(19) United States
(12) Patent Application Publication
(10) Pub. No.: US 2022/0027417 A1
(43) Pub. Date: Jan. 27, 2022

(54) MODULAR APPLICATION PROGRAMMING INTERFACE SYSTEM

(71) Applicant: RapidSOS, Inc., New York, NY (US)

(72) Inventors: Henry KATZ, Brookline, MA (US); Zvika FERENTZ, Rye Brook, NY (US); Lucas Richard Eager LEAVITT, Forest Hills, NY (US); Nicholas Edward HORELIK, Long Island City, NY (US)

(21) Appl. No.: 17/378,045

(22) Filed: Jul. 16, 2021

Related U.S. Application Data
(60) Provisional application No. 63/053,446, filed on Jul. 17, 2020.

(51) Int. Cl. G06F 16/903; G06F 3/0484; G06F 3/14; G06F 3/0481

(52) U.S. Cl. CPC G06F 16/90335; G06F 3/0481; G06F 3/14; G06F 3/0484

(57) ABSTRACT

Disclosed herein is a modular application programming interface (API) system (MAS) for facilitating the efficient integration of various data sources. Data packets received from a dynamically growing set of data sources can be processed and/or validated without requiring redundant engineering work whenever a new data source is added to the set of data sources. In some embodiments, the MAS provides a schema editor interface for creating and editing MAS schemas and a schema database for storing MAS schemas created and edited within the schema editor interface.

### CROSS-REFERENCE

This application claims the benefit of U.S. Provisional Application No. 63/053,446, filed Jul. 17, 2020, which is incorporated herein in its entirety by reference.

### BACKGROUND OF THE INVENTION

A person in an emergency situation may request help using a mobile communication device such as a cell phone to dial a designated emergency number like 9-1-1 or a direct access phone number for the local emergency service provider. However, current emergency communication systems are balkanized across different local and federal jurisdictions and have widely differing capabilities. Integrating disparate communications systems would require customized APIs adapted to each respective communication system at the emergency service providers.

### SUMMARY OF THE INVENTION

One advantage provided by the systems, servers, devices, methods, and media of the instant application is the ability to gather and deliver device-based hybrid locations (hereinafter, “enhanced locations”) and additional data that may be pertinent to emergency situations to emergency service providers (ESPs; e.g., public safety answering points, fire departments, police departments, paramedics, police officers, etc.). In some embodiments, an emergency management system (EMS) includes a clearinghouse (also referred to as an “Emergency Clearinghouse”) that functions to receive enhanced locations (e.g., global positioning systems location data, map data) and additional data (e.g., medical history, video feeds, emergency reports, media reports) from various sources (e.g., medical databases, mobile devices of public or first responders, public cameras, police systems, media outlets) and at various times before, during, or after emergency situations and distribute enhanced locations and additional data to ESPs to aid the ESPs in responding to live emergency situations. In some embodiments, the enhanced locations and additional data are delivered by the EMS to a public safety answering point (PSAP). In some embodiments, the enhanced locations and additional data are displayed within a preexisting PSAP system, such as an Automatic Location Identification (ALI) display. In some embodiments, the enhanced locations and additional data are displayed through a graphical user interface provided by an emergency response application separate from the preexisting ESP system (e.g., PSAP system).

Another advantage provided by the systems, devices, methods and media of the instant application is the ability to provide a modular application programming interface (API) system (MAS) for receiving data packets (e.g., enhanced locations and additional data) from a dynamically growing set of data sources without requiring redundant engineering work whenever a new data source is added to the set of data sources. The conventional approach to managing data streams from different data sources is to build a different API for each data source due to the differences in the types of data generated by each data source. In other words, a bespoke API must be programmed for each data source, which is time-consuming and requires programming knowledge. The inefficiency of this approach is magnified in scenarios where many data sources are involved. For example, in the case of an emergency management system or clearinghouse that is communicatively coupled to a multitude of network entities transmitting data corresponding to a large number of data sources, there is a need to efficiently manage the incoming data and providing the relevant portions of that data to recipient emergency service providers in the appropriate visualization format. Accordingly, disclosed herein is a modular API system that is user-friendly and allows non-programmers to generate such bespoke APIs quickly and easily. Non-emergency systems are also contemplated herein in which the modular API system provides an innovative solution in various situations where disparate data sources with different data format/visualization needs have to be provided to one or more recipients.

In some embodiments, the MAS provides a schema editor interface for creating and editing MAS schemas and a schema database for storing MAS schemas created and edited within the schema editor interface. Individual MAS schemas may be associated with individual data sources, such that when the MAS receives a data packet (e.g., an enhanced location or additional data) from a data source, the MAS can retrieve a MAS schema associated with the data source from the schema database and validate the data packet (also referred to as a “data payload”) against the MAS schema associated with the data source. In this way, a single API may be utilized for a plurality of data sources and does not need to be reengineered to receive data from a new data source. Instead, a new MAS schema can be created within the schema editor interface to provide data validation without the need to build a new API. Alternatively or in combination, the MAS schema can be used to provide a validated data set to a party in need of the information such as an emergency service provider. For example, an emergency dispatch center may be capable of Thus, the MAS schema can be used for validating data received from data sources as well as for providing a validated data set to a recipient of the information.

Another advantage provided by the systems, servers, devices, methods, and media of the instant application is the ability to access an emergency response application provided to authorized emergency service providers (e.g., PSAPs) for receiving and displaying emergency data, such as enhanced locations. In some embodiments, the emergency response application functions to verify emergency service providers, generate emergency data requests, and display emergency data received from the Emergency Clearinghouse, as described below. In some embodiments, the emergency response application provides a graphical user interface to a computing device that is accessible by members of emergency service providers. In some embodiments, the emergency response application integrates with one or more preexisting ESP systems to provide a seamless and comprehensive emergency data delivery system.

In one aspect, disclosed herein is a method for validating and visualizing data using a modular API system, the method comprising: providing a schema database comprising a plurality of schemas corresponding to a respective plurality of schema identifiers, each schema defining a validation requirement and a visualization rule for one or more data fields; receiving a data packet associated with a schema identifier from the plurality of schema identifiers and comprising one or more data values for one or more respective data fields; retrieving a schema associated with the schema identifier from the schema database; validating the data packet against the schema to generate a validated data packet; and transmitting the validated data packet to a recipient for display of the one or more data values within a graphical user interface according to the visualization rule defined by the schema. In some embodiments, the validation requirement comprises a data format. In some embodiments, the validation requirement comprises a mandatory designation. In some embodiments, the visualization rule comprises a rendering option, a display label, or a display order. In some embodiments, the one or more data values are visualized within the graphical user interface according to the visualization rule within a data card. In some embodiments, the plurality of schemas corresponds to a respective plurality of data sources. In some embodiments, the method further comprises: storing the validated data packet in a database; receiving a data query for the validated data packet; and visualizing the one or more data values within the graphical user interface in response to receiving the data query for the validated data packet. In some embodiments, the data packet comprises or is otherwise associated with a user identifier and wherein the data query comprises the user identifier. In some embodiments, the method further comprises receiving a definition of the schema through a schema editor interface. In some embodiments, the method further comprises comprising providing the schema editor interface for creating and defining new schemas. In some embodiments, the schema editor interface is provided through a web application accessible through a standard web browser. In some embodiments, the definition of the schema comprises at least one data field and at least one data format associated with the at least one data field. In some embodiments, the visualization rule is selected within the schema editor interface. In some embodiments, validating the data packet against the schema comprises confirming that a data value for a data field comprised by the data packet is in an appropriate data format as defined by the schema. In some embodiments, the schema additionally defines a data field configured to be visualized as a clickable action. In some embodiments, the data packet is an emergency alert and wherein the graphical user interface is provided by an emergency response application. In some embodiments, the emergency alert comprises at least a location and a user identifier. In some embodiments, the emergency response application is executed on a computing device at an emergency service provider (ESP). In some embodiments, the graphic user interface displays a map showing at least a portion of the jurisdiction of the emergency service provider and a location of an emergency corresponding to the validated data packet.

In another aspect, disclosed herein is an emergency management system comprising: a schema database comprising a plurality of schemas corresponding to a respective plurality of schema identifiers, each schema defining a validation requirement and a visualization rule for one or more data fields; and a processor and non-transitory computer readable storage medium including instructions that, when executed by the processor, causes the processor to: receive a data packet associated with a schema identifier from the plurality of schema identifiers and comprising one or more data values for one or more respective data fields; retrieve a schema associated with the schema identifier from the schema database; validate the data packet against the schema to generate a validated data packet; and transmit the validated data packet to a recipient for display of the one or more data values within a graphical user interface according to the visualization rule defined by the schema. In some embodiments, the validation requirement comprises a data format. In some embodiments, the validation requirement comprises a mandatory designation. In some embodiments, the visualization rule comprises a rendering option, a display label, or a display order. In some embodiments, the one or more data values are visualized within the graphical user interface according to the visualization rule within a data card. In some embodiments, the plurality of schemas corresponds to a respective plurality of data sources. In some embodiments, the processor is further caused to: store the validated data packet in a database; receive a data query for the validated data packet; and visualize the one or more data values within the graphical user interface in response to receiving the data query for the validated data packet. In some embodiments, the data packet comprises or is otherwise associated with a user identifier and wherein the data query comprises the user identifier. In some embodiments, the processor is further caused to receive a definition of the schema through a schema editor interface. In some embodiments, the processor is further caused to provide the schema editor interface for creating and defining new schemas. In some embodiments, the schema editor interface is provided through a web application accessible through a standard web browser. In some embodiments, the definition of the schema comprises at least one data field and at least one data format associated with the at least one data field. In some embodiments, the visualization rule is selected within the schema editor interface. In some embodiments, validate the data packet against the schema comprises confirming that a data value for a data field comprised by the data packet is in an appropriate data format as defined by the schema. In some embodiments, the schema additionally defines a data field configured to be visualized as a clickable action. In some embodiments, the data packet is an emergency alert and wherein the graphical user interface is provided by an emergency response application. In some embodiments, the emergency alert comprises at least a location and a user identifier. In some embodiments, the emergency response application is executed on a computing device at an emergency service provider (ESP).

In another aspect, disclosed herein is a method for validating and sharing emergency data by an emergency management system (EMS), the method comprising: a) providing a schema database comprising a plurality of schemas corresponding to a plurality of schema identifiers, each respective schema defining a validation requirement for one or more of a data type, data amount, or data format for data originating from a respective data source; b) receiving an emergency alert comprising emergency data, wherein the emergency alert includes or is associated with a schema identifier; c) retrieving a schema from the schema database using the schema identifier; d) validating the emergency data against the schema to generate a validated emergency data set; and e) transmitting the validated emergency data set to an emergency service provider (ESP) for display within a graphical user interface (GUI) of an emergency response application executed on a computing device at the ESP. In some embodiments, the schema includes or is otherwise associated with rendering rules for displaying the emergency data within the GUI of the emergency response application. In some embodiments, the method further comprises receiving a definition of the schema through a schema editor interface. In some embodiments, the method further comprises providing the schema editor interface for creating and defining new schemas. In some embodiments, the schema editor interface is a provided through a web application accessible through a standard web browser via a URL. In some embodiments, the schema editor interface allows for the definition of a schema, wherein the definition of the schema comprises at least one data type and at least one data format associated with the at least one data type. In some embodiments, the definition of the schema further comprises at least one rendering rule associated with the at least one data type. In some embodiments, the emergency data is displayed within the GUI of the emergency response application according to the at least one rendering rule. In some embodiments, the emergency data comprises or is otherwise associated with a user identifier and the method further comprises: a) in response to the emergency data being successfully validated against the schema, storing the emergency data in one or more emergency databases; b) receiving an emergency data request comprising the user identifier from an emergency service provider (ESP); and c) in response to receiving the emergency data request, gathering the emergency data using the user identifier. In some embodiments, the method further comprises, in response to the emergency data being successfully validated against the schema: a) automatically accessing one or more geofences associated with one or more emergency service providers (ESPs) from a geofence database, the one or more geofences comprising a first geofence associated with the ESP; b) determining that the emergency location is within the first geofence associated with the ESP; and c) transmitting the emergency data to the ESP in response to determining that the emergency location is within the first geofence associated with the ESP. In some embodiments, the emergency alert further comprises an indication that the emergency alert comprises supplemental emergency data. In some embodiments, the emergency alert further comprises an indication that the emergency alert comprises a primary request for emergency service. In some embodiments, the schema is defined through an emergency flow building block within a modular emergency flow and wherein the schema identifier is an emergency flow identifier associated with the modular emergency flow. In some embodiments, the emergency flow building block through which the schema is defined is configured to publish at least a portion of the emergency data comprised by the emergency alert to a message bus within the emergency management system (EMS). In some embodiments, the modular emergency flow comprises one or more additional emergency flow building blocks, wherein the one or more additional emergency flow building blocks are configured to prompt an emergency flow management system to execute one or more emergency response functions. In some embodiments, the one or more additional emergency flow building blocks comprises a second emergency flow building block configured to prompt the emergency flow management system to execute a voice over internet protocol (VoIP) call the ESP. In some embodiments, the ESP is a public safety answering point (PSAP). In some embodiments, the schema is associated with a permission tag and further comprising: a) identifying an account associated with a user accessing the emergency response application; b) determining if the account has been given permission to access data associated with the permission tag; and c) transmitting the emergency data to the ESP in response to determining that the account has been given permission to access data associated with the permission tag. In some embodiments, the schema defines one or more visualization rules and further comprising visualizing the validated emergency data set within the GUI of the emergency response application according to the one or more visualization rules. In some embodiments, the one or more visualization rules comprises one or more of a rendering option, a display label, and a display order. In some embodiments, the validated emergency data set is visualized within the GUI of the emergency response application according to the one or more visualization rules within a data card. In some embodiments, the one or more visualization rules defined by the schema are selected within a schema editor interface. 25 In some embodiments, the method further comprises tagging the validated emergency data set with the one or more visualization rules defined by the schema. In some embodiments, the validated emergency data set is visualized within the GUI of the emergency response application by a visualization engine comprised by the emergency response application. In some embodiments, the validated emergency data set is visualized within the GUI of the emergency response application within a data card.

In another aspect, disclosed herein is a method for validating and sharing emergency data by an emergency management system (EMS), the method comprising: a) providing a schema database comprising a plurality of schemas corresponding to a plurality of schema identifiers, each respective schema defining a validation requirement for one or more of a data type, data amount, or data format for data originating from a respective data source; b) receiving an emergency alert comprising emergency data, wherein the emergency alert includes or is associated with a user identifier and a schema identifier; c) retrieving a schema from a schema database using the schema identifier; d) validating the emergency data against the schema to generate a validated emergency data set associated with the user identifier; e) storing the emergency data in one or more emergency databases after the emergency data has been successfully validated against the schema; f) receiving an emergency data request comprising the user identifier from an emergency service provider (ESP); g) in response to receiving the emergency data request, identifying the validated emergency data set using the user identifier; h) transmitting the validated emergency data set to the ESP; and i) displaying the validated emergency data set within a graphical user interface (GUI) of an emergency response application executed on a computing device at the ESP. In some embodiments, the schema includes or is otherwise associated with rendering rules for displaying the emergency data within the GUI of the emergency response application. In some embodiments, the method further comprises receiving a definition of the schema through a schema editor interface. In some embodiments, the method further comprises providing the schema editor interface for creating and defining new schemas. In some embodiments, the schema editor interface is a provided through a web application accessible through a standard web browser via a URL. In some embodiments, the schema editor interface allows for the definition of a schema, wherein the definition of the schema comprises at least one data type and at least one data format associated with the at least one data type. In some embodiments, the definition of the schema further comprises at least one rendering rule associated with the at least one data type. In some embodiments, the emergency data is displayed within the GUI of the emergency response application according to the at least one rendering rule. In some embodiments, the emergency data comprises or is otherwise associated with a user identifier and the method further comprises: a) in response to the emergency data being successfully validated against the schema, storing the emergency data in one or more emergency databases; b) receiving an emergency data request comprising the user identifier from an emergency service provider (ESP); and c) in response to receiving the emergency data request, gathering the emergency data using the user identifier. In some embodiments, the method further comprises, in response to the emergency data being successfully validated against the schema: a) automatically accessing one or more geofences associated with one or more emergency service providers (ESPs) from a geofence database, the one or more geofences comprising a first geofence associated with the ESP; b) determining that the emergency location is within the first geofence associated with the ESP; and c) transmitting the emergency data to the ESP in response to determining that the emergency location is within the first geofence associated with the ESP. In some embodiments, the emergency alert further comprises an indication that the emergency alert comprises supplemental emergency data. In some embodiments, the emergency alert further comprises an indication that the emergency alert comprises a primary request for emergency service. In some embodiments, the schema is defined through an emergency flow building block within a modular emergency flow and wherein the schema identifier is an emergency flow identifier associated with the modular emergency flow. In some embodiments, the emergency flow building block through which the schema is defined is configured to publish at least a portion of the emergency data comprised by the emergency alert to a message bus within the emergency management system (EMS). In some embodiments, the modular emergency flow comprises one or more additional emergency flow building blocks, wherein the one or more additional emergency flow building blocks are configured to prompt an emergency flow management system to execute one or more emergency response functions. In some embodiments, the one or more additional emergency flow building blocks comprises a second emergency flow building block configured to prompt the emergency flow management system to execute a voice over internet protocol (VoIP) call the ESP. In some embodiments, the ESP is a public safety answering point (PSAP). In some embodiments, the schema is associated with a permission tag and further comprising: a) identifying an account associated with a user accessing the emergency response application; b) determining if the account has been given permission to access data associated with the permission tag; and c) transmitting the emergency data to the ESP in response to determining that the account has been given permission to access data associated with the permission tag. In some embodiments, the schema defines one or more visualization rules and further comprising visualizing the validated emergency data set within the GUI of the emergency response application according to the one or more visualization rules. In some embodiments, the one or more visualization rules comprises one or more of a rendering option, a display label, and a display order. In some embodiments, the validated emergency data set is visualized within the GUI of the emergency response application according to the one or more visualization rules within a data card. In some embodiments, the one or more visualization rules defined by the schema are selected within a schema editor interface. 25 In some embodiments, the method further comprises tagging the validated emergency data set with the one or more visualization rules defined by the schema. In some embodiments, the validated emergency data set is visualized within the GUI of the emergency response application by a visualization engine comprised by the emergency response application. In some embodiments, the validated emergency data set is visualized within the GUI of the emergency response application within a data card.

In another aspect, disclosed herein is a method for validating and sharing emergency data by an emergency management system (EMS), the method comprising: a) providing a schema database comprising a plurality of schemas corresponding to a plurality of schema identifiers, each respective schema defining a validation requirement for one or more of a data type, data amount, or data format for data originating from a respective data source; b) receiving an emergency alert comprising emergency data, wherein the emergency data comprises an emergency location, and wherein the emergency alert includes or is associated with a user identifier and a schema identifier; c) retrieving a schema from the schema database using the schema identifier; d) validating the emergency data against the schema to generate a validated emergency data set associated with the user identifier; and e) in response to the emergency data being successfully validated against the schema: i) automatically accessing one or more geofences associated with one or more emergency service providers (ESPs) from a geofence database, the one or more geofences comprising a first geofence associated with a first ESP; ii) determining that the emergency location is within the first geofence associated with the first ESP; and iii) transmitting the emergency data to the first ESP for display within a graphical user interface (GUI) of an emergency response application. In some embodiments, the schema includes or is otherwise associated with rendering rules for displaying the emergency data within the GUI of the emergency response application. In some embodiments, the method further comprises receiving a definition of the schema through a schema editor interface. In some embodiments, the method further comprises providing the schema editor interface for creating and defining new schemas. In some embodiments, the schema editor interface is a provided through a web application accessible through a standard web browser via a URL. In some embodiments, the schema editor interface allows for the definition of a schema, wherein the definition of the schema comprises at least one data type and at least one data format associated with the at least one data type. In some embodiments, the definition of the schema further comprises at least one rendering rule associated with the at least one data type. In some embodiments, the emergency data is displayed within the GUI of the emergency response application according to the at least one rendering rule. In some embodiments, the emergency data comprises or is otherwise associated with a user identifier and the method further comprises: a) in response to the emergency data being successfully validated against the schema, storing the emergency data in one or more emergency databases; b) receiving an emergency data request comprising the user identifier from an emergency service provider (ESP); and c) in response to receiving the emergency data request, gathering the emergency data using the user identifier. In some embodiments, the method further comprises, in response to the emergency data being successfully validated against the schema: a) automatically accessing one or more geofences associated with one or more emergency service providers (ESPs) from a geofence database, the one or more geofences comprising a first geofence associated with the ESP; b) determining that the emergency location is within the first geofence associated with the ESP; and c) transmitting the emergency data to the ESP in response to determining that the emergency location is within the first geofence associated with the ESP. In some embodiments, the emergency alert further comprises an indication that the emergency alert comprises supplemental emergency data. In some embodiments, the emergency alert further comprises an indication that the emergency alert comprises a primary request for emergency service. In some embodiments, the schema is defined through an emergency flow building block within a modular emergency flow and wherein the schema identifier is an emergency flow identifier associated with the modular emergency flow. In some embodiments, the emergency flow building block through which the schema is defined is configured to publish at least a portion of the emergency data comprised by the emergency alert to a message bus within the emergency management system (EMS). In some embodiments, the modular emergency flow comprises one or more additional emergency flow building blocks, wherein the one or more additional emergency flow building blocks are configured to prompt an emergency flow management system to execute one or more emergency response functions. In some embodiments, the one or more additional emergency flow building blocks comprises a second emergency flow building block configured to prompt the emergency flow management system to execute a voice over internet protocol (VoIP) call the ESP. In some embodiments, the ESP is a public safety answering point (PSAP). In some embodiments, the schema is associated with a permission tag and further comprising: a) identifying an account associated with a user accessing the emergency response application; b) determining if the account has been given permission to access data associated with the permission tag; and c) transmitting the emergency data to the ESP in response to determining that the account has been given permission to access data associated with the permission tag. In some embodiments, the schema defines one or more visualization rules and further comprising visualizing the validated emergency data set within the GUI of the emergency response application according to the one or more visualization rules. In some embodiments, the one or more visualization rules comprises one or more of a rendering option, a display label, and a display order. In some embodiments, the validated emergency data set is visualized within the GUI of the emergency response application according to the one or more visualization rules within a data card. In some embodiments, the one or more visualization rules defined by the schema are selected within a schema editor interface. 25 In some embodiments, the method further comprises tagging the validated emergency data set with the one or more visualization rules defined by the schema. In some embodiments, the validated emergency data set is visualized within the GUI of the emergency response application by a visualization engine comprised by the emergency response application. In some embodiments, the validated emergency data set is visualized within the GUI of the emergency response application within a data card.

In another aspect, disclosed herein is a method for validating and sharing emergency data, comprising: a) receiving an emergency alert comprising emergency data, wherein the emergency alert includes or is otherwise associated with a schema identifier; b) retrieving a schema from a schema database using the schema identifier, wherein the schema is associated with a permission tag; c) validating the emergency data against the schema; d) associating the emergency data with the permission tag; e) transmitting the emergency data to an emergency service provider (ESP) for display within a graphical user interface (GUI) of an emergency response application executed on a computing device at the ESP, wherein an account associated with a user accessing the emergency response application is determined to have been given permission to access data associated with the permission tag.

In another aspect, disclosed herein is an emergency management system comprising: a) a schema database comprising a plurality of schemas corresponding to a plurality of schema identifiers, each respective schema defining a validation requirement for one or more of a data type, data amount, or data format for data originating from a respective data source; and b) a processor and non-transitory computer readable storage medium including instructions that, when executed by the processor, causes the processor to: 1) receive an emergency alert comprising emergency data, wherein the emergency alert includes or is associated with a schema identifier; 2) retrieve a schema from the schema database using the schema identifier; 3) validate the emergency data against the schema to generate a validated emergency data set; and 4) transmit the validated emergency data set to an emergency service provider (ESP) for display within a graphical user interface (GUI) of an emergency response application executed on a computing device at the ESP. In some embodiments, the schema includes or is otherwise associated with rendering rules for displaying the emergency data within the GUI of the emergency response application. In some embodiments, the processor is further caused to receive a definition of the schema through a schema editor interface. In some embodiments, the processor is further caused to provide the schema editor interface for creating and defining new schemas. In some embodiments, the schema editor interface is a provided through a web application accessible through a standard web browser via a URL. In some embodiments, the schema editor interface allows for the definition of a schema, wherein the definition of the schema comprises at least one data type and at least one data format associated with the at least one data type. In some embodiments, the definition of the schema further comprises at least one rendering rule associated with the at least one data type. In some embodiments, the emergency data is displayed within the GUI of the emergency response application according to the at least one rendering rule. In some embodiments, the emergency data comprises or is otherwise associated with a user identifier and wherein the processor is further caused to: h) in response to the emergency data being successfully validated against the schema, store the emergency data in one or more emergency databases; i) receive an emergency data request comprising the user identifier from an emergency service provider (ESP); and j) in response to receiving the emergency data request, gather the emergency data using the user identifier. In some embodiments, in response to the emergency data being successfully validated against the schema, the processor is further caused to: k) automatically access one or more geofences associated with one or more emergency service providers (ESPs) from a geofence database, the one or more geofences comprising a first geofence associated with the ESP; l) determine that the emergency location is within the first geofence associated with the ESP; and m) transmitting the emergency data to the ESP in response to determining that the emergency location is within the first geofence associated with the ESP. In some embodiments, the emergency alert further comprises an indication that the emergency alert comprises supplemental emergency data. In some embodiments, the emergency alert further comprises an indication that the emergency alert comprises a primary request for emergency service. In some embodiments, the schema is defined through an emergency flow building block within a modular emergency flow and wherein the schema identifier is an emergency flow identifier associated with the modular emergency flow. In some embodiments, the emergency flow building block through which the schema is defined is configured to publish at least a portion of the emergency data comprised by the emergency alert to a message bus within the emergency management system (EMS). In some embodiments, the modular emergency flow comprises one or more additional emergency flow building blocks, wherein the one or more additional emergency flow building blocks are configured to prompt an emergency flow management system to execute one or more emergency response functions. In some embodiments, the one or more additional emergency flow building blocks comprises a second emergency flow building block configured to prompt the emergency flow management system to execute a voice over internet protocol (VoIP) call the ESP. In some embodiments, the ESP is a public safety answering point (PSAP). In some embodiments, the schema is associated with a permission tag and the processor is further caused to: n) identify an account associated with a user accessing the emergency response application; o) determine if the account has been given permission to access data associated with the permission tag; and p) transmit the emergency data to the ESP in response to determining that the account has been given permission to access data associated with the permission tag. In some embodiments, the schema defines one or more visualization rules and further comprising visualizing the validated emergency data set within the GUI of the emergency response application according to the one or more visualization rules. In some embodiments, the one or more visualization rules comprises one or more of a rendering option, a display label, and a display order. In some embodiments, the validated emergency data set is visualized within the GUI of the emergency response application according to the one or more visualization rules within a data card. In some embodiments, the one or more visualization rules defined by the schema are selected within a schema editor interface. In some embodiments, the processor is further caused to tag the validated emergency data set with the one or more visualization rules defined by the schema. In some embodiments, the validated emergency data set is visualized within the GUI of the emergency response application by a visualization engine comprised by the emergency response application. In some embodiments, the validated emergency data set is visualized within the GUI of the emergency response application within a data card.

In another aspect, disclosed herein is an emergency management system comprising: a) a schema database comprising a plurality of schemas corresponding to a plurality of schema identifiers, each respective schema defining a validation requirement for one or more of a data type, data amount, or data format for data originating from a respective data source; and b) a processor and non-transitory computer readable storage medium including instructions that, when executed by the processor, causes the processor to: i) provide a schema database comprising a plurality of schemas corresponding to a plurality of schema identifiers, each respective schema defining a validation requirement for one or more of a data type, data amount, or data format for data originating from a respective data source; ii) receive an emergency alert comprising emergency data, wherein the emergency alert includes or is associated with a user identifier and a schema identifier; iii) retrieve a schema from a schema database using the schema identifier; iv) validate the emergency data against the schema to generate a validated emergency data set associated with the user identifier; v) store the emergency data in one or more emergency databases after the emergency data has been successfully validated against the schema; vi) receive an emergency data request comprising the user identifier from an emergency service provider (ESP); vii) in response to receiving the emergency data request, identify the validated emergency data set using the user identifier; viii) transmit the validated emergency data set to the ESP; and ix) display the validated emergency data set within a graphical user interface (GUI) of an emergency response application executed on a computing device at the ESP. In some embodiments, the schema includes or is otherwise associated with rendering rules for displaying the emergency data within the GUI of the emergency response application. In some embodiments, the processor is further caused to receive a definition of the schema through a schema editor interface. In some embodiments, the processor is further caused to provide the schema editor interface for creating and defining new schemas. In some embodiments, the schema editor interface is a provided through a web application accessible through a standard web browser via a URL. In some embodiments, the schema editor interface allows for the definition of a schema, wherein the definition of the schema comprises at least one data type and at least one data format associated with the at least one data type. In some embodiments, the definition of the schema further comprises at least one rendering rule associated with the at least one data type. In some embodiments, the emergency data is displayed within the GUI of the emergency response application according to the at least one rendering rule. In some embodiments, the emergency data comprises or is otherwise associated with a user identifier and wherein the processor is further caused to: h) in response to the emergency data being successfully validated against the schema, store the emergency data in one or more emergency databases; i) receive an emergency data request comprising the user identifier from an emergency service provider (ESP); and j) in response to receiving the emergency data request, gather the emergency data using the user identifier. In some embodiments, in response to the emergency data being successfully validated against the schema, the processor is further caused to: k) automatically access one or more geofences associated with one or more emergency service providers (ESPs) from a geofence database, the one or more geofences comprising a first geofence associated with the ESP; l) determine that the emergency location is within the first geofence associated with the ESP; and m) transmitting the emergency data to the ESP in response to determining that the emergency location is within the first geofence associated with the ESP. In some embodiments, the emergency alert further comprises an indication that the emergency alert comprises supplemental emergency data. In some embodiments, the emergency alert further comprises an indication that the emergency alert comprises a primary request for emergency service. In some embodiments, the schema is defined through an emergency flow building block within a modular emergency flow and wherein the schema identifier is an emergency flow identifier associated with the modular emergency flow. In some embodiments, the emergency flow building block through which the schema is defined is configured to publish at least a portion of the emergency data comprised by the emergency alert to a message bus within the emergency management system (EMS). In some embodiments, the modular emergency flow comprises one or more additional emergency flow building blocks, wherein the one or more additional emergency flow building blocks are configured to prompt an emergency flow management system to execute one or more emergency response functions. In some embodiments, the one or more additional emergency flow building blocks comprises a second emergency flow building block configured to prompt the emergency flow management system to execute a voice over internet protocol (VoIP) call the ESP. In some embodiments, the ESP is a public safety answering point (PSAP). In some embodiments, the schema is associated with a permission tag and the processor is further caused to: n) identify an account associated with a user accessing the emergency response application; o) determine if the account has been given permission to access data associated with the permission tag; and p) transmit the emergency data to the ESP in response to determining that the account has been given permission to access data associated with the permission tag. In some embodiments, the schema defines one or more visualization rules and further comprising visualizing the validated emergency data set within the GUI of the emergency response application according to the one or more visualization rules. In some embodiments, the one or more visualization rules comprises one or more of a rendering option, a display label, and a display order. In some embodiments, the validated emergency data set is visualized within the GUI of the emergency response application according to the one or more visualization rules within a data card. In some embodiments, the one or more visualization rules defined by the schema are selected within a schema editor interface. In some embodiments, the processor is further caused to tag the validated emergency data set with the one or more visualization rules defined by the schema. In some embodiments, the validated emergency data set is visualized within the GUI of the emergency response application by a visualization engine comprised by the emergency response application. In some embodiments, the validated emergency data set is visualized within the GUI of the emergency response application within a data card.

In another aspect, disclosed herein is an emergency management system comprising: a) a schema database comprising a plurality of schemas corresponding to a plurality of schema identifiers, each respective schema defining a validation requirement for one or more of a data type, data amount, or data format for data originating from a respective data source; and b) a processor and non-transitory computer readable storage medium including instructions that, when executed by the processor, causes the processor to: c) providing a schema database comprising a plurality of schemas corresponding to a plurality of schema identifiers, each respective schema defining a validation requirement for one or more of a data type, data amount, or data format for data originating from a respective data source; d) receiving an emergency alert comprising emergency data, wherein the emergency data comprises an emergency location, and wherein the emergency alert includes or is associated with a user identifier and a schema identifier; e) retrieving a schema from the schema database using the schema identifier; f) validating the emergency data against the schema to generate a validated emergency data set associated with the user identifier; and g) in response to the emergency data being successfully validated against the schema: 1) automatically accessing one or more geofences associated with one or more emergency service providers (ESPs) from a geofence database, the one or more geofences comprising a first geofence associated with a first ESP; 2) determining that the emergency location is within the first geofence associated with the first ESP; and 3) transmitting the emergency data to the first ESP for display within a graphical user interface (GUI) of an emergency response application. In some embodiments, the schema includes or is otherwise associated with rendering rules for displaying the emergency data within the GUI of the emergency response application. In some embodiments, the processor is further caused to receive a definition of the schema through a schema editor interface. In some embodiments, the processor is further caused to provide the schema editor interface for creating and defining new schemas. In some embodiments, the schema editor interface is a provided through a web application accessible through a standard web browser via a URL. In some embodiments, the schema editor interface allows for the definition of a schema, wherein the definition of the schema comprises at least one data type and at least one data format associated with the at least one data type. In some embodiments, the definition of the schema further comprises at least one rendering rule associated with the at least one data type. In some embodiments, the emergency data is displayed within the GUI of the emergency response application according to the at least one rendering rule. In some embodiments, the emergency data comprises or is otherwise associated with a user identifier and wherein the processor is further caused to: h) in response to the emergency data being successfully validated against the schema, store the emergency data in one or more emergency databases; i) receive an emergency data request comprising the user identifier from an emergency service provider (ESP); and j) in response to receiving the emergency data request, gather the emergency data using the user identifier. In some embodiments, in response to the emergency data being successfully validated against the schema, the processor is further caused to: k) automatically access one or more geofences associated with one or more emergency service providers (ESPs) from a geofence database, the one or more geofences comprising a first geofence associated with the ESP; l) determine that the emergency location is within the first geofence associated with the ESP; and m) transmitting the emergency data to the ESP in response to determining that the emergency location is within the first geofence associated with the ESP. In some embodiments, the emergency alert further comprises an indication that the emergency alert comprises supplemental emergency data. In some embodiments, the emergency alert further comprises an indication that the emergency alert comprises a primary request for emergency service. In some embodiments, the schema is defined through an emergency flow building block within a modular emergency flow and wherein the schema identifier is an emergency flow identifier associated with the modular emergency flow. In some embodiments, the emergency flow building block through which the schema is defined is configured to publish at least a portion of the emergency data comprised by the emergency alert to a message bus within the emergency management system (EMS). In some embodiments, the modular emergency flow comprises one or more additional emergency flow building blocks, wherein the one or more additional emergency flow building blocks are configured to prompt an emergency flow management system to execute one or more emergency response functions. In some embodiments, the one or more additional emergency flow building blocks comprises a second emergency flow building block configured to prompt the emergency flow management system to execute a voice over internet protocol (VoIP) call the ESP. In some embodiments, the ESP is a public safety answering point (PSAP). In some embodiments, the schema is associated with a permission tag and the processor is further caused to: n) identify an account associated with a user accessing the emergency response application; o) determine if the account has been given permission to access data associated with the permission tag; and p) transmit the emergency data to the ESP in response to determining that the account has been given permission to access data associated with the permission tag. In some embodiments, the schema defines one or more visualization rules and further comprising visualizing the validated emergency data set within the GUI of the emergency response application according to the one or more visualization rules. In some embodiments, the one or more visualization rules comprises one or more of a rendering option, a display label, and a display order. In some embodiments, the validated emergency data set is visualized within the GUI of the emergency response application according to the one or more visualization rules within a data card. In some embodiments, the one or more visualization rules defined by the schema are selected within a schema editor interface. In some embodiments, the processor is further caused to tag the validated emergency data set with the one or more visualization rules defined by the schema. In some embodiments, the validated emergency data set is visualized within the GUI of the emergency response application by a visualization engine comprised by the emergency response application. In some embodiments, the validated emergency data set is visualized within the GUI of the emergency response application within a data card.

In another aspect, disclosed herein is a system for validating and sharing emergency data, comprising a processor and non-transitory computer readable storage medium including instructions that, when executed by the processor, causes the processor to: a) receive an emergency alert comprising emergency data, wherein the emergency alert includes or is otherwise associated with a schema identifier; b) retrieve a schema from a schema database using the schema identifier, wherein the schema is associated with a permission tag; c) validate the emergency data against the schema; d) associate the emergency data with the permission tag; and e) transmit the emergency data to an emergency service provider (ESP) for display within a graphical user interface (GUI) of an emergency response application executed on a computing device at the ESP, wherein an account associated with a user accessing the emergency response application is determined to have been given permission to access data associated with the permission tag.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts diagrams of (i) an electronic device and (ii) an emergency management system (EMS) in accordance with some embodiments of the present disclosure;

FIG. 1B depicts diagrams of (iii) an emergency service provider (ESP) system and (iv) ESP software in accordance with some embodiments of the present disclosure;

FIG. 2 depicts a diagram of a clearinghouse for emergency data in accordance with some embodiments of the present disclosure;

FIG. 3A depicts a diagram of a geofence system applied to a clearinghouse for emergency data in accordance with some embodiments of the present disclosure;

FIG. 3B illustrates a map of non-limiting examples of geofence approximations in accordance with some embodiments of the present disclosure;

FIG. 4 depicts a diagram of a clearinghouse and a modular application programming interface (API) system (MAS) in accordance with some embodiments of the present disclosure;

FIG. 5 illustrates a graphical user interface (GUI) of a schema editor interface in accordance with some embodiments of the present disclosure;

FIG. 6 depicts an application of a MAS in accordance with some embodiments of the present disclosure;

FIG. 7 depicts a diagram of an emergency flow management system (EFMS) in accordance with some embodiments of the present disclosure;

FIG. 8 depicts a system for developing and deploying emergency flows in accordance with some embodiments of the present disclosure;

FIG. 9 depicts a diagram of an EFMS in accordance with some embodiments of the present disclosure;

FIG. 10 illustrates a GUI of an application for developing and deploying emergency flows in accordance with some embodiments of the present disclosure;

FIG. 11 illustrates a first example of an emergency flow in accordance with some embodiments of the present disclosure;

FIG. 12 illustrates a second example of an emergency flow in accordance with some embodiments of the present disclosure;

FIG. 13A and FIG. 13B depict systems for receiving and transmitting emergency data by an emergency management system (EMS) in accordance with some embodiments of the present disclosure;

FIG. 14 depicts a ladder diagram of a process for utilizing a MAS in accordance with some embodiments of the present disclosure;

FIG. 15 depicts a diagram of a system for providing an emergency response application in accordance with some embodiments of the present disclosure;

FIG. 16A and FIG. 16B illustrate examples of a GUI of an emergency response application in accordance with some embodiments of the present disclosure;

FIG. 16C and FIG. 16D illustrate examples of data cards presented within a GUI of an emergency response application in accordance with some embodiments of the present disclosure;

FIG. 17A, FIG. 17B, FIG. 17C, and FIG. 17D illustrate a management portal provided by an emergency response application in accordance with some embodiments of the present disclosure;

FIG. 18 depicts examples of MAS schemas in accordance with some embodiments of the present disclosure;

FIG. 19 depicts examples of MAS schemas in accordance with some embodiments of the present disclosure; and

FIG. 20A and FIG. 20B illustrate examples of data cards presented within a GUI of an emergency response application in accordance with some embodiments of the present disclosure.

### DETAILED DESCRIPTION

Disclosed herein are systems, devices, media, and methods for providing enhanced emergency communications and functions. Embodiments of the present disclosure take advantage of technological advancements that have allowed for mobile communication devices to generate accurate locations by incorporating multiple technologies embedded in the devices, such as GPS, Wi-Fi, and Bluetooth to create device-based hybrid locations. Device-based hybrid locations are locations calculated on an electronic or communication device, as opposed to locations calculated using a network (e.g., a carrier network). Device-based hybrid locations can be generated using GPS, network-based technologies, Wi-Fi access points, Bluetooth beacons, barometric pressure sensors, dead reckoning using accelerometers and gyrometers, and a variety of crowdsourced and proprietary databases that device operating systems providers are running to enhance location technology. These device-based hybrid locations can be quickly generated during emergency calls.

Furthermore, mobile communication devices (e.g., mobile phones, wearables, IoT devices, smart home devices, vehicle computers, etc.) are often capable of generating or storing additional information that may be useful in responding to emergency situations, such as health data or medical histories. For example, during an emergency, a modern mobile communication device may have access to an implicated person's blood type, preexisting medical conditions, or even the implicated person's current heartrate. In some embodiments, the mobile communication device has access to data from sensors (e.g., health or environmental sensors). For example, a video feed of the emergency via a connected surveillance camera can provide valuable situational awareness regarding the emergency.

### Electronic Device, Emergency Management System (EMS), and Emergency Service Provider (ESP)

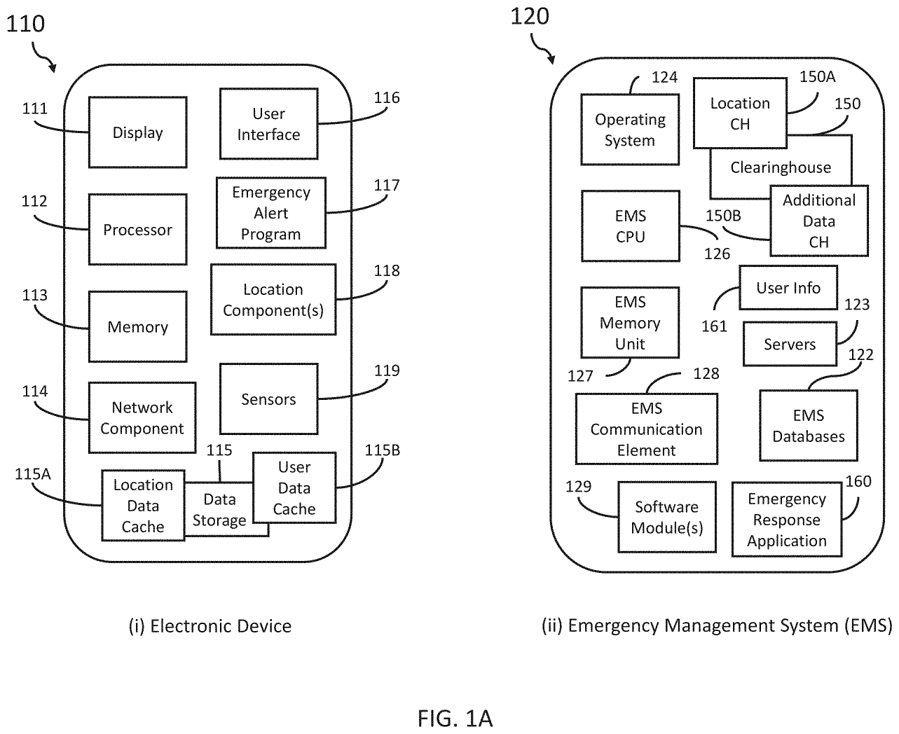

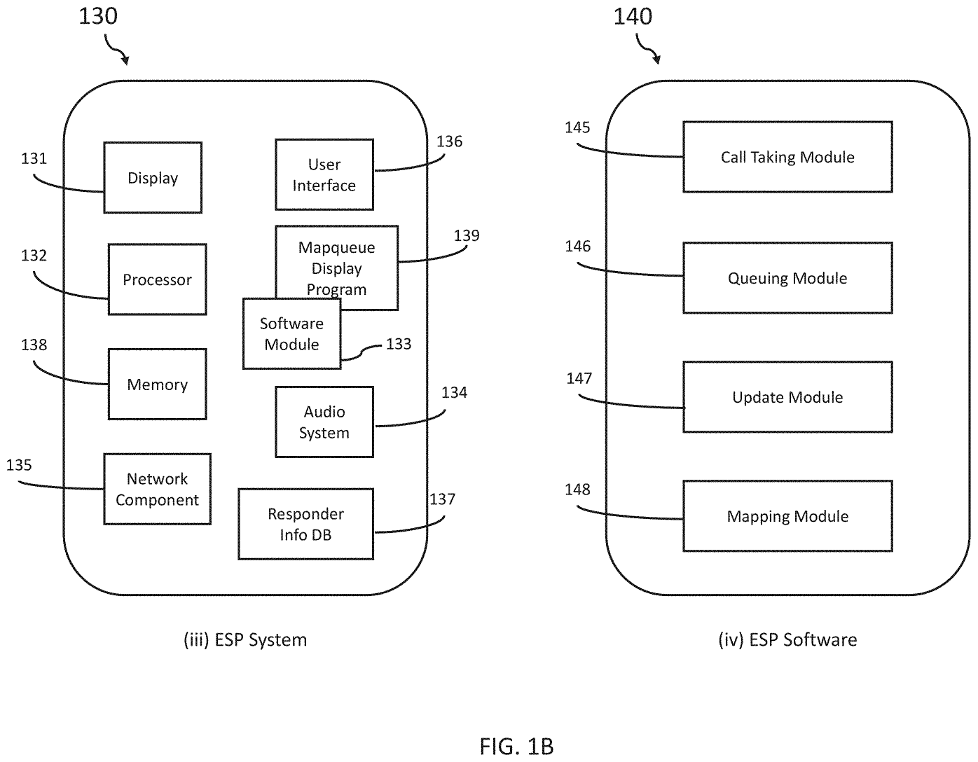

In various embodiments, disclosed herein are devices, systems, and methods for managing emergency data for emergency response. FIG. 1A depicts diagrams of (i) an electronic device 110 and (ii) an emergency management system (EMS) 120 in accordance with some embodiments. In some embodiments, the electronic device 110 is a digital processing device such as a communication device (e.g., mobile or cellular phone, computer, laptop, etc.). In some embodiments, the electronic device is a wearable device (e.g., a smartwatch). In some embodiments, the electronic device is an Internet of Things (IoT) device, such as a home assistant (e.g., an Amazon Echo) or a connected smoke detector (e.g., a Nest Protect smoke and carbon monoxide alarm). In some embodiments, the electronic device is a walkie-talkie or two-way radio.

In some embodiments, the electronic device 110 includes a display 111, a processor 112, a memory 113 (e.g., an EPROM memory, a RAM, or a solid-state memory), a network component 114 (e.g., an antenna and associated components, Wi-Fi adapters, Bluetooth adapters, etc.), a data storage 115, a user interface 116, an emergency alert program 117, one or more location components 118, and one or more sensors 119. In some embodiments, the processor 112 is implemented as one or more microprocessors, microcomputers, microcontrollers, digital signal processors, central processing units, state machines, logic circuitries, and/or devices that manipulate signals based on operational instructions. Among other capabilities, the processor 112 is configured to fetch and execute computer-readable instructions stored in the memory 113.

In some embodiments, the display 111 is part of the user interface 116 (e.g., a touchscreen is both a display and a user interface in that it provides an interface to receive user input or user interactions). In some embodiments, the user interface 116 includes physical buttons such as an on/off button or volume buttons. In some embodiments, the display 111 and/or the user interface 116 comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage 115 includes a location data cache 115A and a user data cache 115B. In some embodiments, the location data cache 115A is configured to store locations generated by the one or more location components 118.

In some embodiments, the emergency alert program 117 is an emergency response application or emergency response mobile application. In some embodiments, the emergency alert program 117 is configured to record user data, such as a name, address, or medical data of a user associated with the electronic device 110. In some embodiments, the emergency alert program 117 is configured to detect when an emergency request is generated or sent by the electronic device 110 (e.g., when a user uses the electronic device 110 to make an emergency call). In some embodiments, in response to detecting an emergency request generated or sent by the electronic device 110, the emergency alert program 117 is configured to deliver a notification to the EMS 120. In some embodiments, the notification is an HTTP post containing information regarding the emergency request. In some embodiments, the notification includes a location (e.g., a device-based hybrid location) generated by or for the electronic device 110. In some embodiments, in response to detecting an emergency request generated or sent by the electronic device 110, the emergency alert program 117 is configured to deliver user data to the EMS 120.

In some embodiments, as depicted in FIG. 1A, the emergency management system (EMS) 120 includes an EMS operating system 124, an EMS CPU 126, an EMS memory unit 127, an EMS communication element 128, and one or more software modules 129. In some embodiments, the EMS CPU 126 is implemented as one or more microprocessors, microcomputers, microcontrollers, digital signal processors, central processing units, state machines, logic circuitries, and/or devices that manipulate signals based on operational instructions. Among other capabilities, the EMS CPU 126 is configured to fetch and execute computer-readable instructions stored in the EMS memory unit 127. The EMS memory unit 127 optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The EMS memory unit 127 optionally includes modules, routines, programs, objects, components, data structures, etc., which perform particular tasks or implement particular abstract data types.

In some embodiments, the EMS 120 includes one or more EMS databases 122, one or more servers 123, and a clearinghouse 150. In some embodiments, the clearinghouse 150, as described in further detail below, is an input/output (I/O) interface configured to manage communications and data transfers to and from the EMS 120 and external systems and devices. In some embodiments, the clearinghouse 150 includes a variety of software and hardware interfaces, for example, a web interface, a graphical user interface (GUI), and the like. The clearinghouse 150 optionally enables the EMS 120 to communicate with other computing devices, such as web servers and external data servers (not shown). In some embodiments, the clearinghouse 150 facilitates multiple communications within a wide variety of networks and protocol types, including wired networks, for example, LAN, cable, etc., and wireless networks, such as WLAN, cellular, or satellite. In some embodiments, the clearinghouse 150 includes one or more ports for connecting a number of devices to one another or to another server. In some embodiments, the clearinghouse 150 includes one or more sub-clearinghouses, such as location clearinghouse 150A and additional data clearinghouse 150B, configured to manage the transfer of locations and additional data, respectively. In some embodiments, the EMS 120 additionally includes a user information module 161 that receives and stores user information (e.g., personal information, demographic information, medical information, location information, etc.) within the EMS 120. In some embodiments, users can submit user information through a website, web application, or mobile application, such as during a registration process for an emergency response application. In some embodiments, when the EMS 120 receives emergency data including user information, such as through an emergency alert received by the clearinghouse 150 (as described below), the EMS 120 stores the user information in the user information module 161. In some embodiments, user information stored within the user information module 161 is received by the EMS 120 from a third-party server system, as described below. In some embodiments, user information stored within the user information module 161 is associated with an identifier of a user or an electronic device associated with a user, such as a phone number or an email address. In some embodiments, the EMS 120 or clearinghouse 150 includes modular application programming interface (API) system (MAS), as described below.

In some embodiments, as depicted in FIG. 1B, an emergency service provider (ESP; e.g., a public safety answering point (PSAP)) system 130 includes one or more of a display 131, a user interface 136, at least one central processing unit or processor 132, a network component 135, an audio system 134 (e.g., microphone, speaker and/or a call-taking headset), and a computer program such as a PSAP Emergency Display Application or Location Display Program 139. In some embodiments, the PSAP application or program 139 comprises one or more software modules 140. In some embodiments, the PSAP system 130 comprises a database of emergency responders 137, such as medical assets, police assets, fire response assets, rescue assets, safety assets, etc.

In some embodiments, as depicted in FIG. 1B, the PSAP application or program 139 installed on a PSAP system 130 comprising a software module 140 is a call taking module 145, an ESP display module 146, a supplemental or updated information module 147, or a combination thereof. In some embodiments, the PSAP application 139 displays the information on a map (e.g., on the display 131). In some embodiments, location and supplemental information is displayed for emergency service providers (e.g., police, fire, medical, etc.) and/or responders on their devices. It is contemplated that responder devices have optionally installed a responder device program (not shown) similar to PSAP display module 146. In some embodiments, the responder device program displays the emergency location on a map.

### Emergency Clearinghouse

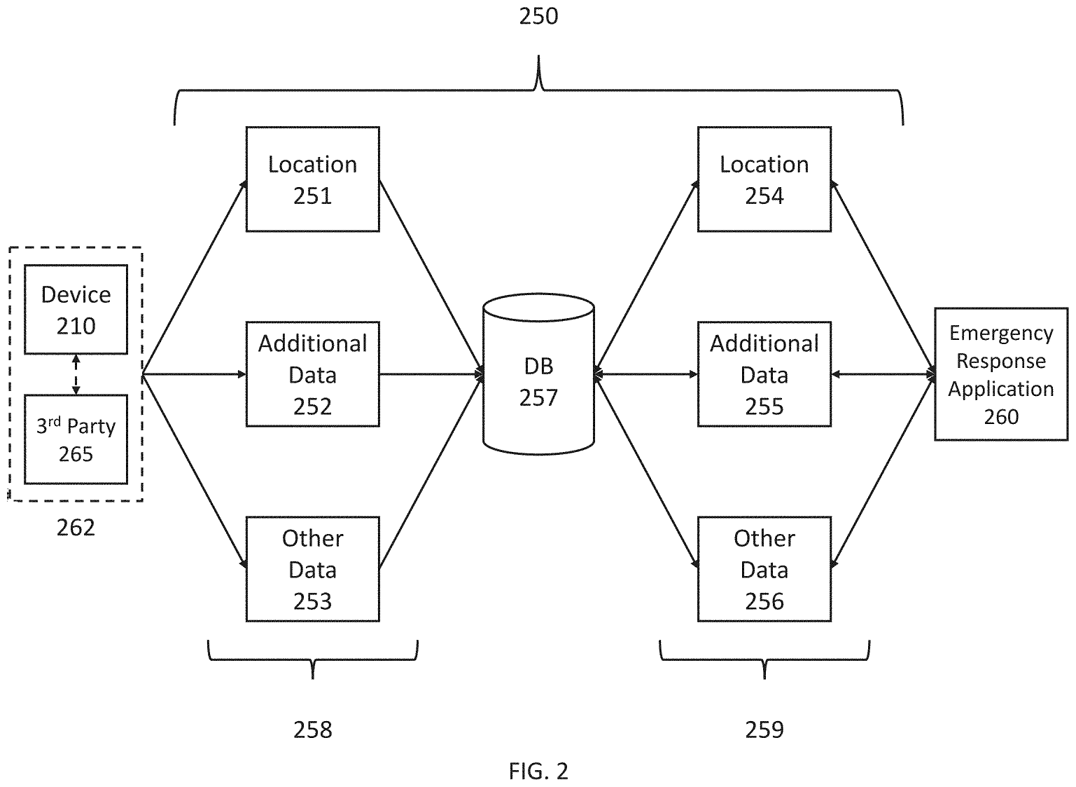

In some embodiments, as mentioned above with respect to FIG. 1A, the emergency management system (EMS) 120 includes a clearinghouse 150 (also referred to as an “Emergency Clearinghouse”) for storing, retrieving, and transmitting emergency data. In some embodiments, the clearinghouse 150 includes a location clearinghouse 150A and an additional data clearinghouse 150B. In some embodiments, the location clearinghouse 150A includes a location ingestion module and a location retrieval module, as described below with respect to FIG. 2. In some embodiments, the additional data clearinghouse 150B includes an additional data ingestion module and an additional data retrieval module, as described below with respect to FIG. 2. In other embodiments, additional data and location data (hereinafter “emergency data”) are stored in one or more databases in a distributed manner. In some embodiments, the emergency data is stored in an external or third-party server that is accessible to the EMS 120. The clearinghouse 150 optionally functions as an interface that receives and stores emergency data from electronic or communication devices that are then retrieved, transmitted, and/or distributed to recipients (e.g., emergency service providers) before, during, or after emergencies. As described above, the clearinghouse optionally receives emergency data from electronic or communication devices such as mobile phones, wearable devices, laptop or desktop computers, personal assistants, intelligent vehicle systems, home security systems, IoT devices, camera feeds, and other sources (e.g., emergency response assets and asset service providers, as described in further detail below). As described above and below, emergency data optionally includes locations or additional data such as medical history, personal information, or contact information. In some embodiments, during an emergency, the clearinghouse 150 detects the emergency and/or otherwise identifies the need to provide emergency data pertaining to the emergency. The clearinghouse 150 then identifies any emergency data pertaining to the emergency stored within the clearinghouse 150 and transmits the pertinent emergency data to the requesting ESP. Accordingly, in some embodiments, the clearinghouse 150 acts as a data pipeline that automatically pushes emergency data to an ESP that would otherwise be without access to emergency data that is critical to most effectively and efficiently responding to an emergency. Accordingly, location data stored within the clearinghouse 150 allows emergency responders to arrive at the scene of an emergency faster, and additional data stored within the clearinghouse 150 allows emergency responders to be better prepared for the emergencies they face.

For example, an emergency alert is triggered by an electronic device 110 (e.g., by pressing a soft button, a physical button, voice command, or gesture) or autonomously based on sensor data (e.g., smoke alarms). In this example, the user then confirms the emergency and/or provides authorization for sending the emergency alert. Emergency data, such as an enhanced location and additional data regarding the user (e.g., the user's medical history) is delivered by the electronic device 110 to the EMS 120 and stored in the clearinghouse 150 (e.g., in the location clearinghouse 150A and the additional data clearinghouse 150B). In some embodiments, the EMS 120 or clearinghouse 150 formats the emergency data into a format that is compatible with industry standards for storing and sharing emergency data. For example, in some embodiments, the emergency data is formatted to be compatible with National Emergency Number Association (NENA) standards. In some embodiments, the clearinghouse 150 transmits the emergency data to a receiving party in response to receiving a query from the receiving party, as described below. In some embodiments, the clearinghouse 150 automatically pushes the emergency data to a receiving party (e.g., without receiving a query from the receiving party), such as a PSAP. For example, in some embodiments, the clearinghouse 150 or emergency management system 120 housing the clearinghouse automatically pushes the emergency data to a receiving party using a subscription system, as described below.

In some embodiments, as mentioned above, a requesting party (such as a PSAP responding to an emergency call) queries the clearinghouse 150 with an emergency data request (such as a HTTP GET request). In some embodiments, the emergency data request is in the form of the Location Information Server (LIS) protocol. In response to the emergency data request, the EMS 120 or clearinghouse 150 sends an appropriate response including relevant emergency data to the requesting party via an encrypted pathway. In some embodiments, the emergency data request is in the form of HTTP-Enabled Location Delivery (HELD) and the response from the EMS 120 or clearinghouse 150 is in the form of Presence Information Data Format Location Object (PIDF-LO). In some embodiments, the emergency data request includes an authorization code (also referred to as an “authorization token” or “temporary access token”) in the body, header, or metadata of the request, and the EMS 120 checks that the authorization code is active before providing a response to the requesting party. In some embodiments, authorization is provided in the “Authorization” header of the emergency data request using HTTP Basic Authentication. For example, in some embodiments, authorization is base64-encoded username and password for an account associated with the requesting party. In some embodiments, emergency data requests are sent over public networks using API access keys or credentials. In some embodiments, Transport Layer Security (TLS) is used in the requests and responses from the EMS 120 for encryption security. In some embodiments, the call taking module 145 includes a call-handling application, which is provided by a third-party vendor. In some embodiments, an ESP personnel interacts with the call-handling application to send an emergency data request to the EMS 120. In some embodiments, the response from the EMS 120 is displayed at the ESP display 131.

In some embodiments, as described above, emergency data includes locations and additional data. In some embodiments, emergency data includes one or more emergency data categories (also referred to as “data categories”). In some embodiments, the emergency data categories include: service data reference, full name, email, emergency contacts, addresses, language, occupation, phone numbers, websites, gender, height, weight, ethnicity, profile picture, allergies, medical conditions, medications, disabilities, blood type, medical notes, birthday, and additional comments. In some embodiments, emergency data categories are tagged with tags for specific types of data such as “demographics” or “medical data.” For example, in some embodiments, gender, height, weight, ethnicity, profile picture (image-url) are tagged as demographic data. In some embodiments, medical data protected under HIPAA and other laws are tagged as “HIPAA” or “private.” In some embodiments, medical data includes information on one or more of allergies, medical condition(s) or illness(es), medication(s), disabilities, blood type, medical note(s), and other medical information. In some embodiments, medical information protected under HIPAA are encrypted and/or anonymized. In some embodiments, some data are tagged as “general” or another similar tag, wherein access is not specifically restricted.

An example of an additional data communication from the EMS 120 in a standard format compatible with industry standards, PIDF-LO, is shown below.

HTTP/1.1 200 OK

Date: Tue, 1 Dec. 2016 23:27:30 GMT

Content-Length: 489

Content-Type: application/EmergencyCallData.DeviceInfo+xml

<dev:EmergencyCallData.DeviceInfo

xmlns:dev=“urn:ietf:params:xml:ns:EmergencyCallData:DeviceInfo”>

<dev:DataProviderReference>d4b3072df.201409182208075@example.org

In some embodiments, when the emergency data is stored at a third-party server and receives a request for emergency data from the EMS 120, as a database query, the third-party server formats the requested emergency data and stores this information in an alternate database, and forwards either a response or a reference to the alternate database for accessing the emergency data requested by the EMS 120, which is provided to the ESP 130 over a hybrid analog and/or a data communication channel, depending on the capabilities of ESP 130. In some embodiments, the third-party server stores the emergency data, requested by the EMS 120 or directly by the ESP 130, in the alternate database for a certain period of time after receiving the request for the emergency data regarding a user and any electronic devices 110. In some embodiments, this period of time is a timer value (e.g., a timer countdown or a set time point) defined by the EMS 120 and the third-party server in conjunction with each other prior to the addition of the requested emergency data to the alternate database at the third-party server. In some embodiments, once the timer value has passed and no new requests for the emergency data pertaining to the particular user and the electronic device 110, or other devices associated with the user, are received by the third-party server, then the third-party server marks the particular alternate database entries to be deleted and waits for another, different, time-out interval. In some embodiments, once this particular second time-out interval has also been completed and no new requests for location data for the particular user or associated electronic devices 110 are received by the third-party server, the third-party server removes the specific marked entries from the alternate database in the next cycle of updates for the alternate database. In some embodiments, after adding the emergency data in the alternate database by the third-party server, the third-party server keeps updating the emergency data in the alternate database on a periodic, or as-needed basis, for the purpose of keeping the emergency data about the user or electronic device 110 current for providing the most recent and accurate emergency data to the EMS 120 and the ESP 130 for the purposes of responding to a request for emergency assistance. In some embodiments, the third-party server is updated by the EMS 120 for all the emergency data pertaining to all users and their associated electronic devices 110 that are served by the EMS 120 at any current time.

In some non-emergency situations, there is a need to access location data, user data, emergency data or sensor data. For example, in some embodiments, a user of an electronic device 110 grants authorization to family members to access location data for the user. Accordingly, when a family member requests location data for a user, access is granted if there is proper authorization. As another example, in some embodiments, a taxi operations company requests and obtains location data of one or more fleet members to keep track of its vehicles (e.g., via onboard vehicle console or terminal).

Various embodiments and applications of the clearinghouse 150 are described in detail herein. However, the embodiments and applications described herein should not be considered exhaustive or limiting in any way.

FIG. 2 depicts an embodiment of an Emergency Clearinghouse 250 for storing and retrieving emergency data. In some embodiments, the clearinghouse 250 includes a set of ingestion modules 258 (also referred to as “ingestion modules”) and a set of retrieval modules 259 (also referred to as “retrieval modules”). The set of ingestion modules 258 is configured to receive various forms of emergency data from various emergency data sources 262, such as an electronic device 210 or a third-party server system 265 (hereinafter, “third-party server”). In some embodiments, an electronic device 210 is a communication device (e.g., a mobile phone), a wearable device (e.g., a smartwatch), or an internet of things (IoT) device (e.g., a smart speaker) that can communicate with one or more of the ingestion modules within the set of ingestion modules 258. In some embodiments, a third-party server 265 stores data that is not generated by or stored within an electronic device. For example, in some embodiments, a third-party server 265 includes a database of static medical information that can be sent to the clearinghouse during an emergency. In some embodiments, when the emergency management system 120 detects an emergency (e.g., when a person calls 9-1-1), the clearinghouse 250 can query an emergency data source 262 for emergency data regarding the emergency. For example, in some embodiments, in response to detecting a 9-1-1 call made from a mobile phone, the additional data ingestion module 252 (as described below) sends a query including the phone number of the mobile phone to a third-party server 265 that stores static medical information. The third-party server 265 can then return any available medical information associated with the phone number of the mobile phone to the additional data ingestion module. In some embodiments, multiple ingestion modules within the set of ingestion modules can receive emergency data for a single emergency. For example, in some embodiments, when a person calls 9-1-1 from a mobile phone, the mobile phone can send a device-based hybrid location to the location ingestion module 251 (as described below) and demographic data (as described above) to the additional data ingestion module 252. In some embodiments, the clearinghouse can receive emergency data from multiple emergency data sources 262 for a single emergency. For example, in some embodiments, when a person calls 9-1-1 from a mobile phone, the clearinghouse can receive a location from the mobile phone (such as through the location ingestion module 251) and a heartrate from a smartwatch that the person is wearing (such as through additional data ingestion module 252). Or for example, in some embodiments, when a person calls 9-1-1 from a mobile phone, the clearinghouse can receive a location from the mobile phone and medical information associated with the person from a third-party server 265. In some embodiments, an electronic device generates and transmits data to a third-party server 265, where it can then be transmitted to or retrieved by the clearinghouse 250, such as through one or more ingestion modules within the set of ingestion modules 258. In some embodiments, one or more ingestion modules within the set of ingestion modules are managed by a modular API system (MAS), as described below.

The set of ingestion modules 258 optionally include a location ingestion module 251, an additional data ingestion module 252, and one or more other data ingestion modules 253. In some embodiments, the location ingestion module 251 is an emergency location service ingestion interface for posting or receiving emergency locations. In some embodiments, the location ingestion module 251 is a REST API that receives an HTTP POST including location data when an emergency alert is generated (e.g., when an emergency call is made from a cell phone). The location data includes a location generated concurrently or in response to the generation of the emergency alert. In some embodiments, the location data includes a location generated before the emergency alert. For example, when an emergency call is made from a cell phone, thereby generating an emergency alert, the location ingestion module 251 receives a location recently generated by the phone but before the emergency alert was generated, ensuring that a location for the emergency is available as quickly as possible. In some embodiments, the location data includes a device-based hybrid location generated by an electronic device 210 that generated the emergency alert. In some embodiments, the location data includes a location generated by a second electronic device communicatively coupled to the electronic device that generated the emergency alert. The location ingestion module 251 is integrated into an electronic device 210 through a mobile application installed on the device 210 or integrated into the firmware or operating system of the electronic device 210.

In some embodiments, the location data is generated by the electronic device 210 before the emergency and is accessible to a PSAP during an emergency. For example, a taxi company may have software that transmits the location of its cars or assets to the emergency clearinghouse 250 preemptively. Thus, when an emergency arises, the location of the affected taxi can be made accessible quicker to send help. In some embodiments, the location data is generated by the electronic device 210 after the emergency has commenced and is made accessible to a PSAP during the on-going emergency. For example, updated location data of a hijacked taxi is also periodically transmitted to the emergency clearinghouse 250 and made accessible to a PSAP.

In some embodiments, the additional data ingestion module 252 is an interface for posting or receiving static or dynamic emergency profile data (e.g., “additional data” or “additional information”). In some embodiments, additional data comprises medical data, personal data, demographic data, health data, or any combination thereof. Examples of medical data include information relating to a person's medical history, such as past surgeries or preexisting conditions. Examples of personal data include a person's name, date of birth, height, weight, occupation, address(es) (e.g., home address, work address, etc.), spoken languages, and other personal information. Examples of demographic data include a person's gender, ethnicity, age, etc. Examples of health data include information such as a person's blood type or heartrate. In some embodiments, additional data comprises data received from connected devices such as vehicles, IoT devices, and wearable devices. For example, some intelligent vehicle systems generate and send data regarding a crash, such as the speed at which the vehicle was moving just before the collision, where the vehicle was struck, the number of occupants, etc. In some embodiments, the additional data ingestion module 252 is a REST API (e.g., a JSON (JavaScript Object Notation) REST API). For example, in some embodiments, when an emergency call is made from a cell phone, thereby generating an emergency alert, the cell phone receives a heartrate of the person who made the emergency call from a smartwatch worn by the person and communicatively coupled to the cell phone (e.g., Wi-Fi or Bluetooth connectivity). The cell phone sends the heartrate to the additional data ingestion module 252, along with any other additional data, in an HTTP POST. In some embodiments, the additional data ingestion module 252 is integrated into an electronic device 210 through a mobile application installed on the device 210 or integrated into the firmware or operating system of the electronic device 210. In some embodiments, additional data is sent to the additional data ingestion module 252 from a network server. The additional data ingestion module 252 is accessed by any connected platform that receives data that might be relevant in an emergency. Connected platforms optionally send additional data to the additional data ingestion module 252 at any time. For example, in some embodiments, a website, web application, or mobile application integrated with the additional data ingestion module 252 that allows users to create profiles sends additional data included in the profiles to the additional data ingestion module 252 every time a profile is created or updated.

In some embodiments, the set of ingestion modules 258 includes one or more other data ingestion modules 253. Another data ingestion module 253 is optionally an interface for posting or receiving data relevant to emergencies that is not received by the location ingestion module 251 or the additional data ingestion module 252. In some embodiments, the other data ingestion module 253 receives audio or video streams during an emergency from electronic or communication devices associated with the emergency or proximal to the emergency. For example, an emergency alert is generated by an intelligent vehicle system installed in a vehicle in response to the vehicle experiencing a collision. In this example, the emergency alert is sent to the EMS 120 by the intelligent vehicle system or by an electronic device communicatively coupled to the intelligent vehicle system, such as a cell phone coupled to the intelligent vehicle system via Bluetooth. In response to generating the emergency alert, the intelligent vehicle system additionally begins streaming audio and video from microphones and cameras installed inside or outside of the vehicle to the clearinghouse 250 through the other data ingestion module 253. A cell phone communicatively coupled to the intelligent vehicle system additionally or alternatively streams audio or video from microphones and cameras integrated into the cell phone to the clearinghouse 250 through the other data ingestion module 253. In some embodiments, the one or more other data ingestion modules 253 are REST APIs that are accessed with an HTTP POST.

After receiving the relevant data, the set of ingestion modules 258 can store the data in one or more clearinghouse databases 257. For example, in some embodiments, the clearinghouse databases 257 includes a location database and an additional data database. In some embodiments, as described above, the one or more clearinghouse databases 257 are stored on a third-party server communicatively coupled to or otherwise accessible by the EMS 120. In some embodiments, the set of ingestion modules 258 tags or otherwise associates the data received by the modules with an identifier of a user or device associated with the data. For example, the set of ingestions modules 258 tag the data the received by the modules with a user ID number, an email address, or a phone number (e.g., caller ID). In some embodiments, the ingestion modules 258 tag the data received by the clearinghouse 250 based on the data source (e.g., device name or type, application name, username, phone number, corporate account, etc.).

In some embodiments, the emergency data maintained by the clearinghouse is purged. In some embodiments, the data is purged on a regular or periodic basis. In some embodiments, data that is older than a defined threshold is purged. In some embodiments, different data types are purged according to different schedules and/or thresholds. For example, dynamic data (e.g., data that is subject to constant or regular change) such as location data may be more likely to become out-of-date over time and so may be purged more frequently than static data such as a permanent home address, which may remain permanently in the database until it is replaced with an updated address.

In some embodiments, an individual or group of individuals are associated with multiple identifiers. For example, the location ingestion module 251 receives a location generated by a phone associated with the phone number +1-555-555-5555, associated with John Doe. The additional data ingestion module 252 also receives a heartrate from a smartwatch associated with the email address johndoe@email.com, also associated with John Doe. In this example, the set of ingestion modules 258 tag the location with the phone number “+1-555-555-5555,” tag the heartrate with the email address “johndoe@email.com,” and associate both the location and the heartrate with John Doe in the clearinghouse databases 257.

In some embodiments, as depicted in FIG. 2, the clearinghouse 250 includes a set of retrieval modules 259. The set of retrieval modules 259 optionally include a location retrieval module 254, an additional data retrieval module 255, and one or more other data retrieval modules 256. In some embodiments, the location retrieval module 254 is an interface for retrieving location data from the clearinghouse databases 257. In some embodiments, the location retrieval module 254 is a JSON REST API that receives a query or request (e.g., in the form of an HTTP GET request) from a requesting party, such as an ESP. In some embodiments, the request is sent from a call-taking application (e.g., call taking module 145) integrated into the ESP system 130. In some embodiments, the request (also referred to as an “emergency data request”) is sent from an emergency response application 260. In some embodiments, the location retrieval module 254 provides a single GET endpoint for retrieving either the latest or paginated list of locations for a specific caller ID (e.g., an identifier of a user or an electronic device associated with a user, such as a phone number). For example, as described above, a phone number associated with a device 210 from which a location was received is included in the header, body, or metadata of the request sent to the location retrieval module 254. The clearinghouse 250 then retrieves a location or set of locations from the clearinghouse databases 257 and deliver the location or set of locations to the requesting party. In some embodiments, the location retrieval module 254 is a location information server (LIS). In some embodiments, the LIS is a NG911 standards-based XML API for the retrieval of location data from the clearinghouse databases 257. In some embodiments, as described above, the location retrieval module 254 accepts HELD requests from requesting parties and returns location data for a specific caller ID or anonymous reference. However, in some embodiments, the location retrieval module 254 automatically retrieves and transmits location data using a subscription system, as described below.

As depicted in FIG. 2, the set of retrieval modules 259 optionally include an additional data retrieval module 255. In some embodiments, the additional data retrieval module 255 is a JSON REST API for the retrieval of emergency or additional data. As described above, additional data optionally includes medical data, personal data, demographic data, and health data. Additional data also optionally includes data received from connected devices such as vehicles, IoT devices, and wearable devices. In some embodiments, the additional data retrieval module 255 receives a query or request (e.g., in the form of an HTTP GET request) from a requesting party, such as an ESP. In some embodiments, the request (also referred to as an “emergency data request”) is sent from an emergency response application 260. The additional data then retrieves additional data associated with a specific or particular identifier of a user or an electronic device associated with the user, such as a phone number, and returns the data to the requesting party. In some embodiments, the set of retrieval modules 259 further includes one or more other data retrieval modules 256, which function similarly to the location retrieval module 254 and additional data retrieval module 255, for the retrieval of data stored in the clearinghouse databases 257 not retrieved by the location retrieval module 254 or additional data retrieval module 255. However, in some embodiments, the additional data retrieval module 255 automatically retrieves and transmits additional data using a subscription system, as described below.

In some embodiments, a retrieval module within the set of retrieval modules 259 and a corresponding ingestion module within the set of ingestion modules 258 form a sub-clearinghouse. For example, in some embodiments, location ingestion module 251 and location retrieval module 254 combine to form location clearinghouse 150A (as shown in FIG. 1B). Likewise, in some embodiments, additional data ingestion module 252 and additional data retrieval module 255 combine to form additional data clearinghouse 150B. In some embodiments, a requesting party is only given access to a particular sub-clearinghouse. For example, a police officer is only given access to the location clearinghouse 150A, while an EMT (emergency medical technician) is only given access to the additional data clearinghouse 150B. However, a requesting party is given differential access to the clearinghouse 150, sub-clearinghouses, or particular emergency data categories within the clearinghouse 150 based on any factor or set of factors. In some embodiments, a requesting party initiates a query or request (e.g., an emergency data request) using an emergency response application 260 (as described below), which in turn generates the query and transmits the query to the clearinghouse 250.

In some embodiments, the clearinghouse 250 includes an emergency data streaming module or streaming module (not shown). In some embodiments, a streaming module is capable of both receiving and transmitting emergency data, but emergency data received by the streaming module is not stored within a database. Instead, emergency data is streamed through the streaming module without being committed to memory within the clearinghouse 250. In some embodiments, the streaming module establishes an active or persistent communication link (e.g., a websocket connection, as described below) between the EMS or clearinghouse 250 and an emergency data recipient. For example, in some embodiments in which emergency data is pushed from the EMS or clearinghouse 250 to an emergency data recipient, the streaming module can establish a persistent communication link between the EMS or clearinghouse 250 and the emergency data recipient, and any emergency data that is received by the EMS or clearinghouse 250 to which the emergency data recipient is subscribed (as described below) is pushed to the emergency data recipient through the persistent communication link without being committed to memory within the EMS or clearinghouse 250.

As described above, in some embodiments, an emergency management system (EMS) maintains a clearinghouse 250 that obtains and shares emergency data to aid emergency service providers (ESPs) in responding to emergencies. During an emergency, in some embodiments, an ESP can send an emergency data request to the EMS through the emergency response application 260, and, in response, the EMS can send any available emergency data associated with the emergency back to the emergency response application 260. In some embodiments, as described above, the emergency response application 260 includes an identifier associated with an emergency alert in the emergency data request. The EMS can then use the identifier associated with the emergency alert to retrieve emergency data associated with the emergency alert from the clearinghouse. For example, as described above, an ESP 230 (e.g., a public safety answering point (PSAP)) can receive an emergency alert in the form of a 9-1-1 phone call (representative of an emergency or potential emergency) from a mobile phone associated with a phone number (e.g., (555) 555-5555). The ESP 230 can then send an emergency data request including the phone number (e.g., the identifier of the emergency alert) to the EMS, which can then retrieve any emergency data within or otherwise accessible by the clearinghouse 250 associated with the phone number and return the available emergency data to the requesting ESP 230. This process of returning emergency data to the emergency response application 260 in response to an emergency data request is referred to as “pulling” emergency data from the clearinghouse.

However, in some embodiments, the EMS can “push” emergency data from the clearinghouse 250 to the emergency response application (e.g., the EMS can send emergency data to the emergency response application 260 without receiving an emergency data request). In some embodiments, the EMS pushes emergency data to the emergency response application 260 using an emergency data subscription system. Using the emergency data subscription system, a recipient (or potential recipient) of emergency data from the clearinghouse 250 can subscribe to the clearinghouse 250 for a particular device identifier, user identifier, or ESP account (hereinafter, “subscription”). After subscribing to a subscription, the recipient (e.g., an ESP) may automatically receive updates regarding the subscription without first sending an emergency data request. For example, in some embodiments, if an ESP subscribes to a phone number, whenever the clearinghouse 250 receives updated emergency data associated with the phone number, the clearinghouse 250 can automatically send the updated emergency data associated with the phone number to the ESP (e.g., through the emergency response application 260), without first receiving an emergency data request including the phone number. For example, in some embodiments, if a recipient is subscribed to a particular phone number, and the clearinghouse 250 receives a new or updated location associated with the particular phone number, the clearinghouse 250 will instantly and automatically push the new or updated location associated with the particular phone number to the recipient the moment that the new or updated location is received by the clearinghouse 250, without the recipient having to send an emergency data request. In some embodiments, when an ESP or ESP personnel accesses the emergency response application 260 at a computing device associated with the ESP or ESP personnel, the EMS establishes a persistent or active communication link (e.g., a websocket connection) with the computing device in order to push emergency data regarding a subscription to which the ESP or ESP personnel is subscribed to the emergency response application 260.

In some embodiments, an active communication link is a connection, or a potential connection (e.g., two corresponding endpoints), between two entities (e.g., an EMS and an ESP) through which data can be freely transmitted (e.g., without a recipient entity having to actively accept transmitted data). In some embodiments, an active communication link is a persistent communication link. In some embodiments, a persistent communication link is a communication link that endures for a period of time that is not dependent on the transmission of a particular packet of data. For example, in some embodiments, a persistent communication link between two entities (e.g., an EMS and an ESP) endures until the communication link is actively terminated by one of the entities, as opposed to passively terminating once a particular packet of data (e.g., a particular emergency alert) has been transmitted. In another example, a persistent communication link endures for a predetermined amount of time (e.g., five minutes or an hour). In another example, a persistent communication link established between an EMS and an ESP through an emergency response application endures until a login session on the emergency response application is terminated or the emergency response application itself is terminated. In some embodiments, a persistent communication link is a websocket connection. WebSocket is a type of computer communications protocol. A websocket connection is a longstanding or persistent internet connection between a client and a server that allows for bidirectional communication between the client and server without the client needing to send data requests to the server, which differentiates the WebSocket computer communications protocol from other types of computer communications protocols such as the HyperTextual Transfer Protocol (HTTP). The WebSocket protocol is often used by chat clients to facilitate user to user webchats. In some embodiments, the EMS establishes an active communication link with a computing device (e.g., an ESP console 130) in response to receiving an emergency data request. In some embodiments, the EMS establishes an active communication link with an ESP console when an ESP personnel logs into the emergency response application 260 at the ESP console. In some embodiments, the EMS establishes an active communication link with a responder device when an ESP personnel logs into the emergency response application 260 at the responder device. In some embodiments, an active communication link established between the EMS and a computing device associated with ESP personnel is maintained by the EMS for the duration of the ESP personnel's log-in session.

In some embodiments, the EMS automatically subscribes a recipient to a subscription (e.g., a particular device identifier or user identifier) in response to receiving an emergency data request including the subscription or an identifier of the subscription. For example, in some embodiments, when an ESP personnel sends an emergency data request including a phone number to the EMS through their ESP console (e.g., through the emergency response application 260), the EMS subscribes the ESP personnel to the phone number and establishes a persistent or active communication link with the ESP console. Then, whenever the clearinghouse 250 receives updated emergency data associated with the phone number, the EMS can automatically push the updated emergency data associated with the phone number to the ESP console. For example, an ESP personnel logs into an emergency response application 260 in communication with the EMS on the ESP personnel's ESP console. Subsequently, the ESP personnel receives a 9-1-1 call from a mobile phone and then generates and sends an emergency data request including the phone number of the mobile phone to the EMS through the emergency response application 260. The EMS then uses the phone number of the mobile phone to retrieve the most recent location associated with the mobile phone received by the clearinghouse and returns the most recent location associated with the mobile phone to the ESP personnel through the emergency response application 260. The EMS simultaneously subscribes the ESP personnel to the phone number of the mobile phone and establishes a websocket connection between the EMS and the ESP console and automatically pushes any updated emergency data (e.g., enhanced locations) associated with the phone number received by the clearinghouse to the emergency response application 260 as soon as the updated emergency data associated with the phone number is received by the clearinghouse 250.

In some embodiments, an ESP is associated with an identifier of the ESP (e.g., a unique ESP account ID; also referred to as an “ESP identifier”) that an ESP or ESP personnel can subscribe to. The EMS can then establish a persistent or active communication link with a computing device associated with an ESP or ESP personnel subscribed to the unique ESP identifier and push emergency data associated with the unique ESP identifier to the computing device (e.g., through the emergency response application 260) whenever new or updated emergency data associated or tagged with the unique ESP identifier is received by the clearinghouse 250. For example, in some embodiments, when the clearinghouse 250 receives a location (e.g., an emergency location) associated with an emergency alert (e.g., when a person calls 9-1-1 from a mobile phone and the mobile phone responsively sends a current location of the mobile phone to the clearinghouse 250), the EMS retrieves one or more geofences (as described below) associated with each ESP registered with the EMS and determines which (if any) of the geofences that the location associated with the emergency alert falls within. The EMS then tags the location associated with the emergency alert with the unique ESP identifiers associated with each of the ESPs associated with geofences that the location associated with the emergency alert falls within. For example, if four ESPs are registered with the EMS—ESP A, ESP B, ESP C, and ESP D—and the clearinghouse 250 receives a location associated with an emergency that falls within the one or more of the geofences associated with ESP A and ESP D, the EMS can tag the location associated with the emergency alert with the unique ESP account ID associated with ESP A and the unique ESP account ID associated with ESP D. The EMS can then push the location associated with the emergency alert to any ESPs or ESP personnel with an established persistent or active communication link with the EMS and currently subscribed to either the unique ESP account ID for ESP A or the unique ESP account ID for ESP D. In some embodiments, when an ESP personnel logs into the emergency response application 260, a communication is sent to the EMS that includes one or more unique ESP account IDs that the ESP personnel or their respective ESP is currently subscribed to.

### Emergency Data Geofencing

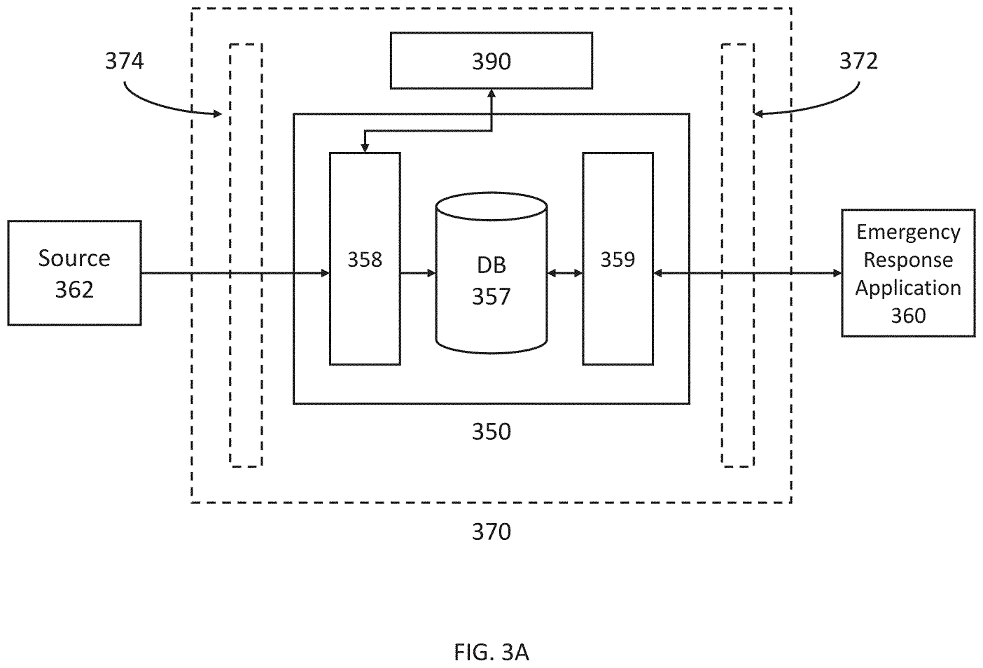

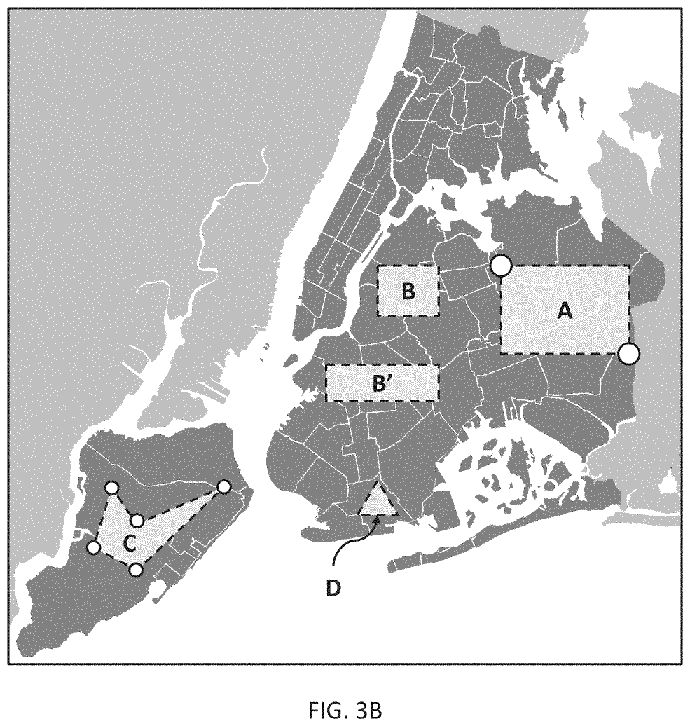

FIG. 3 depicts a diagram of a geofence applied to a clearinghouse for emergency data. In some embodiments, a geofence module 370 is applied to the clearinghouse 350 to protect potentially sensitive emergency data using geospatial analysis. In some embodiments, as described above with respect to FIG. 2, the clearinghouse 350 includes a set of ingestion modules 358 and a set of retrieval modules 359. In some embodiments, one or more ingestion modules within the set of ingestion modules 358 are managed by a modular API system (MAS) 390, as described below. The set of ingestion modules can receive emergency data, or other information that can be useful in responding to an emergency, from a variety of sources. For example, in some embodiments, a smartphone sends emergency data to the clearinghouse 350 in the form of an HTTP POST API call in response to a user of the smartphone initiating a 911 emergency call. As depicted in FIG. 3, in some embodiments, when emergency data (e.g., an emergency location or additional emergency data) is sent (directly or indirectly, such as through a third-party server) from an electronic device 310 to the clearinghouse 350, the emergency data is first processed by a geofence module 370 before being received by the set of ingestion modules 358 within the clearinghouse 350. Similarly, in some embodiments, when an emergency data request is sent from a requesting party (e.g., through an emergency response application 360, as described below), the emergency data request is processed by the geofence module 370 before being received by the set of retrieval modules 359.

In some embodiments, as mentioned above, a geofence module 370 is applied to the clearinghouse 350 to protect potentially sensitive emergency data using geofences. Generally, a geofence is a virtual perimeter for a real-world geographic area. A geofence can be dynamically generated—as in a radius around a point location—or a geofence can be a predefined set of boundaries (such as school zones or neighborhood boundaries). The use of a geofence is called geofencing, and one example of usage involves a location-aware device of a location-based service (LBS) user entering or exiting a geofence. Entry or exit from a geofence could trigger an alert to the device's user as well as messaging to the geofence operator. The geofence information, which could contain the location of the device, could be sent to a mobile telephone or an email account.

For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. In some embodiments, geofences only represent authoritative regions if the geofence has been assigned or verified by a local, state, or federal government. In some embodiments, geofences represent assigned jurisdictions that are not necessarily authoritative regions. For example, in some embodiments, a geofence is unilaterally created by its associated ESP without verification or assignment by a local, state, or federal government.

Geofences can be defined in various ways. For example, in some embodiments, a geofence comprises one or more of the following: a county boundary, a state boundary, a collection of postal/zip codes, a collection of cell sectors, simple shapes, complex polygons, or other shapes or areas. In some embodiments, geofences comprise approximations where the “approximated” geofence encloses an approximation of the authoritative region.

Updates to geofences may be required over time because the authoritative regions may change over time. Geofences may change over time (e.g., a new sub-division has cropped up) and require updates. In some embodiments, the systems and methods described herein allow geofences to be updated (e.g., a PSAP administrator can upload updated geofence GIS shapefiles).

For maintaining the privacy, security and integrity of the data, geofencing may be applied to emergency data. For example, applying geofence filters to the emergency data allows additional avenues for monitoring, both visibility and control, over the clearinghouse to detect anomalies/spikes and reduce the risk of security breaches.

In some embodiments, the emergency data is obtained or received from an emergency data source 362 (such as an electronic device or third-party server, as described above) by the clearinghouse 350. Then, geofencing can be applied to the emergency data in various ways. In some embodiments, an ingestion geofence 374 (also referred to as “upstream filtering”) is applied to restrict sending of data from emergency data sources 362 to the clearinghouse 350 from geographical areas that are not covered by the “combined authoritative jurisdiction” (e.g., covered one or more provisioned geofences in the geofence database 376). In such an embodiment, the geofence module 370 identifies a location associated with the emergency data (e.g., a device-based hybrid location received from a mobile phone as part of an emergency alert) and determines if the location falls within any of the geofences stored within the geofence database 376. In some embodiments, the ingestion geofence (also referred to as an “ingress filter”) is applied to the ingestion module 358 to protect against accidental breaches of privacy. In some embodiments, the ingestion module 358 of the clearinghouse 350 drops location payloads that do fall within the geographical region covered by the “combined authoritative region.” In some embodiments, geofencing is applied to determine if a location associated with emergency data received by the clearinghouse 350 falls within any of the geofences stored within the geofence database 376, and, if so, which entity is associated with the geofence that the location falls within, as described below.

In some embodiments, the clearinghouse 350 comprises one or more databases 357 (e.g., a database storing emergency data). For example, in some embodiments, the retrieval module 359 obtains emergency data from a clearinghouse database 357 to send to an emergency data recipient (e.g., an ESP) in response to an emergency data request, as described above. In some embodiments, the retrieval geofence 372 (also referred to as an “egress filter”) is applied at the retrieval module 359 of the clearinghouse 350. Applying geofencing to retrieved emergency data will protect against abuse and limit the scope of security breaches in cases where credentials have been compromised. In some embodiments, one or more geofences are associated with one or more credentials associated with an ESP agency or organization. In some embodiments, the credentials associated with an ESP agency or organization confers authorization to access data such as emergency data from the clearinghouse. In some embodiments, specific authorization to access data is granted individually to members of a PSAP through tokens derived from the credentials for that PSAP.

In some embodiments, when the retrieval module 359 checks the coordinates of current location data (within retrieved emergency data) associated with a device identifier with the geofence(s) associated with the credentials in an emergency data request. If the current location is within the geofence region (enclosed by the geofence(s)), the current location is returned to the ESP and displayed within the ESP console. If not, the module 359 will return a “not found” message (as opposed to the retrieved location is outside the geofence) to protect privacy.

In some embodiments, geofences can be used for reporting results for internal metrics and monitoring the system. For example, the number of emergency data requests, locations provided, “no location found” etc., can be obtained for a geofence(s) associated with a PSAP. Using single or combined geofences, the emergency data can be obtained on county-wide, city-wide, postal code, course grid (rectangle overlay), state-wide, or country-wide basis. In some embodiments, ingress and egress counters (e.g., percent of emergency sessions where the location data was received, but not queried) and other similar metrics can be calculated and analyzed to identify problems and spikes. In some embodiments, different geofences are used for retrieval and for reporting.

In some embodiments, a location associated with a given emergency can be determined to fall within a plurality of geofences, as described below. In some embodiments, emergency data for the emergency is pushed to each PSAP having a geofence that the emergency (e.g., the location associated with the emergency) falls within. In some embodiments, emergency data for the emergency is transmitted to a subset of PSAPs having a geofence that encloses or encompasses the location associated with the emergency. In some embodiments, the location data of an individual device identifier is not transmitted to more than one PSAP at one time. Thus, the emergency data is only transmitted to one PSAP (e.g., a primary agency), but may be transmitted to multiple secondary agencies (e.g., police departments) and regional agencies. In some embodiments, the emergency data is transmitted to one or more emergency responders who may be associated with an ESP (e.g., police officers working for a police department). In some embodiments, wherein a device identifier egresses a geofence in which communication began and ingresses into a neighboring geofence, the location data is automatically transmitted to the neighboring PSAP with jurisdiction over the ingress geofence.

In some embodiments, to determine the appropriate ESP(s) for sharing emergency data, the authoritative jurisdiction (defined by one or more geofences) of an ESP (e.g., primary agency) is evaluated before it is used by the geofence module 370. In case of irregularities (e.g., overlaps, islands, or other irregular features), steps may be taken to check with respective agency, geographical boundaries (national and international borders, county lines, rivers, hills, etc.), or other authority. In some embodiments, call routing data may be analyzed to see which ESP is answering the emergency call.

Raw geofences may be pre-processed to generate processed geofences using a variety of techniques. For removing irregularities, a geofence may be processed to resolve overlaps, remove islands and projections, smooth boundaries, modifying the file format or size, etc.

In some cases, there may be overlap between geofences of two or more ESPs. In some embodiments, the emergency data may be shared with the two or more ESPs to err on the side of making mission critical information to all entities that may be involved in the emergency response. In some embodiments, the two or more ESPs are primary agencies (e.g., PSAPs) and the emergency data has to be shared with one appropriate ESP. To determine the appropriate ESP(s) for sharing emergency data, the authoritative jurisdiction (defined by one or more geofences) of the overlapping ESPs by checking with respective agency, geographical boundaries (national and international borders, county lines, rivers, hills, etc.), sample routing data, etc. In contrast, if the overlapping ESPs include one or more secondary ESPs, the overlap may be retained and emergency data may be shared with one or more ESPs (e.g., one primary agency and two secondary agencies).

In some embodiments, a buffer (e.g., +10 km) is added to the geofence(s) so that results within the buffer zone are also returned. In many cases, PSAPs have discretion and incentive to respond to emergencies that are beyond their authoritative jurisdiction. As an example, a geofence that is a circular area with a radius of 10 km would have an area of 100π or ˜314 km2, whereas the same area with a 10 km buffer around its circumference would have yield a combined radius of 20 km and a combined area of 400π or ˜1256 km2. In some embodiments, the buffer is from 0.5 km to 5 km, from 0.5 km to 10 km, from 0.5 km to 15 km, from 0.5 km to 20 km, from 0.5 km to 25 km, or from 0.5 km to 30 km. In some embodiments, the buffer is from 1 km to 5 km, from 1 km to 10 km, from 1 km to 15 km, from 1 km to 20 km, or from 1 km to 30 km. In some embodiments, the buffer is at least 0.1 km, at least 0.2 km, at least 0.3 km, at least 0.4 km, at least 0.5 km, at least 0.6 km, at least 0.7 km, at least 0.8 km, at least 0.9 km, at least 1 km, at least 2 km, at least 3 km, at least 4 km, at least 5 km, at least 6 km, at least 7 km, at least 8 km, at least 9 km, at least 10 km, at least 11 km, at least 12 km, at least 9 km, at least 14 km, at least 15 km, at least 16 km, at least 17 km, at least 18 km, at least 19 km, at least 20 km, at least 25 km, or at least 30 km. In some embodiments, the buffer is no more than 0.1 km, no more than 0.2 km, no more than 0.3 km, no more than 0.4 km, no more than 0.5 km, no more than 0.6 km, no more than 0.7 km, no more than 0.8 km, no more than 0.9 km, no more than 1 km, no more than 2 km, no more than 3 km, no more than 4 km, no more than 5 km, no more than 6 km, no more than 7 km, no more than 8 km, no more than 9 km, no more than 10 km, no more than 11 km, no more than 12 km, no more than 9 km, no more than 14 km, no more than 15 km, no more than 16 km, no more than 17 km, no more than 18 km, no more than 19 km, no more than 20 km, no more than 25 km, or no more than 30 km.

FIG. 3B illustrates non-limiting examples of geofence approximations that may be submitted as an “authoritative jurisdiction” for an ESP. One or more geofences enclose the geofenced region which is under the authoritative jurisdiction of an ESP. In some cases, the geofenced region may be a complex polygon, but it may be approximated using an appropriate shape. For example, a rectangle (A), two disjointed rectangles (B, B′), a polygon with several sides (C) and a triangle (D), may represent different geofenced regions (defined by one or more geofences).

In some embodiments, an administrator of a PSAP submits the complex authoritative jurisdiction as one or more approximate geofence(s) by specifying points. For example, the PSAP administrator can submit geofenced region A by specifying two points—the north-west corner and the south-east corner using a drawing tool provided by the GUI of an emergency response application. In this example, the two points of the geofenced region are set using two latitude-longitude coordinates. In another example, the multiple-sided polygon C is submitted by specifying the five corners. In some embodiments, a PSAP administrator approximates a geofence for a PSAP by drawing one or more polygons using a drawing tool provided by the GUI of the emergency response application. In some embodiments, a geofence is generated using a series of points that are connected (e.g., entering three longitude-latitude points on a map to form a triangular geofence).

Approximating a complex geofenced region has several advantages. The geofence(s) are simple and the calculations can be quicker and less cumbersome for applications where exact calculations are not needed.

In some embodiments, a PSAP administrator can submit a GIS file (e.g., a shapefile) that represents the actual authoritative jurisdiction of the PSAP, which may then be provisioned in a geofence database. It is appreciated that a GIS file defining the authoritative jurisdiction may be saved in one or more industry-acceptable formats such as a shapefile, a GeoJSON file, KML file, etc. In some embodiments, the GIS file includes one or more features such as points, lines, polygons, density, and other shapes. A GeoJSON is open standard GIS file representing geographical features and non-spatial attributes based on JavaScript Object Notation. Some non-limiting examples of features include points (such as addresses and locations), line strings (streets, highways and boundaries), polygons (countries, provinces, tracts of land), and multi-part collections of these types. A Keyhole Markup Language (KML) file includes geographic annotations and visualization on internet-based maps on Earth browsers. A shapefile is a vector data format for storing the location, shape, and attributes of geographic features. A shapefile is stored in a set of related files, each of which may contain one feature class (e.g., lines, points, polygons, etc.). In some embodiments, the shapefile is a file with extension. SHP in ESRI file format where SHP is the feature geometry, SHX is the shape index position and DBF is the attribute data.

Various embodiments of the geofence database are contemplated. In some embodiments, one or more databases are searchable using a PSAP identifier, credentials, or other information. In some embodiments, an emergency location is searched through several geofences in the geofence database. In some cases, the geofenced region is shrunk for ease of storage and to simplify calculations.

### Modular API System (MAS)

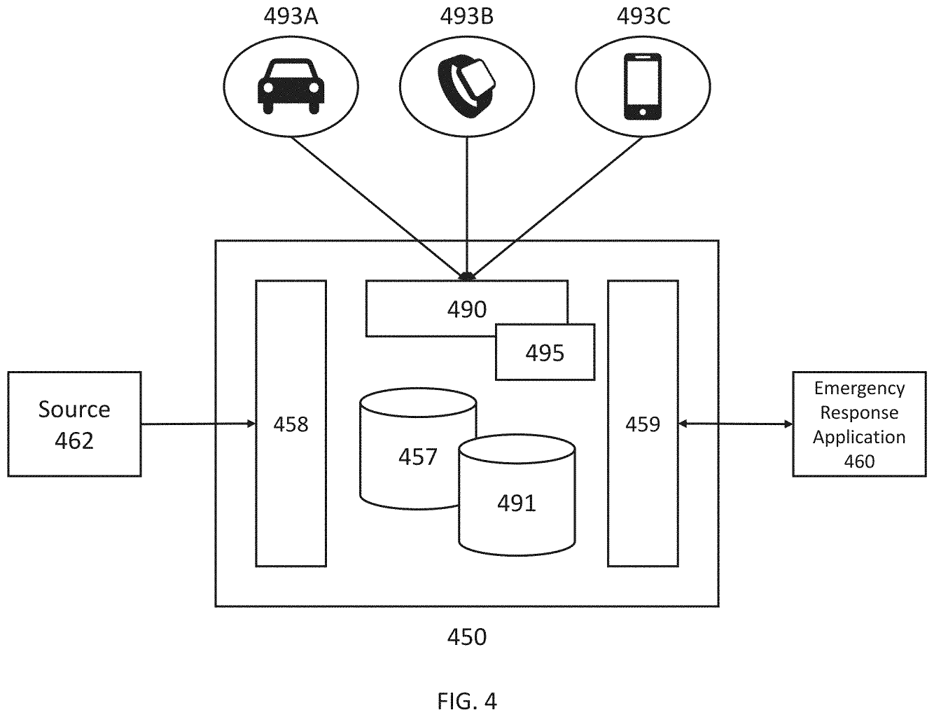

As mentioned above, in some embodiments, an emergency management system (EMS) includes a clearinghouse 450 for receiving, storing, retrieving, and transmitting emergency data. In some embodiments, the clearinghouse 450 includes a set of ingestion modules 458, one or more databases 457, and one or more retrieval modules 459. In some embodiments, the EMS or clearinghouse 450 includes or is otherwise communicatively coupled to a modular application programming interface (API) system (MAS) for receiving data packets from a dynamically growing set of data sources without requiring redundant engineering work to be done whenever a new data source is added to the set of data sources. FIG. 4 depicts a diagram of a clearinghouse and a modular application programming interface system (MAS) in accordance with some embodiments of the present disclosure. In some embodiments, the MAS 490 includes one or more data ingestion modules, such as a data ingestion module included in the ingestion modules 458, which may be an application programming interface (API) or an equivalent. In some embodiments, the MAS 490 includes a schema editor interface (as described below) and one or more schema databases 491 (which may be included in the one or more clearinghouse databases 457). In some embodiments, the MAS 490 includes a validation interface, as described below. In some embodiments, the MAS 490 includes a library of actions, as described below. Although the MAS 490 is often discussed herein in the context of emergency data applications, it will be understood that the MAS 490 may be helpful and utilized in many different applications and data environments.

An application programming interface (API) is a computing interface which defines interactions between multiple software intermediaries. It defines the kinds of calls or requests that can be made, how to make them, the data formats that should be used, the conventions to follow, etc. For example, an emergency alert (e.g., a data packet containing data associated with an emergency or a potential emergency) may be transmitted from a data source 462 (e.g., a mobile phone) to the EMS or clearinghouse 450 through an API defined by one of the data ingestion modules within the set of ingestion modules 458. In this example, the multiple software intermediaries are a software module included in the data source 462 and a software module included in the clearinghouse 450. The API (e.g., the data ingestion module) defines where the data source 462 can send the emergency alert (also referred to as an “endpoint”), the types or amount of data that can be sent to the endpoint, and the format(s) that the data can be sent in. In many cases, the types or amount of data that can be sent to an endpoint and the format(s) that the data can be sent in are defined in a template that can be referred to as a “data schema” (hereinafter, “schema” or “traditional schema”).

In a very simple example, an email service allows its users to send emails using a mobile email application. To do so, the email service develops an API on their backend servers. Users using the email service's mobile application can transmit send email commands to the email service's backend servers through the API. In this example, for the email service to send an email, the email service needs to know at least an identifier of the sending user (e.g., an email address associated with the sending user) an identifier of at least one receiving user (e.g., an email address associated with the at least one receiving user), and the content of the email message. Thus, the schema defined for the send email command and written into the email service's API for the email sending function may contain three “key-value pairs” each defined by a data field and a data type (e.g., {data field 1, data type 1; data field 2, data type 2; data field 3, data type 3}): {sending email address, string; receiving email address, string; email message, string}. Then, when a user uses the graphical user interface (GUI) of the mobile email application to send an email, the user's phone (instructed by the mobile email application) transmits a send email command to the endpoint specified or defined by the API. The send email command should include all three data fields and valid values for the three data fields, and the API will make sure this condition is met by validating the data included in the send email command against the schema defined by or within the API. If the send email command does meet those conditions, the data is considered validated against the schema, and the API can initiate the email sending function on the email service's backend servers. If the send email command does not meet those conditions, the data will be considered invalid in relation to the schema, and the API will not be able to initiate the email sending function.

Generally, a single API contains or defines a single schema, which is “hardcoded” into the API, meaning that the schema is written directly into the code of the API, which is a structure that works just fine for many applications. However, using such a structure, if a data source wishes to send additional data, different kinds of data, or different amounts of data to the endpoint that are not already included in the pre-existing schema, the schema must be reengineered, or a new API must be developed, both options requiring additional engineering work. As discussed herein, the modular API system (MAS) 490 provides a system for a) a single API to use multiple schemas and b) editing existing schemas or creating/adding new schemas for the single API to use without requiring additional engineering work, thereby potentially saving considerable manhours of highly skilled labor.

For example, as described above, the EMS or clearinghouse 450 can receive emergency data from a variety of different emergency data sources 462, such as mobile phones, wearable devices, vehicle telematics systems, medical databases, mobile applications, etc. Each emergency data source 462 may send different kinds or different amounts of emergency data. For example, a mobile phone may be able to transmit an emergency location (e.g., an enhanced location) and any other information stored on the mobile phone, such as the user's home and work location or the user's emergency contacts; however, the user's wearable device may be additionally or alternatively able to transmit the user's heartrate or recent levels of physical activity. Additionally, new and additional emergency data sources 462 may be dynamically created and/or added to the network of devices and systems accessible by or otherwise communicatively coupled to the EMS or clearinghouse 450 on an ongoing basis. If, for example, new and different data sources are added to the network of devices and systems accessible by or otherwise communicatively coupled to the EMS on a regular basis (e.g., four new data sources per month), the manhours of engineering work required to update schemas or create new APIs could be considerable. Therefore, the modular API system (MAS) disclosed herein provides a solution that can quickly and easily create, edit and add modular API schemas 493 (hereinafter, “MAS schemas”) to a schema database 491 that is accessible by a modular API with little or no engineering work, as described below. Like traditional schemas, as described above, MAS schemas can define the types or amount of data that can be sent to an endpoint (e.g., an endpoint managed by the MAS) and the format(s) that the data can be sent in. Unlike traditional schemas, however, multiple MAS schemas may be employed by a single API (e.g., the modular API). Additionally, MAS schemas may include several other designations, such as visualization rules, as described below. When the modular API receives a data packet from a particular data source 462, the modular API can retrieve a MAS schema associated with that particular data source 462 from the schema database 491 and attempt to validate the data packet (or the data included in the data packet) against the MAS schema associated with the particular data source retrieved from the schema database 491, as opposed to a traditional API attempting to validate a data packet against a traditional schema hardcoded into the traditional API. For example, as shown in FIG. 4, the MAS 490 can receive MAS schemas 493 associated with different emergency data sources, such as a MAS schema 493A associated with a vehicle telematics system, a MAS schema 493B associated with a wearable device, and a MAS schema 493C associated with a mobile phone, and store all the different MAS schemas 493A-C into the schema database 491.

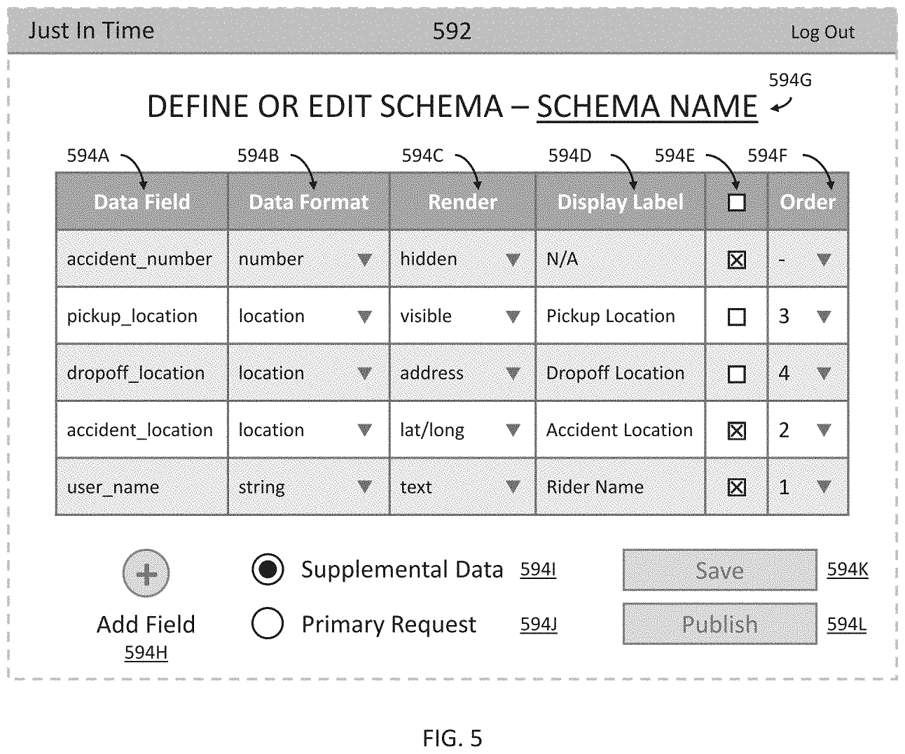

FIG. 5 illustrates a graphical user interface (GUI) of a schema editor interface in accordance with some embodiments of the present disclosure. As mentioned above, in some embodiments, a modular API system (MAS) provides a system for creating and editing schemas that can be stored in a schema database and later retrieved by a modular API. In some embodiments, schemas are created and edited within a schema editor interface 592. In some embodiments, a schema editor interface 592 provides a graphical user interface (GUI) that a user can use to create and edit MAS schemas and save new and edited MAS schemas within a schema database, as mentioned above. As mentioned above, a traditional schema defines the types and amount of data that can be received by an API for the API to properly execute its function. Generally, a single API is hardcoded with a single schema. Using the modular API system (MAS) disclosed herein, a single, modular API can use a plurality of MAS schemas, such as by retrieving a particular MAS schema from a plurality of MAS schemas stored within a schema database when the API receives a data packet from a data source associated with the particular MAS schema.

As illustrated in FIG. 5, in some embodiments, MAS schemas (such as those to be stored in a schema database, as mentioned above) can be created or edited within a schema editor interface 592. The schema editor interface 592 allows a user to create a new MAS schema containing any number of data fields with little to no programming or coding knowledge, experience, or work. In some embodiments, a user need only add a data field 594A (such as by selecting the Add Field button 594H), enter a name for the data field (which, in some embodiments, may need to exactly match the name of the data field when it is transmitted within a data packet) and select a data format 594B to be associated with the data field. In some embodiments, a data field must have at least a data format associated with it. For example, in the email sending function API example discussed above, the schema includes three data fields (sending email address, receiving email address, and email message), and each of the data fields has an associated data format (in this example, each has data format of “string”). As illustrated in FIG. 5, in some embodiments, a user can choose a data format 594B for each data field 594A, such as by selecting a data format from a drop-down list. In some embodiments, a user can select which, if any, of the data fields are mandatory for a data packet associated with the MAS schema to include. For example, in some embodiments, a user can select a check box 594E to designate the associated data field as mandatory. In some embodiments, a user can select to make all of the data fields listed in a MAS schema mandatory. In some embodiments, if a data field listed in a MAS schema is not designated as mandatory, it will be considered optional for the purposes of validating a data packet associated with the MAS schema, as described below. In some embodiments, the schema editor interface 592 allows a single data field to include multiple subfields (e.g., nested data fields). In some embodiments, the schema editor interface 592 allows a single data field to support multiple values. However, a schema editor interface 592 may provide any manner of editing and developing a MAS schema.

For example, in the example illustrated in FIG. 5, a user has created a new MAS schema for a ride sharing mobile application (e.g., Uber) within the schema editor interface 592. In this example, when a user of the ride sharing application experiences an emergency in a vehicle associated with the ride sharing application (e.g., if another passenger in the vehicle has a medical emergency, or if the vehicle gets into an accident), the user can select an emergency button within the ride sharing application, which prompts the user's mobile phone to transmit emergency data and an identifier of the MAS schema to the EMS (as described above), which is employing the modular API. The MAS schema here includes five different data fields 594A: accident_number (e.g., an internal identifier of the accident), pickup_location (e.g., where the user was picked up by the ride sharing vehicle), dropoff_location (e.g., where the user was to be dropped off by the ride sharing vehicle), accident_location (e.g., the location of the user when the user selected the emergency button), and user_name (e.g., the user's name). Each of the data fields 594A has been assigned a data format 594B using a drop-down list: number, location, location, location, and string, respectively. Three of the data fields 594A (accident_number, accident_location, and user_name) have been designated as mandatory data fields using the checkboxes 594E. The other two data fields 594A (pickup_location and dropoff_location) have not been designated as mandatory. Thus, in this example, when a data packet associated with the MAS schema illustrated in FIG. 5 is received by the modular API, the modular API retrieves the MAS schema and attempts to validate the data packet against the MAS schema (as described below) by verifying that the data packet includes at least the three mandatory data fields (accident_number, accident_location, and user_name) and that the those data fields are in the proper data format (number, location, and string, respectively). The data format required of a data field, and/or the mandatory designation of the data field, as defined by a MAS schema, may be referred to as validation requirements or validation criteria. In some embodiments, if the MAS is unable to validate the data packet against the MAS schema (e.g., if the data packet does not include a data value for a data field designated as mandatory by the MAS schema, or if the data packet includes a data value for a data field that is not in the data format defined by the MAS schema for the data field), the MAS (or the API managed by the MAS) returns an error message to the source of the data packet (e.g., the data source). For example, in some embodiments, if the data packet does not include a data value for a data field designated as mandatory by the MAS schema, the MAS returns an error message to the data source that indicates that the data packet is missing the mandatory data field. Alternatively, in some embodiments, if the data packet includes a data value for a data field that is not in the data format defined by the MAS schema for the data field, the MAS returns an error message to the data source that indicates that the correct data format that the data value should be in.

As mentioned above, the modular API system (MAS) may be utilized in many different applications and data environments. However, the MAS is often discussed herein in the context of emergency data applications, where it is particularly useful. As described above, provided herein is an emergency management system (EMS) for receiving, storing, and transmitting emergency data before, during, and after emergencies to aid in emergency response efforts. In some embodiments, as described above and below, the EMS includes a clearinghouse for receiving, storing, and transmitting emergency data and an emergency response application for visualizing emergency data. For example, in some embodiments, when a person dials an emergency number (such as 9-1-1 in the United States) on a mobile phone, the mobile phone transmits (directly or indirectly, such as through a third-party server) an emergency location generated for the caller's emergency (or potential emergency) by the mobile phone (e.g., an enhanced location, or a device-based hybrid location) to the clearinghouse. In some embodiments, after receiving the emergency location, the clearinghouse can determine an appropriate emergency service provider (ESP) to receive the emergency location (such as by using a geofencing system, as described above and below) and transmit the emergency location to the ESP. The emergency location can then be displayed within an emergency response application executed on a computing device at the ESP. In some embodiments, additional data associated with the caller or the caller's emergency location can be received or retrieved by the clearinghouse and transmitted to the ESP as well, such as any available medical or demographic information associated with the caller, which can then likewise be displayed within the emergency response application.

However, the emergency data (e.g., emergency locations and additional data) should be presented within the emergency response application in a way that is helpful and easily digestible for emergency service providers. To this end, in some embodiments, a MAS schema may additionally include one or more visualization rules associated with the individual data fields listed in the MAS schema. The visualization rules instruct the MAS (or a visualization engine, as described below) on how to display the data received in a data packet associated with a MAS schema if/when the data is transmitted to a recipient, as described below. In some embodiments, visualization rules may include a rendering option, a display label, or a display order. For example, different data formats 594B may be rendered in different ways. For example, in some embodiments, a string data format may be rendered as text, a link (e.g., a URL), or a file name. In such an embodiment, if a data format 594B selected for a data field 594A is selected to be a string, the schema editor interface 592 can present rendering options 594C for text, a link, or a file name, such as through a drop-down list. In some embodiments, a string may be a link that points to an image or a video, and the schema editor interface 592 can display rendering options 594C for an image or a video. In some embodiments, the rendering options 594C for a number data format are currency, date, or timestamp. In some embodiments, the rendering options 594C for a location data format are coordinates or street address. In some embodiments, the schema editor interface 592 provides a rendering option 594C of hidden for a data field, which instructs the MAS not to display the data field when data associated with the MAS schema is transmitted to a recipient. In some embodiments, the only rendering options 594C provided by the schema editor interface 592 for some data fields or data formats are hidden or visible. However, because the modular API system (MAS) can be applied in many different data environments, the schema editor interface 592 may provide any number of different data format 594B options and any number of rendering options 594C for an individual data format 594B.

In some embodiments, the schema editor interface 592 additionally or alternatively provides other options for controlling how data received by the modular API system (MAS) will be displayed if/when transmitted to a recipient. For example, in some embodiments, the schema editor interface 592 provides a user with the ability to add a display label 594D or a display order 594F for one or more data fields 594A, as illustrated in FIG. 5. In the example illustrated in FIG. 5, a user has entered “Pickup Location,” “Dropoff Location,” “Accident Location,” and “Passenger Name” as the display labels 594D for the data fields 594A “pickup_location,” “dropoff_location,” “accident_location,” and “user_name,” respectively. The user has also selected that the data fields be displayed in a particular order (in some embodiments, the order that the data fields are listed in within the MAS schema is used as the default display order). Because the user has selected “hidden” as the rendering option 594C for the data field “accident_number,” the display label 594D for the data field “accident_number” has been automatically listed as N/A (e.g., not applicable), and the data field “accident_number” has been given no value for display order. In some embodiments, the schema editor interface 592 provides a user with the ability to determine how values for data fields are styled when they are visualized by a visualization engine, as described below. For example, in some embodiments, the schema editor interface 592 allows the user to select a font, a font size, or any kind of font styling (bold, color, underline, italics) for values associated with data fields to be visualized in. In some embodiments, the schema editor interface 592 provides options for a data field 594A to be rendered as a clickable action, as described below.

In some embodiments, a user designates a MAS schema created within the schema editor interface 592 as supplemental data 5941 or a primary request for emergency service 594J (also referred to as a “primary request”). This designation influences how and when the data received in a data packet (e.g., an emergency alert) received by the MAS is transmitted to a recipient (e.g., an emergency service provider), as described below. In some embodiments, a MAS schema created in the schema editor interface 592 is given a schema name 594G. Finally, in some embodiments, once a user has finished creating or editing their MAS schema within the schema editor interface 592, the user can save the MAS schema for later editing, such as by selecting the save button 594K, or publish the MAS schema so that it may be used on live data by the MAS, such as by selecting the publish button 594L. In some embodiments, the selection of the publish button 594L prompts the MAS to store the MAS schema in a schema database, from where the MAS can retrieve the MAS schema when the MAS receives a data packet associated with the MAS schema, as described below. In some embodiments, the selection of the publish button 594L prompts the MAS to transmit the MAS schema to a validation step, where an administrator of the MAS can review and validate the MAS schema, such as for quality control or assurance purposes, as described below.

In some embodiments, after an emergency alert is received by the MAS and the MAS is able to successfully validate the data included in the emergency alert against an appropriate MAS schema, the data is tagged with visualization rules or other designations associated with the data fields as defined by the MAS schema. The data may be tagged with the visualization rules or other designations through metadata. For example, in some embodiments, if an emergency alert associated with the MAS schema illustrated in FIG. 5 is received and successfully validated by the MAS, the MAS will tag the five data fields included in the emergency alert (accident_number; pickup_location; dropoff_location; accident_location; and user_name) with their respective visualization rules. For example, the “pickup_location” data field will be tagged with “visible” as its rendering option, “Pickup Location” as its display label, and “3” as its display order. Additionally, in some embodiments, the emergency alert itself may be tagged as “Supplemental Data,” as described below.

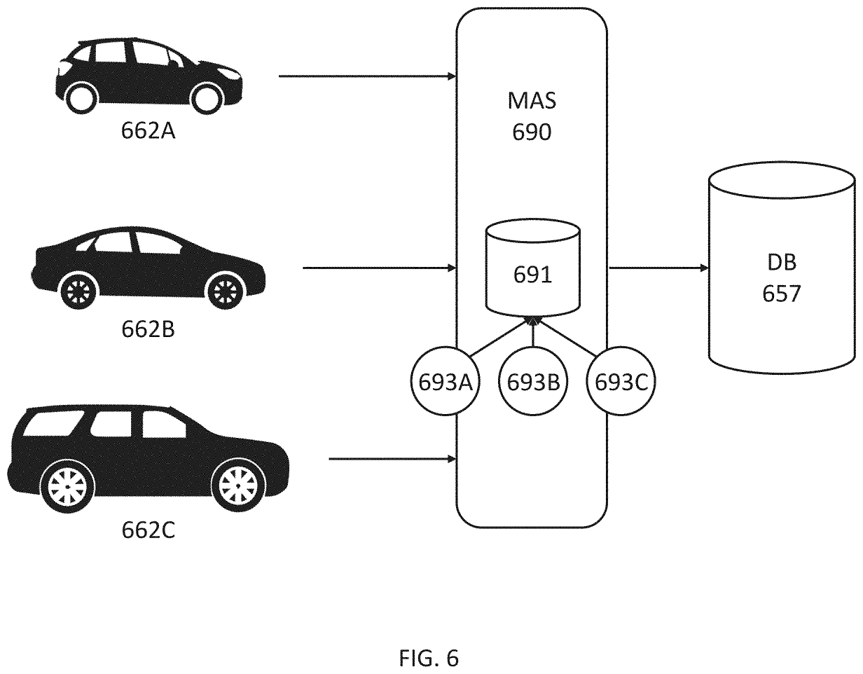

FIG. 6 depicts an application of a modular API system (MAS) in accordance with some embodiments of the present disclosure. As mentioned above, the MAS may be utilized and helpful in many different data environments and applications. FIG. 6 depicts one such application. In this example, a ridesharing company (e.g., Uber or Lyft) employs a MAS to receive telematics data from various vehicles in their ridesharing fleet. For example, the ridesharing company provides a mobile application (e.g., the Uber app) for its drivers and riders to use during rides. In this example, the mobile application is capable of communicating with telematics systems within a driver's vehicle (e.g., via Bluetooth or a USB connection). In this example, if the telematics system of a vehicle determines that the vehicle has gotten into an accident, and the driver is in the process of completing a ridesharing ride, the telematics system can transmit telematics data regarding the vehicle or the accident (e.g., the speed of the vehicle at, before, or after the time of the accident, the impacted area(s) of the vehicle, etc.) to the ridesharing company's backend servers and systems via the mobile application (e.g., using the wireless communication capabilities of the driver's phone) or the vehicles own wireless communication capabilities. The ridesharing company may use the telematics data for any number of purposes, such as for legal or insurance purposes.

However, the ridesharing company's drivers drive their own vehicles, which may be of many different makes and models. As such, the various vehicles within the ridesharing company's fleet may generate different kinds and different amounts of telematics data and in different formats. For example, an electric compact vehicle (e.g., data source 662A) may generate less data points and different data points than a traditional SUV (e.g., data source 662C). Furthermore, the fleet of vehicles may well be dynamically growing to encompass more and more makes and models of vehicles. Therefore, it would behoove the ridesharing company to employ a MAS so that the ridesharing company does not have to build a new API or reengineer the code of their existing API every time a new make or model is added to the fleet. Thus, as illustrated in FIG. 6, when a vehicle within the fleet transmits a data packet (e.g., telematics data sent in response to the detection of a crash) to the ridesharing company's backend system, the data packet is received by the MAS 690. The MAS 690 then retrieves a MAS schema 693 associated with the make and model of the vehicle (e.g., the data packet includes an identifier of the make and model, or an identifier of the MAS schema) from a schema database 691 and attempts to validate the data included in the data packet against the MAS schema 693 (as described below). In the example illustrated in FIG. 6, there are three different makes/models within the fleet (data sources 662A-662C) and three different MAS schemas (schemas 693A-693C, respectively) stored within the schema database 691. In this example, if the MAS 690 receives a data packet from data source 662A (the compact vehicle), the MAS 690 retrieves MAS schema 693A, associated with the compact vehicle 662A; if the MAS 690 receives a data packet from data source 662C (the SUV), the MAS 690 retrieves MAS schema 693C, associated with the SUV 662C. If the MAS 690 is able to successfully validate the data included in the data packet against the associated MAS schema, the MAS 690 can execute its function, which, in this example, is storing the validated data within one of the ridesharing company's databases 657.

### Emergency Flow Management System

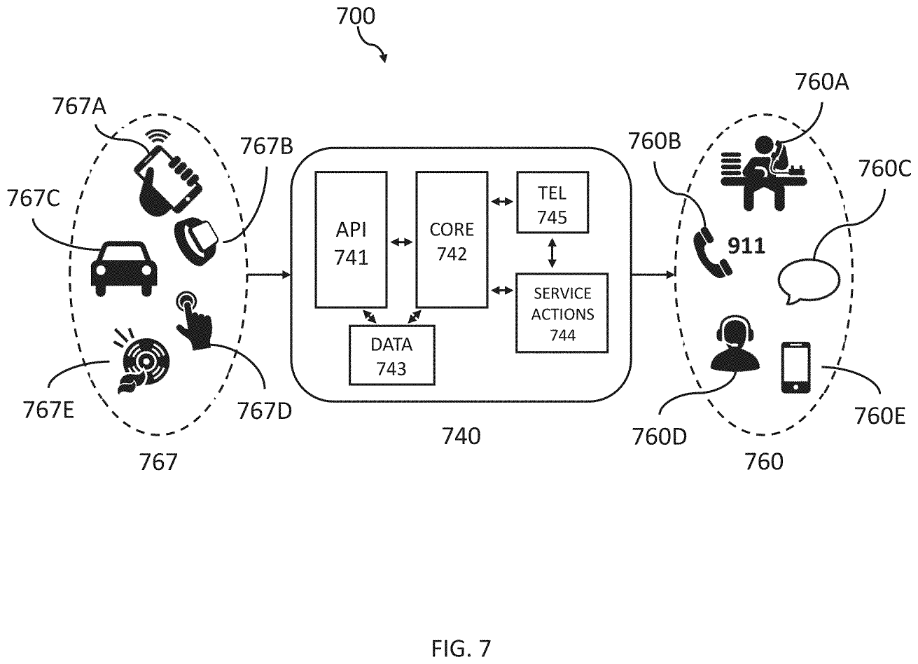

A modular API system (MAS) may be implemented in various ways. In some embodiments, as described below, the MAS is implemented through and/or as part of an emergency flow management system (EFMS). FIG. 7 depicts an embodiment of a system 700 including triggering devices 767, an Emergency Flow Management System (EFMS) 740, and output services 760. One advantage provided by the systems, servers, devices, and methods described herein is the ability to facilitate emergency response communications across devices, services, and systems managed by different parties. As will be discussed in further detail, in some embodiments, the EFMS 740 is capable of being reconfigured and customized by any individual or organization (e.g., a smartphone application developer or a wearable device manufacturer) such that the EFMS 740 can be seamlessly integrated into the devices, services, and/or systems provided by the individual or organization (hereinafter, “administrator”) according to the individual or organization's specific needs. Accordingly, as shown in this embodiment, the system 700 is implemented with a variety of triggering devices 767 and a variety of output services 760.

In some embodiments, a triggering device 767 is activated and delivers an emergency alert to the EFMS 740. In some embodiments, the triggering device 767 is an electronic device associated with a user, such as a smartphone 767A (e.g., an iPhone), a wearable device 767B (e.g., an Apple Watch or FitBit tracker), or a smart home IoT device 767E (e.g., an Amazon Echo or a Nest smoke and carbon monoxide alarm). In some embodiments, the triggering device is a vehicle 767C such as a car or truck. In one example of such an embodiment, the vehicle 767C includes an intelligent vehicle system capable of detecting when a component of the vehicle 767C has failed or when the vehicle 767C has been in an accident or otherwise compromised. In another example of this embodiment, the vehicle 767C includes or is otherwise communicatively coupled to a vehicle safety service that can connect the passengers of a vehicle that has been compromised with a first responder or a customer service agent (e.g., OnStar or AAA). In this example, when the vehicle 767C becomes compromised, the intelligent vehicle system can deliver an emergency alert to the vehicle safety service, which may in turn attempt to contact passengers of the vehicle 767C or send a corresponding emergency alert to another recipient (e.g., to the EFMS 740). In some embodiments, the triggering device comprises a software or hardware panic button 767D. As an example, the triggering device 767 is a physical button installed under the steering wheel of a taxicab, so that a taxi driver who feels threatened by a passenger (e.g., a passenger with a weapon or a passenger who is being verbally abusive) may discreetly call for help. Similarly, in another example, the triggering device 767 is a digital button found in a graphical user interface of a ride sharing smartphone application (e.g., the Uber app) that a passenger may select to discreetly call for help if the passenger feels threatened by a driver of a ride sharing vehicle.

In some embodiments, the triggering device 767 is triggered via user input or automatic detection. For example, in embodiments in which the triggering device is a wearable device 767B (e.g., an Apple Watch), the wearable device 7367B comprises at least one sensor such as a gyroscope, an accelerometer, and/or a heart rate monitor. In this example, if the heart rate monitor detects that the heartrate of the user is abnormal (e.g., higher or lower than average for the user, or arrhythmic), and the gyroscope and/or accelerometer detect a sudden, downward motion of the wearable device 767B (e.g., acceleration exceeds a threshold), the wearable device 767B determines that the user has potentially fallen due to a cardiac emergency and may need assistance. In response to such a determination, the wearable device 767B automatically delivers an emergency alert to the EFMS 740 without input from the user. Alternatively, in some embodiments, if a user of a wearable device 767B feels that they are experiencing or soon to experience a medical emergency, the user optionally selects a button on the wearable device 767B to manually deliver an emergency alert to the EFMS 740. Similarly, in some embodiments, a user of a smartphone 767A or wearable device 767B who is under assault or feels they will soon be under assault is able to select a button on the smartphone 767A or wearable device 767B to manually deliver an emergency alert to the EFMS 740. In some embodiments, the emergency alert is delivered to the EFMS 740 by an electronic device communicatively coupled to the triggering device. For example, in some embodiments, a wearable device coupled to a cell phone via Bluetooth generates an emergency alert that is then delivered to the EFMS by the cell phone via Wi-Fi or cellular data.

In another example, in an embodiment in which the triggering device 767 is a smart home device 767E, the smart home device optionally includes at least one sensor such as a smoke detector or carbon monoxide detector. In this example, when the smart home device 767E detects a concentration of carbon monoxide that exceeds a threshold concentration, the smart home device 767E determines that the user and or house of the user is in a state of emergency, and automatically deliver an emergency alert to the EFMS 740. In another example, when a user is experiencing an emergency, the user optionally manually prompts the smart home device 767E to deliver an emergency alert to the EFMS 740 by pressing a button on the smart home device 767E or by interacting with the smart home device 767E non-physically, such as by verbally communicating with the smart home device 767E (e.g., by saying aloud, “[name of smart home device 767E], call 9-1-1”). In another example of this embodiment, the smart home device 767B includes a video camera or optical sensor. When the video camera (and accompanying software and/or processor) or optical sensor determines the presence of an unauthorized person inside or otherwise proximal to the house of the user, in some embodiments, the smart home device 767E automatically delivers an emergency alert to the EFMS 740. Alternatively, the triggering device 767 is a non-optical device or application and is activated manually or automatically in any fashion.

In some embodiments, the EFMS 740 is configured to receive an emergency alert from a triggering device 767 and execute an emergency flow, as will be discussed in further detail below. In some embodiments, as depicted in FIG. 7, the EFMS 740 includes an API module 741, a core module 742, a data module 743, a service actions module 744, and a telephony module 745. In some embodiments, these modules interact to execute premade or customized emergency flows. In some embodiments, the emergency flows are executed according to various configurations of emergency flow building blocks, wherein the emergency flow building blocks each represent an emergency flow script that performs at least one function. In some embodiments, the various configurations of emergency flow building blocks are labeled and identified with unique emergency flow identification numbers (hereinafter, “emergency flow ID”). In some embodiments, an emergency alert delivered to the EFMS 740 from a triggering device 767 is accompanied by an emergency flow ID, which is recognized by the API module 741 to point to an associated emergency flow for execution by the EFMS 740.

In some embodiments, the EFMS 740 is configured to receive an emergency alert delivered from a triggering device 767 at the API module 741. In some embodiments, the API module 741 is one of the ingestion modules in the set of ingestion modules of the Emergency Clearinghouse, as described above. In some embodiments, the emergency alert delivered from the triggering device 767 includes an emergency flow ID or a user identifier, such as a phone number or email address. In some embodiments, the emergency alert delivered from the triggering device 767 includes additional data. For example, in some embodiments, the emergency alert delivered from the triggering device 767 includes location data, such as a longitude and latitude coordinate pair, or a street address. The location data may include information obtained from one or more sources such as, for example, a location component (such as a GPS, not shown), Wi-Fi access points information using a Wi-Fi antenna (not shown), Bluetooth beacon data using a Bluetooth antenna (not shown), cellular trilateration using a cellular transmitter capable of supporting various technologies such as CDMA, LTE, or WiMAX, and barometric pressure using a pressure sensor to estimate altitude. In some embodiments, the emergency alert delivered from the triggering device 767 includes user data associated with a user of the triggering device 767. For example, the emergency alert delivered from the triggering device 767 is optionally accompanied by medical history data associated with a user that the user has stored on a smartphone 767A. In another example, the emergency alert delivered from the triggering device 767 is accompanied by heart rate data obtained by a wearable device 767B before or during the time that the emergency alert was delivered. In another example, the emergency alert delivered by the triggering device 767 is accompanied by driving data determined by an intelligent vehicle system integrated into a vehicle 767C, such as the speed at which the vehicle was moving before or during the time that the emergency alert was delivered.

Once the EFMS 740 receives an emergency alert (e.g., an API call generated by an emergency trigger script integrated into a computer program on a triggering device), the EFMS 740 then executes an emergency flow associated with the emergency alert (e.g., an emergency flow associated with the emergency trigger script or any data included in the emergency alert). In some embodiments, the EFMS 740 employs the API module 741 to process the emergency alert and any accompanying data (e.g., emergency flow ID, location data, or user data) and activate the core module 742 to execute one or more emergency flows. In some embodiments, before activating the core module 742, the API module accesses an emergency flow database (e.g., data module 743) to identify one or more emergency flows for the EFMS 740 to execute. In some embodiments, an emergency flow script (as described above) that generates an emergency alert is directly associated with one or more emergency flows. In some embodiments, the API module 741 determines which emergency flow for the EFMS 740 to execute based on a user identifier included in the emergency alert. In some embodiments, the API module 741 determines which emergency flow for the EFMS 740 to execute based on an emergency flow ID included with the emergency alert delivered from the triggering device 767. In some embodiments, the API module 741 determines which emergency flow for the EFMS 740 to execute based on an emergency flow ID (also referred to as an emergency call flow identifier or flow identifier) and additional data included with the emergency alert. For example, in some embodiments, an emergency flow ID corresponds to multiple emergency flows (e.g., emergency flow A, emergency flow B, emergency flow C, etc.) which are optionally executed preferentially based on the assessed situation of a user. In one example of this embodiment, an emergency alert is delivered to the EFMS 740 from a wearable device 767B. In this example, the emergency alert includes emergency flow ID #123 and additional data gathered by a heart rate monitor, a gyroscope, and an accelerometer. In this example, emergency flow ID #123 corresponds to two emergency flows, emergency flow A, which includes contacting a nurse and calling 9-1-1, and emergency flow B, which includes contacting a nurse but does not include calling 9-1-1. When the additional data included in the emergency alert indicates that a user of the wearable device has merely fallen, the API module 741 optionally executes emergency flow B. However, if the additional data included in the emergency alert indicates that the user has fallen due to a cardiac emergency, the API module 741 optionally executes emergency flow A instead. In some embodiments, emergency flow A and emergency flow B are considered and/or referred to as complete definitions of an emergency flow (e.g., emergency flow ID #123 represents a template of an emergency flow that requires one or more additional inputs to complete the definition of the emergency flow; emergency flow A and emergency flow B represent complete definitions of the emergency flow corresponding to emergency flow ID #123).

In some embodiments, a particular emergency flow ID only corresponds to one particular emergency flow. In some embodiments, the triggering device 767 selects between multiple emergency flow IDs based on data collected by the triggering device 767 or provided by a user. In some other embodiments, in which an emergency alert does not include an emergency flow ID, the API module 741 selects an emergency flow to execute based on alternative factors, such as the type or brand of triggering device 767, a location of the triggering device, a weather forecast at the location of the triggering device 767, or other parameters. In some embodiments, the flow identifier (e.g., an emergency flow ID) is a flow identification number included in the emergency alert. In some embodiments, the flow identifier is included in the header, footer, message, metadata, or a combination thereof in the emergency alert. In some embodiments, the flow identifier is not a flow identification number and takes another form (e.g., device type, device name, application name, application publisher, etc.). In some embodiments, an emergency alert includes an emergency flow ID and/or an identifier of the organization (hereinafter “organization ID” or “organization identifier”) that created the associated emergency flow. For example, in some embodiments, the emergency alert is an HTTP POST that includes an emergency flow ID in the payload of the HTTP POST and an organization ID associated with the organization that created the associated emergency flow in the header of the HTTP POST, as shown below. In some embodiments, after receiving an emergency alert, the API module 741 first identifies an organization using an organization ID included in the emergency alert and then references the emergency flow database (e.g., data module 743) to determine one or more emergency flows created by the organization. In some embodiments, the API module 741 then uses an emergency flow ID included in the emergency alert to select a corresponding emergency flow from the one or more emergency flows created by the organization to execute. In some embodiments, the emergency flow ID is a name of the corresponding emergency flow selected by the organization that created the emergency flow. In some embodiments, the API module 741 selects an emergency flow in response to an emergency alert from a triggering device 767 through any appropriate means regardless of the form of the flow identifier. In some embodiments, the emergency alert does not include a flow identifier. In some embodiments, the API module 741 selects a default emergency flow in response to an emergency alert that includes no additional data (e.g., no flow identifier, device location, sensor data, etc.).

An embodiment of a template of an emergency alert is shown below in the form of an HTTP POST:

```
url = ″https://api-sandbox.rapidsos.com/v1/rem/trigger″
payload = [
  ″callflow″: ″company_contacts″,
  ″variables″: [
    ″location″: [
      ″latitude″: ″″,
      ″longitude″: ″″,
      ″uncertainty″: ″″
    ],
    ″user″: [
      ″full_name″: ″″,
      ″phone_number″: ″″
    ],
    ″contacts″: [
      [
        ″full_name″: ″″,
        ″phone_number″: ″″ ]
],
]
```

In the foregoing template of an emergency alert, “company_contacts” is both the emergency flow ID and the name of the associated emergency flow as selected or inputted by the administrator that created the emergency flow. In this example, “location”; “user”; “contacts”; and “company” are variables required by the “company_contacts” emergency call flow. “Latitude”; “longitude”; and “uncertainty” are components of the “location” variable; “full_name”; and “phone_number” are components of the “user” variable; and “full_name” and “phone_number” are components of the “contacts” variable. In some embodiments, a value is provided in the emergency alert for each of the variables or components of a variable. In some embodiments, as described above, all variables, and components therein, defined or required by an emergency call flow are necessary for the emergency call flow to be executed by the API module 741.

In some embodiments, emergency flows are stored within a data module 743 located within or otherwise communicatively coupled to the EFMS 740. In some embodiments, the API module 741 consults the data module to determine an emergency flow to execute in response to the emergency alert. For example, in some embodiments, the emergency alert includes an emergency flow ID that corresponds to one or more emergency flows stored within the data module 743. The API module 741 then optionally references the data module 743 for an emergency flow corresponding to the emergency flow ID. In some embodiments, after receiving an emergency alert including an emergency flow ID and any accompanying additional data, the API module 741 references the data module 743 to find an emergency flow corresponding to the emergency flow ID. In some embodiments, the API module 741 then processes the emergency flow, determines any necessary inputs for the emergency flow, and verifies that the additional information included in the emergency alert includes the necessary inputs for the emergency flow. For example, a particular emergency flow may additionally require a measurement of a user's heart rate as a necessary input for the emergency flow. In this example, if the emergency alert does not include a user's heart rate (e.g., the emergency alert includes an emergency flow ID corresponding to the particular emergency flow and a location, but is missing a user's heart rate), the EFMS 740 may not be able to execute the particular emergency flow. In response, the EFMS 740 optionally declines the emergency alert or delivers a notification to the triggering device 767 informing the user that the emergency alert was incomplete. In this embodiment, when the API module 741 determines that the emergency alert does include the necessary inputs for the emergency flow, the API module 741 compiles the necessary inputs received from the emergency alert with the emergency flow to create a complete definition of the emergency flow (as discussed above) and delivers the complete definition of the emergency flow to the core module 742.

In some embodiments, the data module 743 additionally includes an emergency flow history database that records individual instances of particular emergency flow sessions. For example, in some embodiments, after the API module 741 receives an emergency alert including an emergency flow ID and activates the core module 742, the core module 742 records an entry in the emergency flow history database for the particular emergency flow session of the particular emergency flow being executed. In some embodiments, the entry is given a unique session ID or an identifier from the emergency flow history database. In some embodiments, the core module 742 records an entry in the emergency flow history database for every emergency flow session. In some embodiments, the core module 742 records an entry in the emergency flow history database for each emergency alert received by the API module 741. In some embodiments, the core module 742 records an entry in the emergency flow history database for each emergency alert received by the API module 741 that includes an emergency flow ID. In some embodiments, the core module 742 records an entry in the emergency flow history database for a particular emergency flow session of a particular emergency flow after the particular emergency flow has been fully executed. In some embodiments, the core module 742 updates an entry in the emergency flow history database for a particular emergency flow session of a particular emergency flow after each step (e.g., after each individual emergency flow building block) of the execution of the particular emergency flow, or after some steps of the execution of the particular emergency flow.

In some embodiments, after an emergency flow is executed by the EFMS 740, the core module 742 updates an entry in the emergency flow history database for a particular emergency flow session of a particular emergency flow to include additional data about the particular emergency flow session. For example, in some embodiments, the core module 742 records in the emergency flow history database data including, but not limited to: which emergency contacts were contacted, and/or which emergency contacts responded, if an ESP was contacted, if contacting an ESP was successful or unsuccessful, if a party opted to contact an ESP, or which party opted to contact an ESP. In some embodiments, after the execution of a particular emergency flow, the core module 742 updates an entry in the emergency flow history database for the particular emergency flow session of the particular emergency flow to reflect that the particular emergency flow session was successful or unsuccessful. In some embodiments, the criteria for success of a particular emergency flow are predetermined by the administrator that created the particular emergency flow. In some embodiments, the criteria for success of a particular emergency flow are predetermined by the EFMS 740.

The EFMS 740 is capable of executing many different permutations of emergency flows as disclosed herein. In some embodiments, emergency flows are defined by various emergency flow building blocks, each emergency flow building block defined by a script, written in a programming language, which contains instructions for executing various functions relating to an emergency flow. In some embodiments, the various functions are executed by the telephony module 745 and the service actions module 744, as depicted in FIG. 7.

In some embodiments, the EFMS 740 employs the service actions module 744 to execute various emergency flow building blocks that require transmitting data and communications to and from various users and output services 760 using various mediums and communication modes. For example, in some embodiments, an emergency flow includes an emergency flow building block with instructions for delivering a text message through short message service (SMS) or multimedia messaging service (MMS) or text message 760C to an account associated with a user, which is optionally executed by the service actions module 744. In another example, in some embodiments, an emergency call block requires the EFMS 740 to deliver a message to an account associated with a user through an internet enabled communication service 760E (e.g., WhatsApp, Slack, or Facebook Messenger) via an API call or HTTP post, which is optionally executed by the service actions module 744. In some embodiments, associated contacts are also contacted by a voice call (PSTN or data or VoIP call). In some embodiments, associated contacts are called, and a TTS message is played. In yet another example, in some embodiments, an emergency flow includes an emergency flow building block with instructions for delivering an audio adaptation of a text message (e.g., text-to-speech message) to an account associated with a user, which is optionally executed by the service action module 744. In yet another example, an emergency flow may include an emergency flow building block with instructions for querying a triggering device 767 or an electronic device associated with a user for a location associated with a user, which is optionally executed by the service actions module 744.

In some embodiments, the service actions module 744 includes a location service (e.g., a location API) that can be employed by the API module 741 to send or retrieve locations to and from a location database. In some embodiments, the location database is external to the EFMS. For example, in some embodiments, an emergency alert includes a location (e.g., a location generated by the triggering device or an electronic device associated with the triggering device). After receiving the emergency alert, the API module 741 can employ the location service to transmit the location included in the emergency alert to an external location database. In some embodiments, the service actions module 744 includes a voice command service that the API module 741 can employ during emergency flows to receive oral input from users. For example, in some embodiments, an emergency flow building block, such as an interactive call block, as described below, may accept voice inputs using the voice command service.

In some embodiments, the telephony module 745 is constructed using hardware components such as voice over internet protocol (VoIP) gateways and open source communication software. In some embodiments, the EFMS 740 employs the telephony module 745 to execute various emergency flow building blocks requiring communication links. For example, in some embodiments, an emergency flow includes a building block with instructions for delivering an interactive phone call to a user (e.g., an automated phone call that accepts inputs from the recipient of the call). In some embodiments, while executing the emergency flow, the core module 742 employs the telephony module 745 to execute the interactive call. In another example, in some embodiments, an emergency flow includes a building block with instructions for delivering a call to an output service 760 (e.g., an emergency dispatch center 760A, specifically a 911 call center or PSAP 760B, or a customer service representative 760D), which is optionally executed by the telephony module 745.

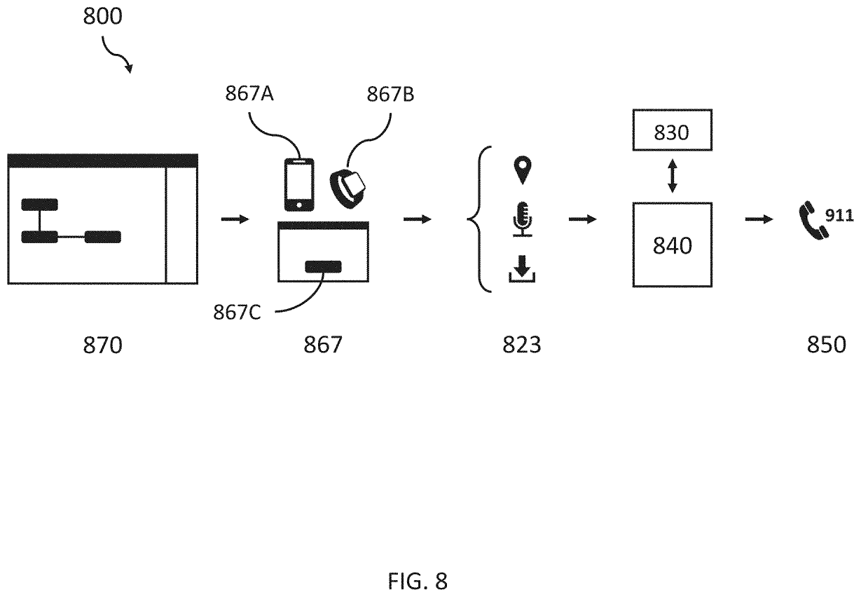

FIG. 8 depicts an embodiment of a system 800 including a graphical user interface (GUI) 870 for managing emergency flows, triggering devices 867, an emergency alert 823, the EFMS 840, the EMS 830, and an output service 850. Examples of triggering devices include mobile or smart phones 867A, wearables 867B, and portable computing devices 867C such as laptops or tablets. In some embodiments, the GUI 870 is a web interface (such as a website or a mobile application) from which a user can download an emergency trigger script that can be integrated into a triggering device 867. In some embodiments, the web interface is provided by the EMS 830. In other embodiments, the web interface is provided by a third-party. The web interface may provide access to one or more default or customized emergency flows. For example, the web interface may provide a default emergency flow A designed for smartwatches and a default emergency flow B designed for smart speaker devices. In such an embodiment, a user with a smartwatch could then access the web interface (e.g., on a computer or directly from the smartwatch) and select to download an emergency trigger script associated with default emergency flow A. The emergency trigger script can be downloaded in numerous forms, including, but not limited to, a block of code, an executable program, a plug-in, or a mobile application. Likewise, the emergency trigger script can be integrated into various devices and applications in different ways. For example, Amazon provides a “Skills Store” for the Amazon Alexa, a smart speaker device, where users can download new “skills” (app like programs that allow the Alexa to perform additional functions). In this example, an emergency trigger script associated with default emergency flow B may be downloaded in the form of a skill from the Alexa Skills Store.

In some embodiments of the system 800, the GUI 870 is an emergency flow editor that an administrator can access to configure an emergency flow. The emergency flow editor 870 then optionally stores the emergency flow in an emergency flow database (e.g., the data module 743 depicted in FIG. 7) and assigns the emergency flow an emergency flow ID. In some embodiments, the administrator then installs a program, application, or script (e.g., an emergency trigger script) into a triggering device 867 configured to deliver data pertaining to the emergency to the EMS 830. Non-limiting examples of the data sent by the triggering device 867 (e.g., included in the emergency alert 823) to the EMS 830 include location data, audio and/or video (streaming or a file), sensor data, emergency indication(s) (e.g., user pressed panic button for a specific type of emergency), and any user commands (e.g., command to notify certain contacts in the contact list). In some embodiments, the data is transmitted within the emergency alert 823 including the emergency flow ID. In some embodiments, data is additionally or alternatively transmitted before or after the emergency alert 823 is sent to the EFMS 440, which functions in conjunction with the EMS 830 to execute the emergency flow. In some embodiments, the emergency alert 823 includes additional data, such as a location associated with a user, health data associated with a user, or a list of accounts associated with a user. In some embodiments, the execution of the emergency flow includes initiating communications with an output service 850, such as an ESP or PSAP. In some embodiments, the data pertaining to the emergency is transmitted to an ESP 850 by the EMS 830. The data may be transmitted as a part of an emergency alert 823 or afterwards. In some embodiments, the data is provisioned in the EFMS 840, EMS 830 or a third-party server and sent to an ESP 850 in response to a query from the ESP 850, as described below. The data is optionally encrypted and sent through secure pathways to authorized recipients. The EMS 830 and EFMS 840 are contemplated to deliver location, voice, and additional data (e.g., user data, images, video feed) from devices 867 to output services 850 in a secure and compatible format.

As an illustrative example, the administrator is a company that produces a smartwatch. The company optionally uses the emergency flow editor 870 to create an emergency flow that activates when a wearer of the smartwatch (e.g., triggering device 867B) presses a button on the smartwatch that indicates (e.g., by delivering an emergency alert 823 to the EFMS 840) that the wearer is in a state of distress (e.g., the wearer of the smartwatch has fallen and is incapable of picking themselves up). When activated, the emergency flow is configured by the company to instruct the EFMS 840 to deliver an interactive call to the smartwatch (if the smartwatch is capable of receiving calls) or to a phone associated with the wearer in which the interactive call asks the wearer if they are in need of emergency assistance. The interactive call then optionally waits for a predetermined duration of time (e.g., 20 seconds) for an input from the wearer of the smartwatch (e.g., the interactive call may present the wearer with two options: press 1 for yes or * for no). If the wearer selects 1, or the predetermined duration of time expires before the wearer submits an input, the EFMS 840 then initiates a call with an ESP and connects the wearer with an ESP 850 once the ESP 850 has accepted the call. If the wearer selects *, the EFMS 840 terminates the emergency response flow.

In another illustrative example, the administrator is a company that provides a vehicle safety service (e.g., OnStar or AAA). In this example, the company uses the emergency flow editor 870 to create an emergency flow that is automatically activated when an intelligent vehicular system (integrated with the vehicle safety service) within a vehicle detects that the vehicle has been compromised (e.g., when the vehicle has been in an accident). In this example, when the intelligent vehicular system detects that the vehicle has been compromised, the vehicle (e.g., a triggering device 467) delivers an emergency alert 823 to the EFMS 840, which executes the emergency flow. In this example, when executed, the emergency flow is configured by the company to instruct the EFMS 840 to call a customer service provider 850 (e.g., a AAA representative), call the vehicle, and bridge the calls between the vehicle and the customer service provider 850. The emergency flow also optionally provides the customer service provider 850 with an option to initiate a call with an ESP (e.g., call a PSAP).

In some embodiments, the customized emergency flow script is associated with a user identifier. In some embodiments, the customized emergency flow script is configured to account for additional user data or input. User data or input can include location information (e.g., user device location determined using GPS and/or WiFi access points), sensor data, user demographic information, health information, or other relevant data. In some embodiments, the flow script comprises one or more emergency flow building blocks configured to perform distinct emergency functions based on the user data or input. In some embodiments, the distinct emergency functions arise from a decision made within the flow script such as to decide on the path of execution of building blocks based on the user data or input. In some embodiments, when an identifier is received, it is matched with a flow script. In some embodiments, additional data is obtained including location of the user (e.g., location of the user communication device) and user data (e.g., user home and work addresses). In some embodiments, a distinct sequence of emergency functions is performed depending on the user location relative to home, work or other known locations. As an example, when a user has a fire emergency at home (e.g., based on specific emergency indication in the alert and user location compared to stored home location), the executed flow script may cause the emergency management system to notify his neighbors. Conversely, when a user who has a medical emergency at work (e.g., determined by the emergency indication in the alert and by comparing current user location to stored work address), the executed flow script may cause the user's employer to receive notification that the user had a medical emergency and will be transported to a nearby hospital. In the case when a user has a car breakdown on the freeway, the route of travel and/or recent movement/travel speed (e.g., based on GPS signal or data from a mobile map application for the last 5 minutes) can result in the executed flow script notifying the user's insurance company and/or an associated towing service.

Alternatively or in combination, multiple emergency flow scripts may be chosen from for a single user based on the additional user data. Examples of various emergency flow scripts include a traffic emergency script, a medical emergency script, a fire emergency script, a police emergency script, a natural disaster emergency script, a home emergency script, a work emergency script, a travel emergency script, and other possible scripts.

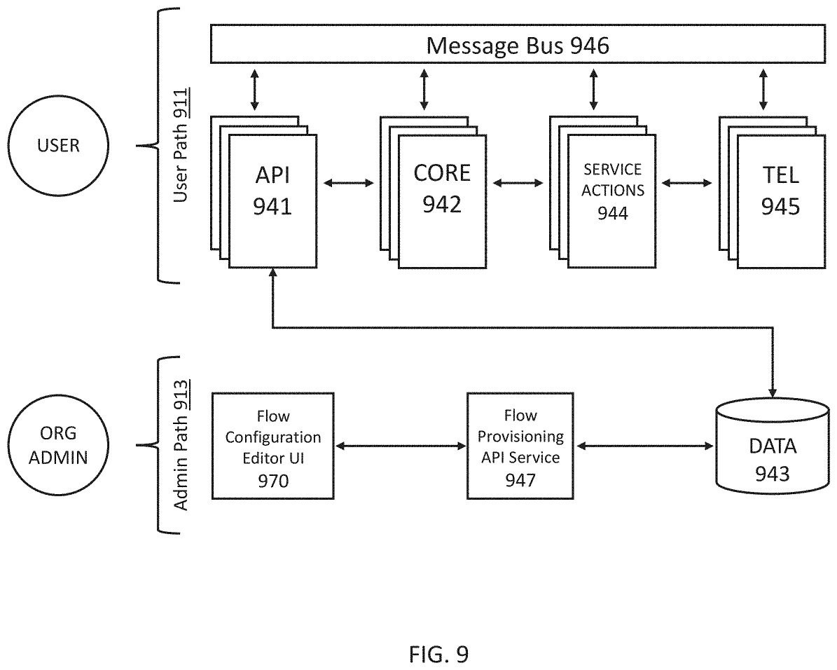

FIG. 9 depicts an embodiment of a system 900 for the creation and implementation of an emergency flow. As depicted in FIG. 9, in some embodiments, the system 900 contains two pathways: an administrator pathway 913 (admin path) and a user pathway 911 (user path). The admin path 913 is initiated by an administrator. In the admin path, the administrator accesses an emergency flow editor 970 to configure an emergency flow to fit the needs of the administrator's product or service, such as the smartwatch or vehicle described in the examples provided above with respect to FIG. 8. In some embodiments, in the admin path 913, an emergency flow provisioning API service 947 compiles the emergency flow, assigns an emergency flow ID to the emergency flow, and stores the emergency flow within a data module 943. The user path 911 is initiated by a user 900 (or a device associated with a user) of the product or service provided by the administrator, such as the vehicle or the wearer of the smartwatch described in the examples provided above with respect to FIG. 8. In some embodiments, in the user path 911, the API module 941 receives an emergency alert including an emergency flow ID from a triggering device. In some embodiments, the API module 941 then references the emergency flow ID with the data module 943 to find the emergency flow corresponding to the emergency flow ID and delivers the emergency flow to the core module 942 for execution. In some embodiments, the core module 942 employs the service actions module 944 and the telephony module 945 to execute various blocks of the emergency flow. In some embodiments, the API module 941, the core module 942, the service actions module 944, and the telephony module 945 are separately and simultaneously in communication with the message bus 946, which facilitates and coordinates synchronous and asynchronous communications (e.g., a communication bridge, text messages, etc.) between the modules and various users and accounts (e.g., a user, emergency contacts, emergency responders, etc.).

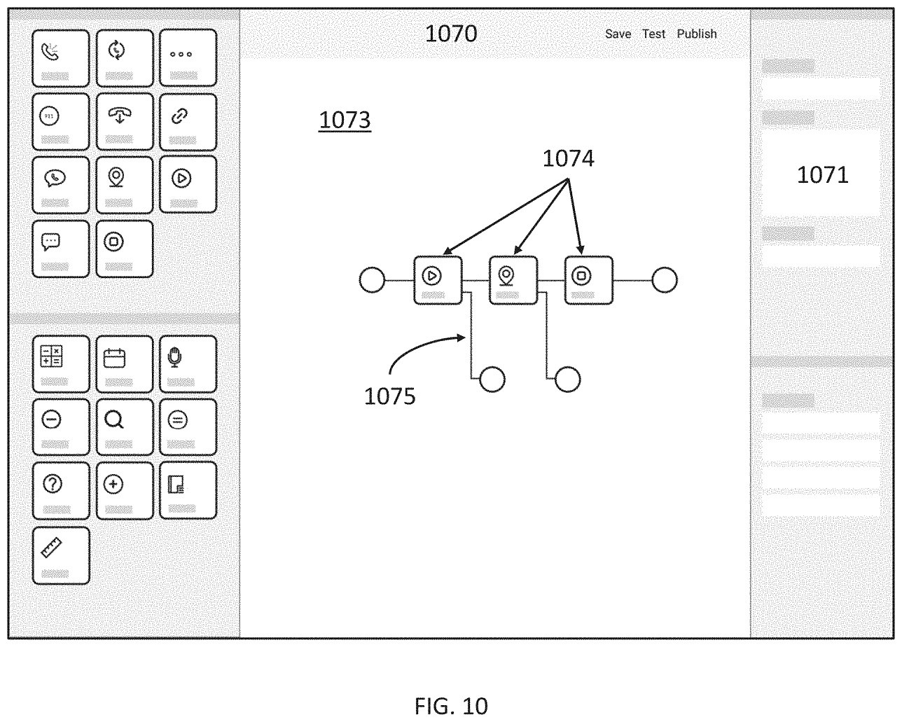

FIG. 10 depicts a view of an emergency flow configuration editor 1070 (also referred to as the Emergency Console or an emergency flow editor). In some embodiments, the emergency flow editor 1070 is used to configure customized emergency flows. In some embodiments, the emergency flow editor 1070 includes a programming language input field 1071 in which users manually program an emergency flow by inputting written programming commands to create a script 1072 (not shown; also referred to as an “emergency flow script”) that defines the emergency flow. In some embodiments, the emergency flow editor additionally or alternatively includes a graphical user interface 1073 (also referred to as an “interactive space”) which users can use to visually assemble emergency flows by dragging and dropping (or otherwise manipulating) graphical representations of emergency flow building blocks 1074 into various arrangements. In some embodiments, an emergency flow building block is defined by a short script (e.g., a compilation or block of written programming commands), written in a programming language, that contains instructions for executing various functions (also referred to as emergency response functions) relating to an emergency flow. A single emergency flow building block generally contains instructions relating to one emergency flow function, as will be described in greater detail, and generally does not represent an entire emergency flow. In some embodiments, an arrangement of emergency flow building blocks in the graphical user interface 1073 automatically results in the creation of a script 1072 (e.g., an emergency flow script), which is optionally displayed in the programming language input field 1071. In some embodiments, an emergency flow building block receives at least one input, performs at least one emergency response function based upon the at least one input, and generates at least one output. In some embodiments, at least one input for an emergency flow building block comprises an output received from another emergency flow building block. In some embodiments, adjacent emergency flow building blocks in an emergency flow script are connected such that an output of a preceding emergency flow building block forms an input for at least one succeeding emergency flow building block. In some embodiments, the emergency flow editor 1070 includes either the programming language input field 1071 or the graphical user interface 1073, but not both. In some embodiments, the emergency flow editor includes both the programming language input field 1071 and the graphical user interface 1073. In some embodiments, the emergency flow editor 1073 includes options or buttons to save, test, and publish an emergency flow. While users can use the emergency flow editor 1070 to visually assemble customized emergency flows, the emergency flow editor 1070 may additionally or alternatively allow users to access default or premade emergency flows provided by the emergency flow management system (EFMS).

In some embodiments, the Emergency Console allows a variety of customizable emergency flows between users, emergency contacts, emergency services, and related third parties by establishing a multitude of voice and data connections to Public Safety Answering Points (PSAPs) through a variety of trigger mechanisms. In some embodiments, the trigger mechanisms enable implementation in a variety of scenarios including software panic buttons (e.g., within mobile applications), remote activation by associated emergency contacts, and others. The Emergency Console allows for the customization and generation of emergency flows while ensuring that the generated emergency flows comply with regulatory constraints (Federal, State or local laws, regulations, policies, best practices, etc.) applicable to the location and type of emergency. In some embodiments, the Emergency Console is a part of the EMS. In some embodiments, the Emergency Console is part of an ESP such as a PSAP. In some embodiments, the Emergency Console is operated on an emergency response server. In some embodiments, the EMS comprises an emergency response server. In some embodiments, the Emergency Console is a web interface that provides tools for generating and testing emergency flows. In some embodiments, the Emergency Console allows for emergency flows to be initiated via simple API triggers from any device.

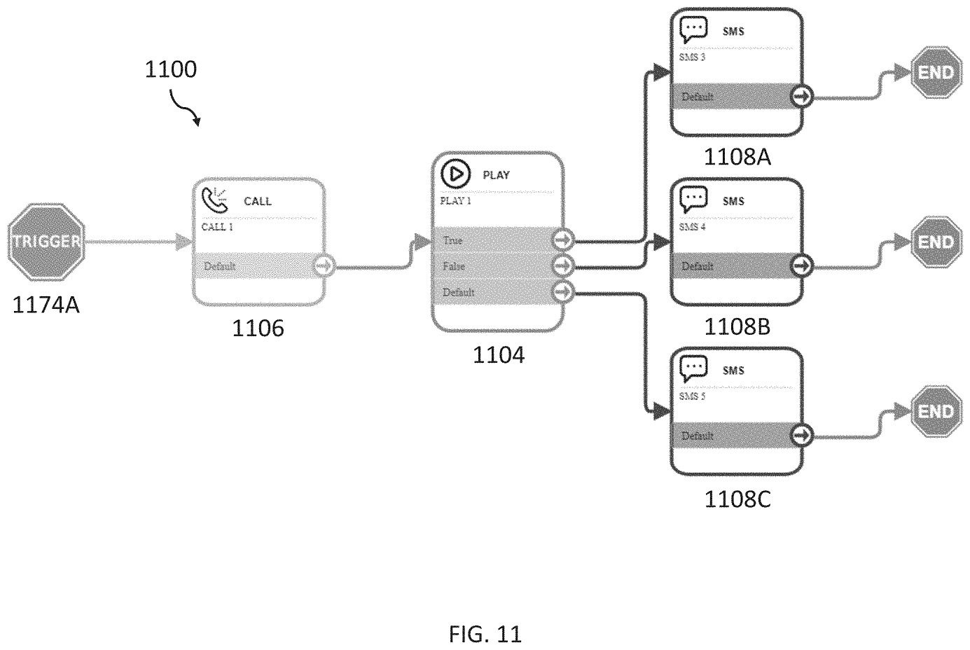

As described above, in some embodiments, emergency flow building blocks 1074 are visually arranged into an emergency flow within the graphical user interface 1073 of the emergency flow editor 1070. In some embodiments, the emergency flow building blocks are connected with one or more connectors 1075. A single emergency flow building block 1074 may be connected to a plurality of other emergency flow building blocks preceding the single emergency flow building block 1074 and/or a plurality of other emergency flow building blocks succeeding the single emergency flow building block 1074. For example, in emergency flow 1100 (described below with regard to FIG. 11), the IVR block 1104 (also referred to as an “interactive call” block, as described below) is connected to one preceding emergency flow building block (call user block 1106, as described below) and three succeeding emergency flow building blocks (send SMS blocks 1108A-1108C, as described below). In some embodiments, the emergency flow building blocks 1074 and connectors 1075 that make up an emergency flow define a pathway of execution for the emergency flow. In such embodiments, the emergency flow management system executes the emergency flow according to the pathway of execution defined by the emergency flow building blocks and connectors.

For example, referring back to emergency flow 1100 (as illustrated in FIG. 11), the emergency flow is triggered when the emergency flow management system (EFMS) receives an emergency alert associated with the emergency flow 1000. According to the pathway of execution defined by the emergency flow building blocks and connectors of emergency flow 1000, the emergency flow 1000 first prompts the EFSM to execute user call block 1106 (e.g., calling the user for whom the emergency alert was triggered). After executing the call user block 1106, according to the pathway of execution defined by the emergency flow building blocks and connectors that constitute emergency flow 1100, the emergency flow management system will then execute the IVR block 1104, an emergency flow building block that can play a pre-recorded message and receive a dial tone response. According to the pathway of execution defined by the emergency flow building blocks and connectors of emergency flow 1000, after executing the IVR block 1104, the EFMS will execute one of the three different send SMS blocks 1108A-1108C, depending on the output of the IVR block 1104. For example, the emergency flow 1000 may be built for a home alarm system and is triggered when the home alarm system detects a potential break in. The home alarm system transmits an emergency alert including the phone number of the homeowner to the EFMS. The EFMS then calls the homeowner (at call user block 1106) and plays a pre-recorded message (at IVR block 1104). In this example, the pre-recorded message recites, “Your home security system has detected a potential break in at your home. If you are at home and can confirm that the detection is a false positive, please press 1. If not, please press 0.” In this example, according to the pathway of execution defined by the emergency flow building blocks and connectors of emergency flow 1000, if the user presses ‘1,’ the EFMS executes the send SMS block 1108A, which prompts the EFMS to transmit an SMS text messaging to the homeowner that recites, “Thank you. Please enjoy your day.” However, if the user presses ‘0,’ the EFMS executes the send SMS block 1108B, which prompts the EFMS to transmit an SMS text message to the homeowner that recites, “Thank you. Police will be dispatched to your home as quickly as possible.” And if the user does not select ‘1’ or ‘0’ within a threshold amount of time, or if the call is dropped or hung up, the EFMS executes send SMS block 1108C, which prompts the EFMS to transmit an SMS text message to the homeowner that recites, “[Homeowner Name], your home security system has detected a potential break in at your home. An attempt to contact you was made but was unsuccessful. Police will be dispatched to your home as quickly as possible.”

In some embodiments, the emergency flow editor 1070 (e.g., the Emergency Console) contains a set of predefined emergency flow building blocks. Below is a non-exhaustive list of emergency flow building blocks that are optionally included in the set of predefined emergency flow building blocks and that may be incorporated into a customized emergency flow (e.g., customized emergency flow script).

(a) Create Emergency Bridge Block: In some embodiments, the create emergency bridge block instructs the EFMS to create a communication bridge in which one or more calls are dynamically added or removed. The communication bridge serves as a hub for various calls that are made during the execution of an emergency flow. In some embodiments, the create emergency bridge block takes no inputs and produces no outputs. In some embodiments, the create emergency bridge block is a core component included in every emergency flow. In some embodiments, the create emergency bridge block is an implied emergency flow building block (e.g., the script defining the create emergency bridge block is included in every emergency flow but the create emergency bridge block is not depicted in the graphical user interface 673).

(b) Call User Block: In some embodiments, the call user block instructs the EFMS to initiate a phone call to a phone number associated with the user associated with the triggering device and connect the phone call with a communication bridge. The input for the call user block is the phone number associated with the user. The outputs of the call user block are: (i) the user answered the phone call or (ii) the user did not answer the phone call.

(c) Play Pre-Recorded Message Block: In some embodiments, the play pre-recorded message block instructs the EFMS to play a pre-recorded audio file to one or more parties currently connected to a communication bridge. The input for the play pre-recorded message block is the name or file location of the pre-recorded audio file. The play pre-recorded message block has no output.

(d) Play TTS Message Block: In some embodiments, the play TTS (text-to-speech) message block instructs the EFMS to play an audio file adaptation of a text file to one or more parties currently connected to a communication bridge. The input for the play TTS message block is the text of the message to be converted to audio. The play TTS message block has no output.

(e) Send SMS Message Block: In some embodiments, the send SMS message block instructs the EFMS to deliver a SMS message to a user or a group of users. In some embodiments, the SMS message includes information pertaining to status of the emergency flow session. The inputs for the send SMS message block are the contents of the text message to be sent and the phone number(s) of the intended recipients of the text message. The send SMS message block has no output.

(f) Timeout Block: The timeout block instructs the EFMS to add a timeout instruction for a desired event. For example, in some embodiments, an administrator can add a timeout instruction to another emergency flow building block, such as the call user block, and specify an amount of time that the emergency flow should wait at the call user block before autonomously determining a negative outcome (e.g., in the case of the call user block, the user did not answer). The input for the timeout block is the amount of time (e.g., 1-30 seconds). The output of the timeout is a confirmed negative outcome.

(g) Location Block: In some embodiments, the location block instructs the EFMS to query or detect a location of a user. In some embodiments, the location block instructs the EFMS to parse a location database for a location. In some embodiments, the location block instructs the EFMS to communicate with a triggering device to determine the location of the triggering device. The input for the location block is an account associated with a user (e.g., a phone number of the user). The output of the location block is a location of the user.

(h) API/HTTP Request Block: In some embodiments, the API/HTTP request block instructs the EFMS to execute an API or HTTP post to an internet-based service to provide status, alerts, and notifications regarding the current emergency. The API or HTTP post may be provided by the user or included in the Emergency Console. In some embodiments, the inputs for the API/HTTP request block are a URL and any necessary parameters (named parameters included in HTTP post). In some embodiments, the outputs of the API/HTTP request block are (i) success or (ii) failure.

(i) Find Next Available Contact Block: In some embodiments, the find next available contact block instructs the EFMS to loop through a list of contacts (e.g., accounts associated with a user or emergency contacts), call each one-by-one in sequence, play an audio message to them and wait for confirmation to determine whether to call the next contact. In some embodiments, a contact can confirm readiness to speak to an EDC or emergency dispatch center by responding to the audio message (e.g., by pressing 1). In some embodiments, the call of the find next available contact block is an interactive call (as discussed below). In some embodiments, the input for the find next available contact block is a list of contacts, the list of contacts including phone numbers and names. In some embodiments, the outputs of the find next available contact block are (i) contact answers the call, (ii) contact does not answer the call, and/or (iii) there are no available contacts (also referred to as an NAC response).

(j) Interactive Call/IVR Block: In some embodiments, the interactive call/IVR (interactive voice response) block instructs the EFMS to call a phone number (e.g., an account associated with a user), play an audio message to the recipient of the call, and wait for a dial tone response (e.g., an interactive call) to determine whether the recipient of the call confirms readiness to speak to an EDC or emergency dispatch center. In some embodiments, the interactive call/IVR block only plays the audio message and waits for the dial tone response (e.g., if a call has already been established). In some embodiments, the interactive call presents the recipient with a plurality of options to choose from (e.g., press 1 to dial 9-1-1, press 2 to call an emergency contact, press * to hang up). In some embodiments, the inputs for the interactive call/IVR block are a name and associated phone number of the intended recipient of the call and an audio message to play to the recipient. In some embodiments, the inputs for the interactive call include a plurality of options for the recipient to choose from. In some embodiments, the outputs of the interactive call/IVR block are (i) a dial tone response from the recipient (ii) the call was answered or (iii) the call was unanswered.

(k) Connect to Customer Call/Operations Center Block: In some embodiments, the connect to customer/operations center block instructs the EFMS to initiate a call with an operations center associated with the administrator. The input for the connect to customer call/operations center is a phone number of the customer call/operations center. In some embodiments, the outputs of the connect to customer call/operations center are (i) successful connection to customer call/operations center or (ii) unsuccessful connection to customer call/operations center. In some embodiments, the call of the connect to customer call/operations center block is an interactive call (as described above).

(1) Connect to 9-1-1 Block: In some embodiments, the connect to 9-1-1 block instructs the EFMS to call 9-1-1 (or another emergency response/dispatch center number), add the call to a communication bridge, and provide the EDC with a location and name of a user. The inputs for the connect to 9-1-1 block are the location of the user and the name and phone number of the user. The outputs of the connect to 9-1-1 block are (i) successful connection to 9-1-1 or (ii) unsuccessful connection to 9-1-1.

(m) Add 3^{rd} Party Block: In some embodiments, the add third party block instructs the EFMS to initiate a call with an additional party (e.g., an emergency contact, customer service, a suicide hotline, etc.) and add the call with the additional party to a communication bridge. The inputs for the add 3^{rd} party block are a name and number of a third party. The outputs of the add third party block are (i) successful connection to third party or (ii) unsuccessful connection to third party.

(n) Failsafe Block: In some embodiments, the failsafe block instructs the EFMS to detect a failure within an emergency flow and deliver a message to a user notifying the user that the emergency flow has failed. In some embodiments, the failsafe block further instructs the API to prompt the user to call 9-1-1. In some embodiments, the failsafe block is an implied emergency flow building block (e.g., the script defining the failsafe block is included in every emergency flow but the “create emergency bridge” block is not depicted in the graphical user interface 1073). In some embodiments, the failsafe block is an implied additional or associated component of every emergency flow building block configured within an emergency flow. In general, the failsafe block functions to ensure that an emergency flow is at least as reliable as a traditional emergency call (e.g., calling 9-1-1 in the United States). In some embodiments, the input for the failsafe block is a failed outcome of a previous or associated emergency flow building block (e.g., the previous or associated emergency flow building block failed to execute its intended function). The failsafe block has no output.

In some embodiments, in addition to the emergency flow building blocks, the Emergency Console contains one or more utility building blocks. For example, in some embodiments, utility building blocks may perform computational or logistical functions, as opposed to emergency functions. For example, the utility building blocks may include a calculator building block configured to perform a mathematical equation on two inputs, a datetime building block configured to return the current day and time, an evaluate building configured to evaluate an expression (e.g., an algebraic expression), a compare building block configured to execute an if/then statement. In some embodiments, the utility building blocks may include increase and decrease building blocks configured to increase or decrease the value of a numerical variable, respectively.

The Emergency Console optionally contains any number of emergency flow building blocks defining any number of emergency response functions. In some embodiments, additional emergency response functions include, but are not limited to, at least one of the following: delivering a location of a user to an emergency dispatch center or database accessible by the emergency dispatch center, identifying an emergency dispatch center suitable for responding to an emergency alert based on location data associated with or received from an electronic device associated with a user, calling an emergency contact of a user for whom an emergency alert has been received, calling an associated device of the user, and obtaining sensor data from a network of sensors associated with the user or user's electronic device. In some embodiments, the Emergency Console allows administrators to edit the short script of an emergency flow building block to reprogram the building block to be more applicable to the needs of the administrator. For example, in some embodiments, the Emergency Console may contain a predefined call user block that takes a single phone number as an input. In this example, the Emergency Console optionally allows an administrator to edit the short script of the predefined call user block such that the edited call user block now takes a list of phone numbers as its input and dials each number in the list of phone numbers one-by-one in sequence until one of the numbers is successfully reached. In some embodiments, the Emergency Console allows administrators to configure any parameter of an emergency flow building block, including, but not limited to: the input, output, and emergency response function. In some embodiments, the Emergency Console allows administrators to design their own original emergency flow building blocks, such as by writing their own short script in the programming language input field 1071. In some embodiments, the Emergency Console includes a shared (e.g., accessible to all administrators) library of administrator generated emergency flow building blocks.

As mentioned above, in some embodiments, a modular API system (MAS) is implemented through and/or as part of an emergency flow management system (EFMS; as described above). For example, in some embodiments, a MAS schema can be built for the MAS as part of an emergency flow within an emergency flow editor (as described above) and stored within an emergency flow database (as described above). Thus, when the EFMS receives an emergency alert including an identifier of the emergency flow (also referred to as an “emergency flow identifier”), the emergency flow identifier serves as an identifier of the MAS schema (also referred to as a “schema identifier”), which the MAS (operating as part of or in conjunction with the EFMS) can use to retrieve the MAS schema (as a component of the emergency flow) from the emergency flow database (effectively operating as a schema database), as described below.

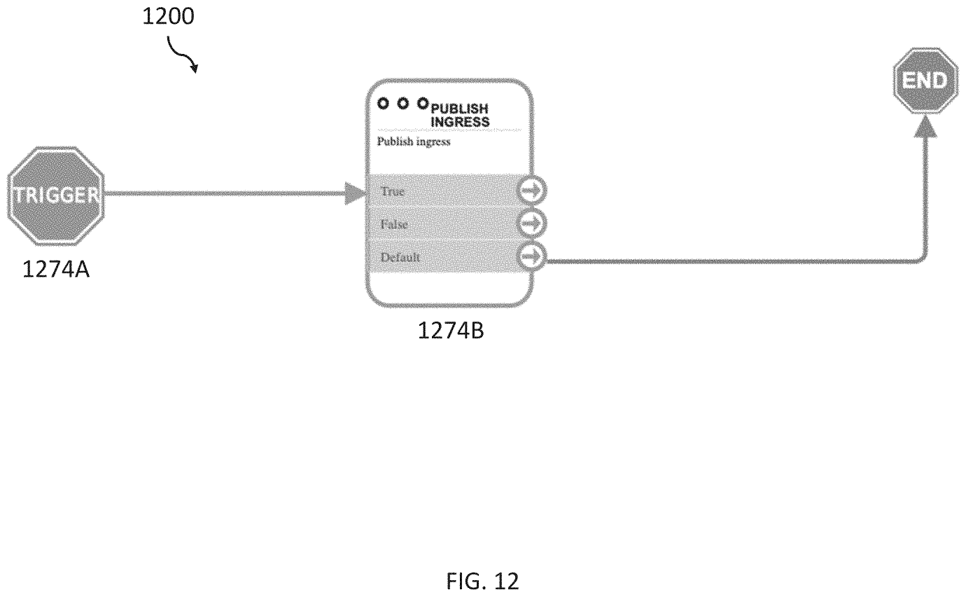

FIG. 12 illustrates a second example of an emergency flow in accordance with some embodiments of the present disclosure. In this example, the emergency flow 1200 includes only one emergency flow building block, Publish Ingress block 1274B. In this example, the Publish Ingress block is an emergency flow building block provided by the emergency flow management system (EFMS) to allow the emergency flow editor to function as a schema editor interface (as described above). In this example, the Publish Ingress emergency flow building block is built to accept a MAS schema (as described above) within its parameters and data from an emergency alert as part of its inputs, and functions to prompt the EFMS to A) validate the data it receives against the MAS schema (as described below) and B) if the validation is successful (as described below), transmit the data to an Emergency Clearinghouse (as described above), where it can be pushed to an appropriate recipient or stored for later retrieval. However, in some embodiments, a MAS schema can be defined within the trigger block 1274A of an emergency flow, and the attempted validation of the data received in an emergency alert associated with the MAS schema can be prompted or executed by the trigger block as well.

For example, in some embodiments, as described above, a send SMS message emergency flow building block takes a message script (e.g., “Thank you. Please enjoy your day.”) as part of its inputs and parameters, which is at least in part defined by a user during the assembly of an emergency flow within the emergency flow editor interface. The send SMS message block then takes a phone number (e.g., the number to which the message script is to be sent) as its input during the execution of the block as part of an emergency flow. Finally, the SMS message block functions to prompt the EFMS to transmit the message script to the phone number received by the block. Similarly, the Publish Ingress emergency flow building block takes a MAS schema as part of its inputs and parameters, which is at least in part defined by a user during the assembly of an emergency flow within the emergency flow editor interface. The Publish Ingress block then takes data included in an emergency alert (e.g., received by the API module) that triggers an emergency flow including the Publish Ingress block as its input during the execution of the block as part of the emergency flow. Finally, in this example, the Publish Ingress block functions to prompt the EFMS to A) validate the data received by the block against the MAS schema defined within the block and B) if the validation is successful, transmit the data to an Emergency Clearinghouse (as described above) communicatively coupled to the EFMS.

In such an embodiment, because the EFMS allows for the creation and storage of a limitless number of emergency flows, each of which may include their own Publish Ingress block with its own MAS schema defined within, the EFMS effectively functions as a modular API system (MAS; as described above). For example, when the API module of the EFMS receives an emergency alert including an emergency flow identifier, the EFMS retrieves an associated emergency flow from an emergency flow database. If the emergency flow includes a Publish Ingress emergency flow building block with a MAS schema defined within it, the EFMS has effectively retrieved a MAS schema (within the emergency flow) from a database of schemas (the emergency flow database, which can store any number of emergency flows respectively including any number of different MAS schemas within respective Publish Ingress blocks) using a schema identifier (in this case, the identifier of the emergency flow).

Additionally, an emergency flow may include a Publish Ingress emergency flow building block in addition to any number of other emergency flow building blocks, further increasing the flexible and dynamic capabilities of the emergency flow management system (EFMS). By including a Publish Ingress block with other emergency flow building blocks, the EFMS can create and execute emergency flows that can perform various emergency response functions and submit emergency data to an Emergency Clearinghouse, from where the emergency data can be pushed to appropriate recipients (e.g., emergency service providers) or stored for later retrieval.

Although a modular API system (MAS) may be implemented through or as part of an emergency flow management system (EFMS), as described above, it will be understood and appreciated that, generally, a modular API system and an emergency flow management system are two separate and different systems with different functions, capabilities, and purposes. Likewise, generally, a MAS schema and an emergency flow are two functionally different and separate entities. As described above, an EFMS functions to create, store, recall, and execute emergency flows, which are compilations of one or more emergency response functions, such as dialing 9-1-1 or transmitting a text message to an emergency contact. As described above, a MAS functions to store and recall MAS schemas, which are definitions of the amount or types of data that can or must be included in a particular packet of data received by an API. A MAS schema defines no emergency response function. After a MAS recalls a particular MAS schema, the MAS can then validate a particular data packet against the particular MAS schema. As described above, it is only when an emergency flow building block included in an emergency flow a) includes a MAS schema in its definition and b) includes the validation of data against the MAS schema included in its definition as part of its emergency response function (e.g., the publish ingress block, as described above) that the EFMS may function as a MAS.

### Emergency Data Transmission

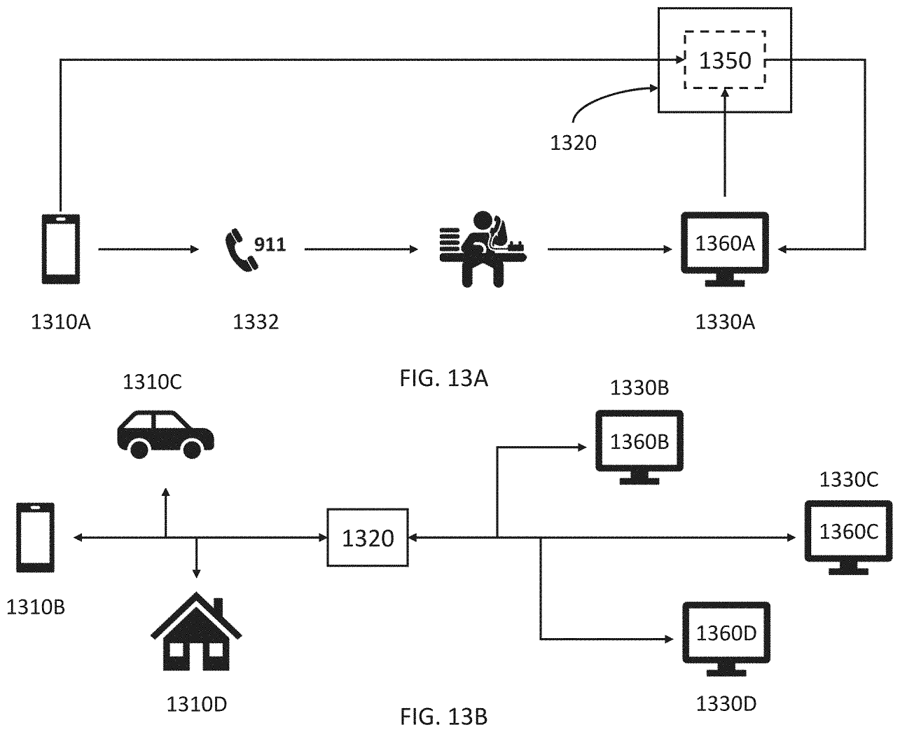

FIGS. 13A and 13B depict systems and processes for receiving and transmitting emergency data by an emergency management system in accordance with some embodiments of the present disclosure. As described above, in some embodiments, an emergency management system (EMS) maintains a clearinghouse that obtains and shares emergency data to aid emergency service providers (ESPs) in responding to emergencies. For example, as depicted in FIG. 13A, during an emergency, an ESP 1330A can send an emergency data request to the EMS 1320 (e.g., through an emergency response application 1360A), and, in response, the EMS 1320 can send any available emergency data associated with the emergency back to the emergency response application 1360A. In some embodiments, as described above, the emergency response application 1360A includes an identifier associated with an emergency alert in the emergency data request. The EMS 1320 can then use the identifier associated with the emergency alert to retrieve emergency data associated with the emergency alert from the clearinghouse 1350. For example, as described above, an ESP 1330A (e.g., a public safety answering point (PSAP)) can receive an emergency alert in the form of a 9-1-1 phone call 1332 (representative of an emergency or potential emergency) from a mobile phone 1310A associated with a phone number (e.g., (555) 555-5555). The ESP 1330A can then send an emergency data request including the phone number (e.g., the identifier associated with the emergency alert) to the EMS 1320, which can then retrieve any emergency data within the clearinghouse 1350 associated with the phone number and return the available emergency data to the requesting ESP 1330A. This process of returning emergency data to an ESP in response to an emergency data request is referred to as “pulling” emergency data from the clearinghouse.

As described above, in some embodiments, the emergency management system (EMS) can “push” emergency data from the Emergency Clearinghouse to emergency service providers (ESPs), such as by using an emergency data subscription system (hereinafter, “subscription system”). FIG. 13B depicts a flow diagram of a process for pushing emergency data from the Emergency Clearinghouse to one or more ESPs. In some embodiments, a member of an ESP (e.g., a PSAP staff member) logs into the emergency response application 1360B at an ESP console 1330B (e.g., a computing device associated with the ESP) by accessing the emergency response application 1360B (e.g., by navigating to the emergency response application 1360B through a web browser) and submitting their login information through the GUI of the emergency response application 1360B. In some embodiments, when the ESP member logs into the emergency response application 1360B by submitting their login information, the emergency response application 1360B or EMS 1320 then determines an ESP account ID associated with the ESP member's account and establishes a persistent or active communication link (e.g., a websocket connection) with the ESP console 1330B, thereby automatically subscribing the ESP console to the ESP account ID for the duration of their login session. Then, as described above, when the EMS 1320 receives an emergency alert including a location (e.g., when an emergency call is made from an electronic device 1310B and sends an emergency alert to the EMS 1320 including a location generated by the electronic device 1310B), the EMS 1320 retrieves a geofence associated with every ESP registered with the EMS 1320 and determines if the location falls within any of the geofences. In response to determining that the location falls within a geofence associated with the ESP associated with the ESP account ID, the EMS 1320 then associates the location with the ESP account ID, determines if there are any active or persistent communication links between the EMS 1320 and any computing devices subscribed to the ESP account ID. In this instance, because the ESP console 1330B is subscribed to the ESP account ID and actively linked to the EMS 1320 through the persistent or active communication link, the EMS 1320 automatically pushes (e.g., from the clearinghouse) the emergency alert or emergency data associated with the emergency alert (e.g., the location, a phone number, etc.) to the ESP console 1330B for display within the emergency response application 1360B. In some embodiments, emergency alerts or emergency data associated with emergency alerts that have been pushed to an ESP are displayed within a jurisdictional awareness view, as described below.

For example, ESP console 1330B and ESP console 1330C are two different ESP consoles associated with the same ESP (e.g., two computing devices at the same public safety answering point (PSAP)), PSAP A. ESP console 1330D is associated with a second ESP, PSAP B. One day, PSAP call-takers access and successfully log into the emergency response application 1360 (emergency response application 1360D-1360D) at each of the three ESP consoles (ESP console 1330B-1330D), thereby establishing three separate active communication links, one active communication link between the EMS 1320 and each of the three ESP consoles. The ESP consoles are automatically subscribed by the EMS 1320 to the ESP account IDs associated with their respective ESPs (ESP ID A for PSAP A and ESP ID B for PSAP B). Both PSAP A and PSAP B are associated with only one geofence, geofence A and geofence B, respectively. Geofences A and B do not overlap. The geofences have previously been tagged within the EMS 1320 with their respective ESP account IDs (e.g., during the registration process for the emergency response application, as described above).

Later that day, an emergency call is made from communication device 1310B, which causes communication device 1310B to generate a first emergency alert including a first location of the communication device 1310B and transmit the first emergency alert to the EMS 1320. When the EMS 1320 receives the first emergency alert, the EMS 1320 retrieves some or all of the geofences stored within the EMS 1320 and determines if the first location falls within any of the geofences stored within the EMS 1320. In this example, the EMS 1320 determines that the first location falls within geofence A, associated with PSAP A. In response, the EMS 1320 tags the first location with the ESP account ID associated with geofence A, ESP ID A. The EMS 1320 then determines if there are any active communication links between the EMS and any ESP consoles subscribed to ESP ID A and automatically pushes (e.g., from the clearinghouse) the first emergency alert to those ESP consoles. In this example, both ESP console 1330B and ESP console 1330C are subscribed to ESP ID A, so the EMS 1320 automatically pushes the first emergency alert to both ESP console 1330B and ESP console 1330C for display within emergency response applications 1360B and 1360C, respectively, such as through a jurisdictional awareness view (as described below). The first location does not fall within geofence B, because geofence A and geofence B do not overlap, so the first emergency alert is not pushed to ESP console 1330D, even though an active communication link has been established between the EMS 1320 and ESP console 1330D.

Three minutes later, the EMS 1320 receives an emergency alert from electronic device 1310D (e.g., a home security system) including a second location of the electronic device 1310D. When the EMS 1320 receives the second emergency alert, the EMS again retrieves some or all of the geofences stored within the EMS 1320 and determines if the second location falls within any of the geofences stored within the EMS 1320. In this example, the EMS 1320 determines that the second location falls within geofence B, associated with PSAP B. In response, the EMS 1320 tags the second location within the ESP account associated with geofence B, ESP ID B and automatically pushes the second emergency alert to ESP console 1330D for display within emergency response application 1360D, because ESP console 1330D has an active communication link established with the EMS 1320 and ESP console 1330D is subscribed to ESP ID B. The EMS 1320 does not push the second emergency alert to ESP console 1330B or ESP console 1330C. Although ESP console 1330B and ESP console 1330C have active communication links established with the EMS 1320, they are not subscribed to ESP ID B, and geofence A and geofence B do not overlap, meaning the second location does not fall within geofence A. Two minutes after that, the EMS 1320 receives an emergency alert from electronic device 1310C (e.g., an intelligent vehicle system) including a third location of the electronic device 1310C. The EMS 1320 determines that the third locations falls within geofence A (like the first location included in the first emergency alert) and thus automatically pushes the third emergency alert to both ESP console 1330B and ESP console 1330C for display within emergency response application 1360B and 1360C. In some embodiments, emergency response application 1360B and emergency response application 1360C display the first emergency alert and the third emergency alert simultaneously, such as through a jurisdictional awareness view, as described below.

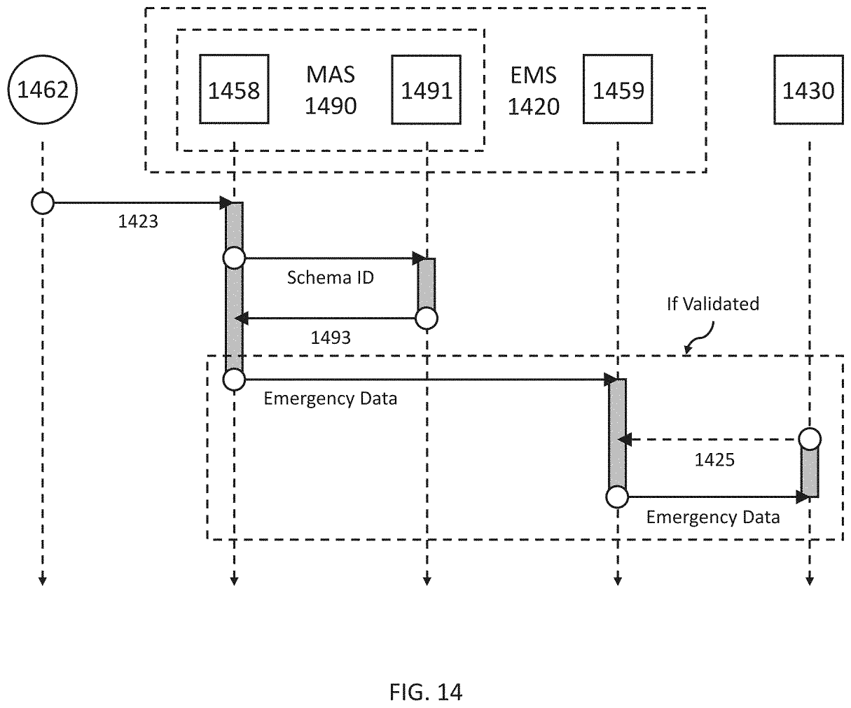

As described above, in some embodiments, an emergency management system (EMS) employs a modular API system (MAS) for receiving data packets (e.g., data included in emergency alerts) from a dynamically growing set of data sources without requiring redundant engineering work to be done whenever a new data source is added to the set of data sources. In some embodiments, as described above, the MAS stores a plurality of MAS schemas in a schema database. When an API managed by the MAS receives a data packet, the MAS can retrieve a MAS schema associated with the data packet from the schema database and attempt to validate the data packet against the MAS schema before the API performs its desired function. FIG. 14 depicts a ladder diagram of a process for utilizing a MAS in accordance with some embodiments of the present disclosure. As depicted in FIG. 14 an EMS 1420 employs a MAS 1490, which includes a data ingestion module 1458 (e.g., an API) managed by the MAS 1490 and a schema database 1491. First, a data source 1462 transmits (directly or indirectly, such as through a third-party server, as described above) an emergency alert 1423 to the data ingestion module 1458. The emergency alert 1423 includes a schema identifier (“Schema ID”) and emergency data (e.g., a user identifier, an emergency location, additional data, etc.). The MAS 1490 then uses the schema identifier to retrieve a MAS schema 1493 associated with the schema identifier from the schema database 1491 and returns the schema 1493 to the data ingestion module 1458. The data ingestion module 1458 then attempts to validate the emergency data included in the emergency alert 1423 by determining if the emergency data includes values for all of the data fields defined as mandatory by the schema 1493 and that all of the values are in the proper data formats as defined by the MAS schema 1493. If the emergency data is successfully validated against the MAS schema 1493, thereby generating a validated emergency data set (e.g., the data ingestion module 1458 determines that the emergency data does indeed include values for all of the data fields defined as mandatory by the MAS schema 1493 and that all of the values are in the proper data formats as defined by the MAS schema 1493), the data ingestion module 1458 transmits the validated emergency data set to one or more data retrieval modules 1459, from where the validated emergency data set (or emergency data included the validated emergency data set) can be pulled by (e.g., in response to an emergency data request 1425) or pushed to an appropriate recipient (e.g., ESP 1430), as described above. In some embodiments, before the validated emergency data set is transmitted to the one or more data retrieval modules 1459, the validated emergency data set is transmitted from the data ingestion module 1458 to one or more databases housed within or otherwise communicatively coupled to the EMS, from where the validated emergency data set (or emergency data included in the validated emergency data set) can later be retrieved by the one or more data retrieval modules 1459.

As mentioned above, in some embodiments, a MAS schema can be designated as supplemental data or as a primary request for emergency service (hereinafter, “primary request”). In some embodiments, data associated with a MAS schema that is designated as supplemental data is processed differently by the EMS than data associated with a MAS schema that is designated as a primary request. For example, in some embodiments, data associated with a MAS schema that is designated as a primary request is automatically and immediately pushed (as described above) to an appropriate recipient (e.g., an emergency service provider) as soon as it is received by the EMS, while data associated with a schema that is designated as supplemental data is stored within the EMS (e.g., within a clearinghouse database) until the data is requested by a recipient (e.g., via an emergency data request, as described above). In another example, in some embodiments, when the EMS receives data associated with a MAS schema designated as a primary request and transmits the data to an ESP through an emergency response application (as described above), the emergency response application creates an incident for the data within the emergency response application (as described below), while an incident is not created for data associated with a MAS schema designated as supplemental data. In another example, in some embodiments, data associated with a MAS schema designated as supplemental data is only transmitted to an ESP through an emergency response application if an incident otherwise already exists or is concurrently created within the emergency response application.

For example, in some embodiments, as described above, when a user makes an emergency call from a mobile phone, the mobile phone transmits an emergency alert including at least an identifier of the mobile phone (e.g., a phone number) and a location generated by the mobile phone to the EMS. The EMS then employs a geofence system to determine an appropriate ESP to receive the emergency alert using the location generated by the mobile phone, as described above. The EMS transmits the emergency alert (or the data included in the emergency alert) to the ESP through an emergency response application and creates an incident for the emergency alert within the emergency response application, as described below. In this example, because an incident has been created within the emergency response application for the emergency alert, any data designated as supplemental data (or any data associated with a MAS schema designated as supplemental data) that is associated with the emergency alert may be transmitted to the ESP and presented within the emergency response application as associated with the incident. For example, after receiving the emergency alert, the EMS may transmit a query including the identifier of the mobile phone (e.g., the phone number) to a third-party medical data database, which may in turn transmit a data packet including medical data to the EMS. The data packet received from the third-party medical data database is associated with a MAS schema that is designated as supplemental data. However, because the incident is created within the emergency response application and the data received by the EMS from the medical data database is associated with the incident (e.g., associated with the emergency alert via the identifier of the mobile phone), the data received from the medical data database can be transmitted to the ESP and presented within the emergency response application as associated with the incident. In some embodiments, supplemental data associated with an incident is only transmitted to the emergency response application in response to the incident being selected within the emergency response application, such as by a user of the emergency response application clicking on the incident (e.g., clicking on the incident prompts the emergency response application to request the supplemental data from the EMS).

In another example, the MAS schema created in FIG. 5 is later edited to be designated as a primary request. Later, a user of the ridesharing mobile application (for which the MAS schema illustrated in FIG. 5 was created) is on a ridesharing ride and the ride experiences an accident. In response, the user selects a panic button within the mobile application, which prompts the mobile application to transmit a data packet associated with the MAS schema created in FIG. 5 to the EMS. A MAS employed by the EMS retrieves the edited MAS schema, successfully validates the data packet against the edited MAS schema, and passes the data packet into the EMS. In this example, because the edited MAS schema is now designated as a primary request, the EMS uses the accident location to determine an appropriate ESP to receive the data included in the data packet (e.g., using a geofence system, as described above), transmits the data included in the data packet to the ESP through an emergency response application, and creates an incident associated with the data packet within the emergency response application. In this example, if the data packet included an identifier (e.g., an identifier of the user's phone, such as a phone number) that could be used to associate the data packet with other data, the EMS could query databases within or external to the EMS for any supplemental data associated with the identifier. If any supplemental data associated with the identifier is found by the EMS (e.g., the medical data retrieved from the third-party medical data database, as described above with respect to the previous example), the EMS could then transmit the supplemental data to the ESP and present the supplemental data within the emergency response application as associated with the incident, because the incident would have previously existed within the emergency response application.

### Emergency Response Application

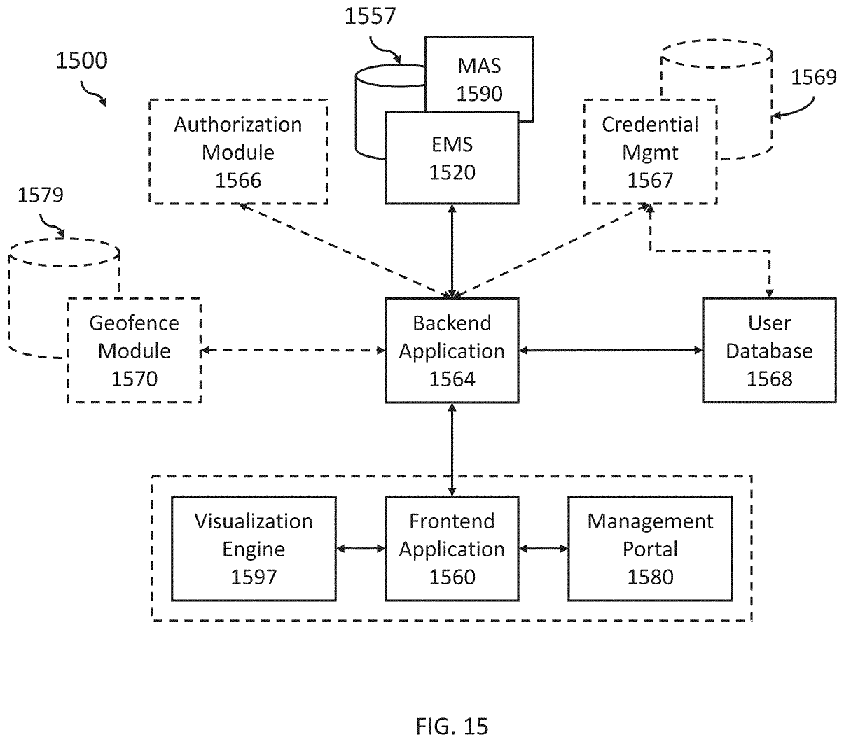

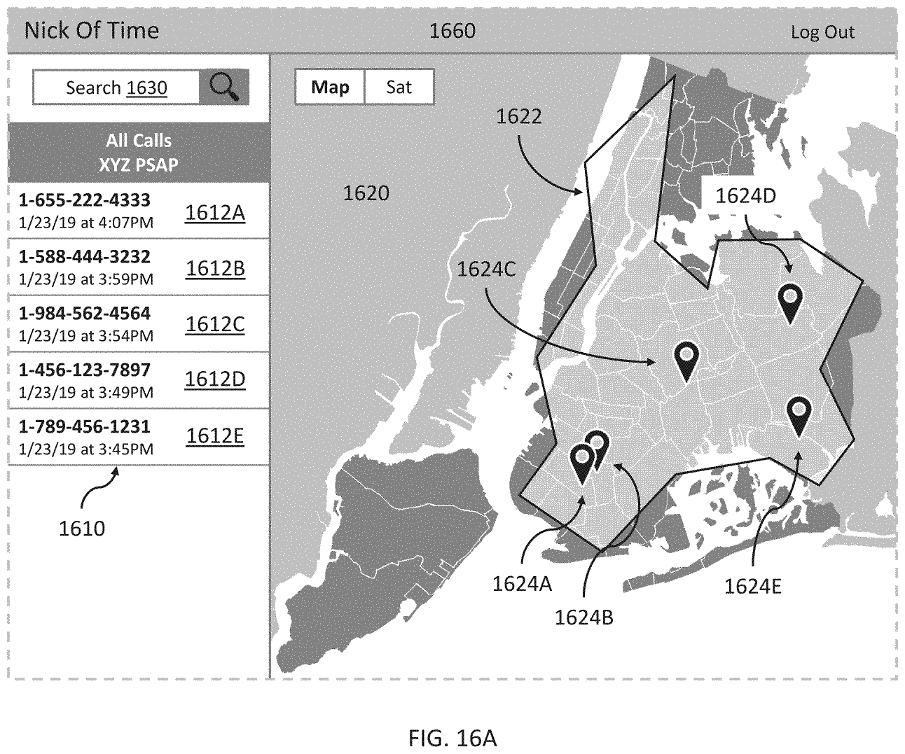

As mentioned above, in some embodiments, data and information is shared between the emergency management system (EMS) and an emergency service provider (ESP) through an emergency response application. In some embodiments, the emergency response application is a software application either installed on a computing device at the ESP or accessed via the internet through a web browser on the computing device (e.g., the emergency response application is hosted on a cloud computing system by the EMS). Generally, the emergency response application functions to both facilitate a two-way communication link between the EMS and the ESP and visualize data (e.g., emergency data) received by the ESP from the EMS. In some embodiments, as depicted in FIG. 15, an emergency response application system 1500 optionally includes various components, such as a frontend application 1560 (also referred to as a “graphical user interface” or “GUI”), a backend application 1564, an authorization module 1566, and a user database 1568. In some embodiments, the emergency response application 1500 additionally or alternatively includes a credential management system 1567 (which may include a credential management database 1569) or a geofence module 1570. In some embodiments, the credential management system 1567 and the geofence module 1570 are external to the emergency response application system 1500 and communicatively coupled to the emergency response application system 1500 (e.g., the credential management system 1567 or geofence module 1570 can be housed or hosted on a cloud computing system by an EMS 1520). Any or all of the components of the emergency response application system 1500 may be hosted on a cloud computing system by the EMS 1520, a computing device at an ESP, or some combination thereof. In some embodiments, the backend application 1564 functions to receive inputs from the frontend application 1560 and coordinates the functions of the authorization module 1566, the credential management system 1567, the user database 1568, and the geofence module 1570 to deliver emergency data to emergency service providers and display the emergency data to the users of the emergency response application system 1500 through the frontend application 1560. In some embodiments, one or more geofences are stored within one or more geofence databases 1579 accessible by the geofence module 1570. In some embodiments, as depicted in FIG. 15, the emergency response application system 1500 is communicatively coupled to the EMS 1520, which may respectively include a modular API system (MAS) 1590 and one or more databases 1557, as described above. In some embodiments, the frontend application 1560 includes or is otherwise communicatively coupled to a visualization engine 1597, as described below. In some embodiments, the frontend application 1560 includes or is otherwise communicatively coupled to an emergency data management system or management portal 1580, as described below.

In some embodiments, the frontend application (hereinafter, “emergency response application”) 1560 is a webpage that can be accessed through an internet or web browser. In such embodiments, the emergency response application 1560 can be quickly and easily integrated into the systems used by emergency service providers (ESPs), such as public safety answering points (PSAPs), because accessing and using emergency response application 1560 requires no additional software or hardware outside of standard computing devices and networks. As previously discussed, one of the greatest hinderances that PSAPs face in providing emergency assistance to people experiencing emergency situations is in acquiring accurate locations of the emergencies and the people involved, because PSAPs are currently typically limited to verbally asking for and verbally receiving locations from callers. In some embodiments, the clearinghouse is capable of receiving accurate locations (as well as additional emergency data, as described above) from electronic devices such as smartphones and delivering the accurate locations to the appropriate PSAPs during emergency situations. Therefore, it is advantageous to provide the emergency response application 1560 to PSAPs in the form of a webpage accessible through a standard web browser, in order to provide the potentially life-saving information stored within the clearinghouse to those capable of providing emergency assistance as quickly and easily as possible. However, in some embodiments, the emergency response application 1560 is a software application installed on a computing device at an ESP. The emergency response application may be provided by the EMS 1520 or by a third-party.

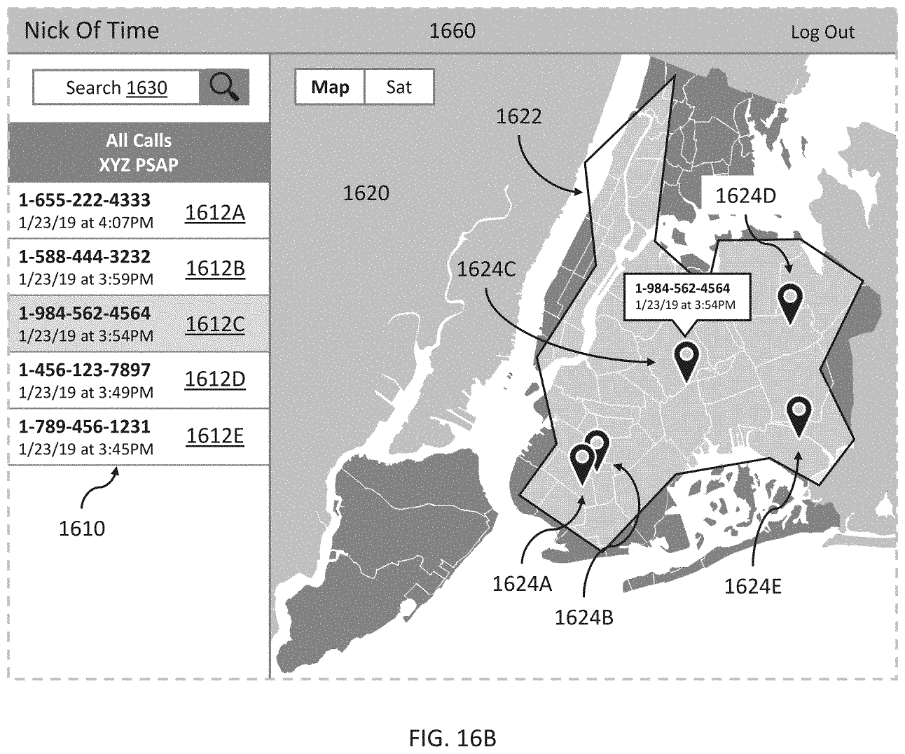

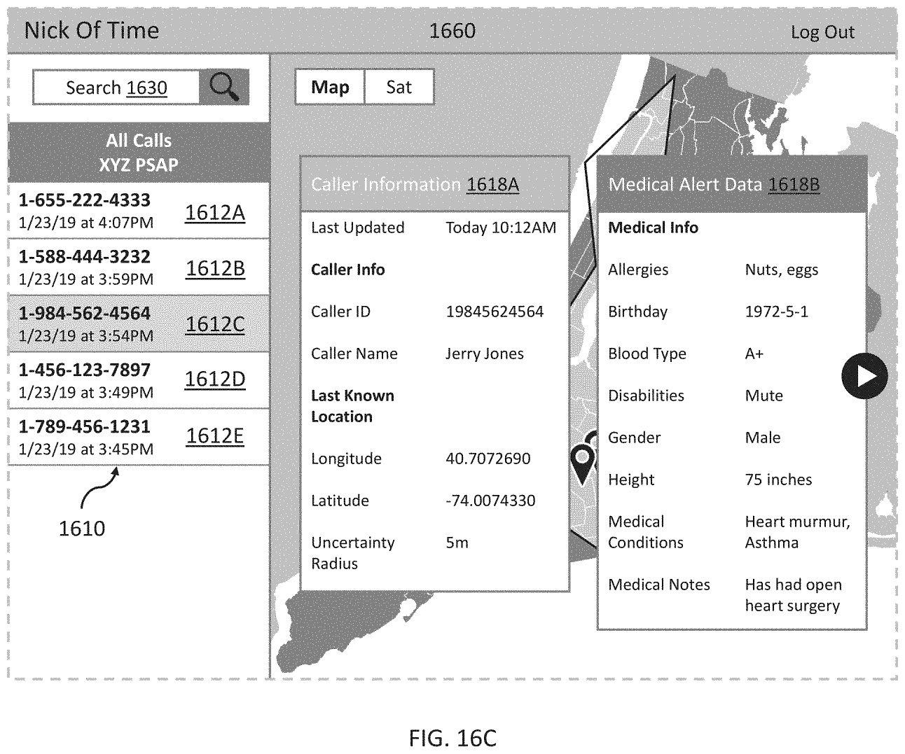

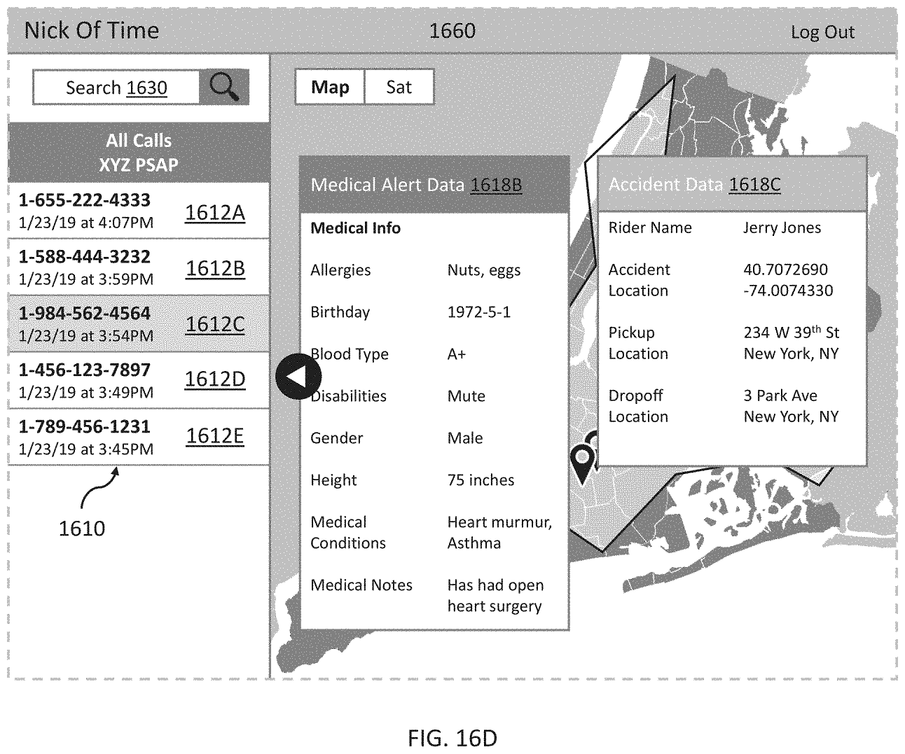

FIGS. 16A and 16B illustrate an embodiment of a graphical user interface (GUI) provided by an emergency response application 1660. The dashboard is a page within the GUI that provides interactive elements that allow a user at an ESP to receive data from the EMS, visualize data received from the EMS, and transmit data to the EMS. For example, in some embodiments, the dashboard includes an entry field 1630 through which a user can submit a device identifier, such as by typing or pasting the device identifier into the entry field 1630. In some embodiments, after submitting a device identifier through the entry field 1630, the user can prompt the emergency response application 1660 to generate and send an emergency data request by selecting a search button. The emergency response application 1660 then generates an emergency data request including the device identifier and any other necessary information (e.g., a temporary access token) and transmits the emergency data request to the EMS. The EMS can then return any available emergency data associated with the device identifier to the emergency response application 1660, as described above and below. In another example, in some embodiments, the emergency response application 1660 can automatically receive emergency data from the EMS for emergencies relevant to an ESP (e.g., emergencies located within the jurisdiction of the ESP) without requiring a user to generate an emergency data request, as described above and below. After receiving emergency data from the EMS, the emergency response application 1660 can then visualize the emergency data within the GUI of the emergency response application 1660. For example, in some embodiments, the emergency response application 1660 includes a list of incidents 1610 and an interactive map 1620, as illustrated by FIG. 16A. As shown, in some embodiments, when the emergency response application 1660 receives a location and a device identifier associated with an emergency occurring within the jurisdiction 1622 of the receiving ESP, the emergency response application 1660 displays the location associated with the emergency within the interactive map 1620 as a location marker 1624 (also referred to as an “incident location”) and displays the device identifier associated with the emergency within the list of incidents 1610 as an incident 1612.

In addition to emergency locations, the emergency response application 1660 can receive and visualize numerous types of emergency data from the EMS. For example, the emergency response application 1660 can receive additional data regarding an emergency, such as demographic or medical data associated with a person involved in the emergency (e.g., an emergency caller). In another example, the emergency response application 1660 can receive data from sensors associated with the emergency, such as heartrate data collected by a sensor on an emergency caller's smartwatch. The emergency response application 1660 can visualize any emergency data received from the EMS within the GUI of the emergency response application. In some embodiments, the emergency response application 1660 utilizes a visualization engine to visual emergency data received from the EMS, as described below.

In some embodiments, the systems, applications, servers, devices, methods, and media of the instant application provide a jurisdictional awareness view within the emergency response application 1660. In some embodiments, the jurisdictional awareness view enables an ESP to view one or more ongoing or recently received emergency alerts (e.g., emergency calls) within one or more geofenced jurisdictions. FIGS. 16A and 16B illustrate an embodiment of a jurisdictional awareness view displayed within the emergency response application. In some embodiments, the jurisdictional awareness view includes a list of incidents 1610 that displays one or more incidents 1612 associated with one or more device identifiers (e.g., phone numbers, IP addresses). In some embodiments, the jurisdictional awareness view additionally or alternatively includes an interactive map 1620 that displays one or more incident locations 1624 associated with the one or more incidents 1612 associated with the one or more device identifiers, as described below. In some embodiments, the jurisdictional awareness view displays incidents and incident locations only for emergencies occurring within the jurisdiction 1622 of the ESP at which the emergency response application 860 is being accessed.

For example, in the example illustrated in FIG. 16A, an ESP has accessed an emergency response application 1660 provided by the EMS. In this example, the EMS has pushed emergency data associated with five different emergency alerts to the ESP (as described above) through the emergency response application 1660. Accordingly, the emergency response application 1660 displays five different incidents 1612 (e.g., incidents 1612A-1612E) within the list of incidents 1610 and five corresponding incident locations 1624 (e.g., incident locations 1624A-1624E) within the interactive map 1620. As illustrated by FIG. 16B, in some embodiments, incidents 1612 and incident locations 1624 may be selected or hovered over to highlight a particular incident 1612. In this example, incident 1612C and its corresponding incident location 1624C have been selected and highlighted. In some embodiments, selecting a particular incident 1612 or corresponding incident location 1624 prompts the emergency response application 860 to display additional information associated with the particular incident 1612 (e.g., additional emergency data or information associated with the emergency alert for which the particular incident 1612 was created). Because the jurisdiction view can show an ESP numerous incidents 1612 occurring within the jurisdiction 1622 of the ESP simultaneously, the jurisdiction view can provide the ESP with situational awareness that the ESP otherwise would not have. For example, with the knowledge that incidents 1612A and 1612B originated in close proximity and at approximately the same time, an ESP personnel (e.g., a call taker at a public safety answering point) can determine that the two incidents may be related.

### Visualization Engine

As described above, in some embodiments, an emergency response application functions to receive emergency data from an emergency management system (EMS) and visualize the emergency data received from the EMS within a graphical user interface (GUI). In some embodiments, the visualization engine is a component of a modular API system (MAS). In some embodiments, the emergency response application utilizes a visualization engine to visualize and display emergency data received from the EMS within the GUI, as described below. FIG. 16C illustrates examples of data cards generated by a visualization engine and presented within a GUI of an emergency response application in accordance with some embodiments of the present disclosure. In some embodiments, as described above, data received or stored by the EMS may be tagged (either before or after being received by the EMS) in various ways, such as by appending the data with metadata. For example, data received or stored by the EMS may be tagged with a data type or one or more visualization rules, as described above. In another example, data received or stored by the EMS may be tagged with an identifier, such as a user identifier (e.g., a phone number or an email address) or a source identifier (e.g., an identifier of the type of device or the associated organization that generated or transmitted the data). In some embodiments, data received or stored by the EMS may be tagged with a data category, as described above. In some embodiments, data received by the EMS may be tagged with an identifier of a MAS schema (also referred to as a “schema identifier”) against which the data was validated, as described above. An individual piece of a data (e.g., an individual data value) may be tagged with a plurality of tags. For example, a location (e.g., an individual data value) generated by a wearable device (e.g., a FitBit tracker) may be tagged with “location” (data type), “caller information” (data category), “wearable” (device type), “FitBit” (data source), and “fitbit_schema_1” (schema identifier) tags.

In some embodiments, as mentioned above, an emergency response application includes or is otherwise communicatively coupled to a visualization engine that the emergency response application uses to visualize and display data within a GUI of the emergency response application. In some embodiments, when the emergency response application 1660 receives data from the EMS, the visualization engine identifies the tags associated with the data and visualizes the data according to those tags. For example, as illustrated in FIG. 16C, in some embodiments, the visualization engine displays data within the GUI within data cards 1618 that may be categorized in various ways. For example, as illustrated in FIG. 16C, “Caller Information” data card 1618A includes data tagged with the “caller information” data category, such as caller ID (e.g., a phone number), caller name, and location data. In another example, as illustrated in FIG. 16C, “Medical Alert Data” data card 1618B includes data tagged with the source “Medical Alert.”

In some embodiments, the visualization engine visualizes (or renders) data within the GUI of the emergency response application 1660 based on visualization rules (as described above with respect to FIG. 5) or other designations associated with or tagged onto the data. For example, referring again to the “Medical Alert Data” data card 1618B as illustrated in FIG. 16C, Medical Alert may represent an organization that receives and stores medical information regarding users in a medical information database. In this example, a Medical Alert MAS schema has been created for Medical Alert to transmit data to the EMS through a modular API system (MAS), as described above. The MAS schema created for Medical Alert (hereinafter, the “MedicalAlert schema”) includes at least eight data fields, represented by the data labels “Allergies,” “Birthday,” “Blood Type,” “Disabilities,” “Gender,” “Height,” “Medical Conditions,” and “Medical Notes.” It is possible that the Medical Alert MAS schema includes other data fields designated as non-mandatory, as described above, but that those other data fields designated as non-mandatory did not have values in the example illustrated in FIG. 16C. In this example, the values for the eight data fields are displayed within the “Medical Alert Data” data card 1618B to the right of the display labels. For example, the data field represented by the display label “Disabilities” has a value of “Mute,” which is a string data type, rendered as text. The data field represented by the display label “Birthday” has a value of “1972-5-1,” which may be a number data format, rendered as a date.

In another example, as illustrated by FIG. 16D, the “Accident Data” data card 1618C is a visualization, created by the visualization engine, of data included in a data packet associated with the MAS schema created within the schema editor interface in FIG. 5 for a ridesharing company. In this example, a user in a ridesharing ride has used an associated ridesharing application to alert an EMS that an accident has occurred during the ride. In response, the ridesharing application has transmitted a data packet to the EMS, which was received by a modular API system (MAS). As described above, the MAS has retrieved the MAS schema associated with the data packet (e.g., a schema associated with the ridesharing application or ridesharing company) and attempted to validate the data packet against the MAS schema, as described above. The data packet included values in the proper formats for all of the data fields designated as mandatory by the MAS schema, so the MAS has successfully validated the data packet against the MAS schema, tagged the data with the appropriate visualization rules and designations, and transmitted the data packet (e.g., the data included in the data packet) to a database within the EMS (e.g., because the MAS schema has been defined as supplemental data; if the MAS schema had been defined as a primary request, the data packet would have been automatically pushed to an appropriate ESP, as described above). In this example, an emergency phone call has been made by the rider (in this example, Jerry Jones) and an incident 1612C already exists within the emergency response application for the rider's emergency phone call. Thus, the EMS has associated the data packet with the incident 1612C, as described above. A user of the emergency response application 1660 has selected incident 1612C, and the data packet has now been visualized through the GUI of the emergency response application 1660 by the visualization engine within the “Accident Data” data card 1618C, as illustrated in FIG. 16D. As illustrated, the “Accident Data” data card 1618C displays all four of the data fields tagged with non-hidden rendering options (e.g., pickup_location, visible; dropoff_location, address; accident_location, lat/long; user_name, string) with the display labels given to the data fields (e.g., pickup_location, Pickup Location; dropoff_location, Dropoff Location; accident_location, Accident Location; user_name, Rider Name), in the order selected for the data fields (pickup_location, 3; dropoff_location, 4; accident_location, 2; user_name, 1), and in the rendering option that was selected for the data fields (pickup_location, visible (e.g., default); dropoff_location, address; accident_location, lat/long; user_name, text). In some embodiments, if a data packet does not include a value for a data field (e.g., a non-mandatory data field), the visualization engine displays a default value for the data field, such as “Unknown.” In some embodiments, a MAS schema or the visualization engine may include conditional formatting rules. For example, in some embodiments, if a value of a data field falls above or below a predetermined threshold for that data field, the visualization engine can emphasize the data field, such as by highlighting, underline, bolding, italicizing, or coloring the value associated with the data field when the data field is presented within the emergency response application 1660 (such as within a data card 1618). Although the visualization engine has been discussed herein in the context of emergency data applications, it will be understood that a visualization, like the modular API system (MAS) may be useful in many different applications and data environments.

In some embodiments, the visualization engine includes or is otherwise communicatively coupled to an emergency data management system that a user (e.g., an ESP administrator) of the emergency response application can access to control access to emergency data. In some embodiments, as described in further detail below, the emergency data management system can be used to select which kinds of data (e.g., which data fields, which data categories, or from which data sources, etc.) can be transmitted to or visualized for which users of the emergency response application. As mentioned above, an emergency management system (EMS) may have access to a dynamically growing set of data sources. The emergency data management system can be a useful tool for ESPs as more types of data and sources of data are received by the EMS and become available to the ESPs, because ESPs may not always be trained or prepared to receive and handle new types or sources of emergency data. Or, for example, certain levels of personnel at ESPs may be trained and prepared to receive and handle certain types or sources of emergency data that other levels of personnel are not. The emergency data management system provides ESPs with the ability and flexibility to control for such situations.

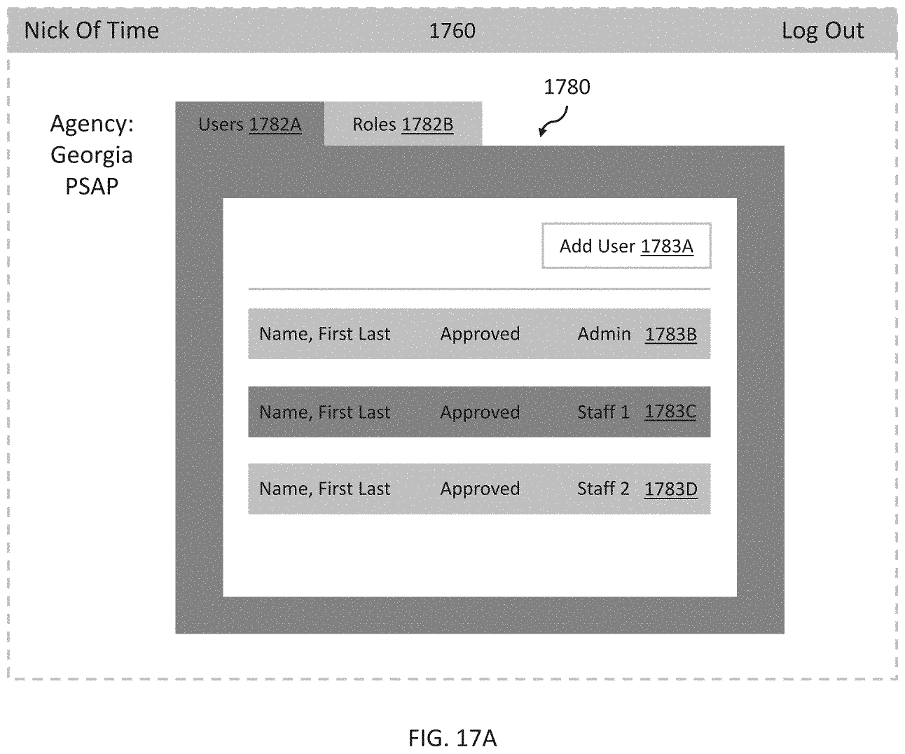

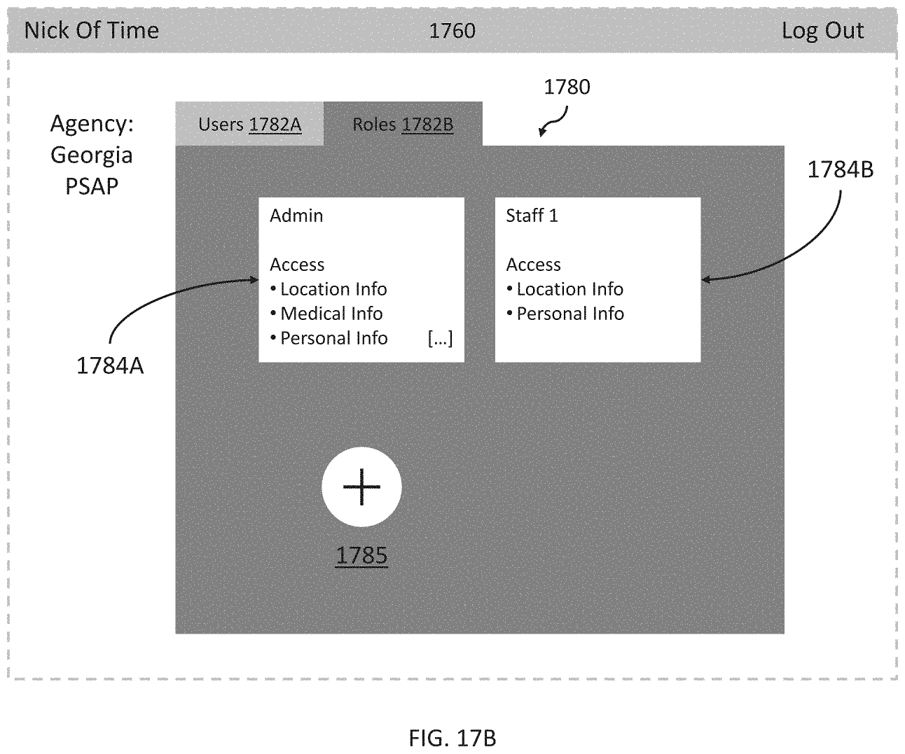

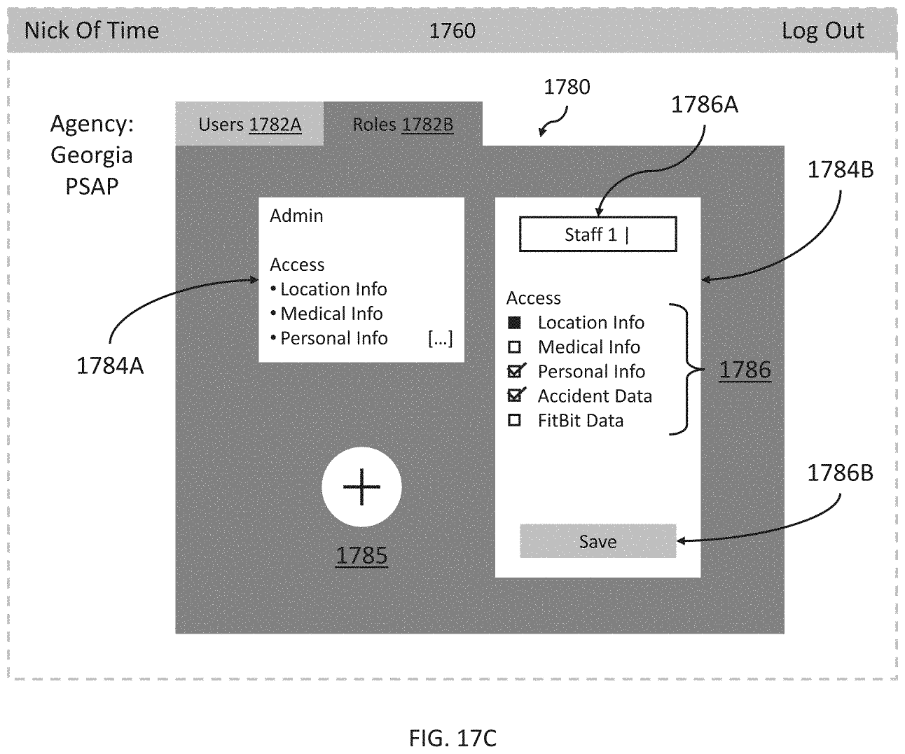

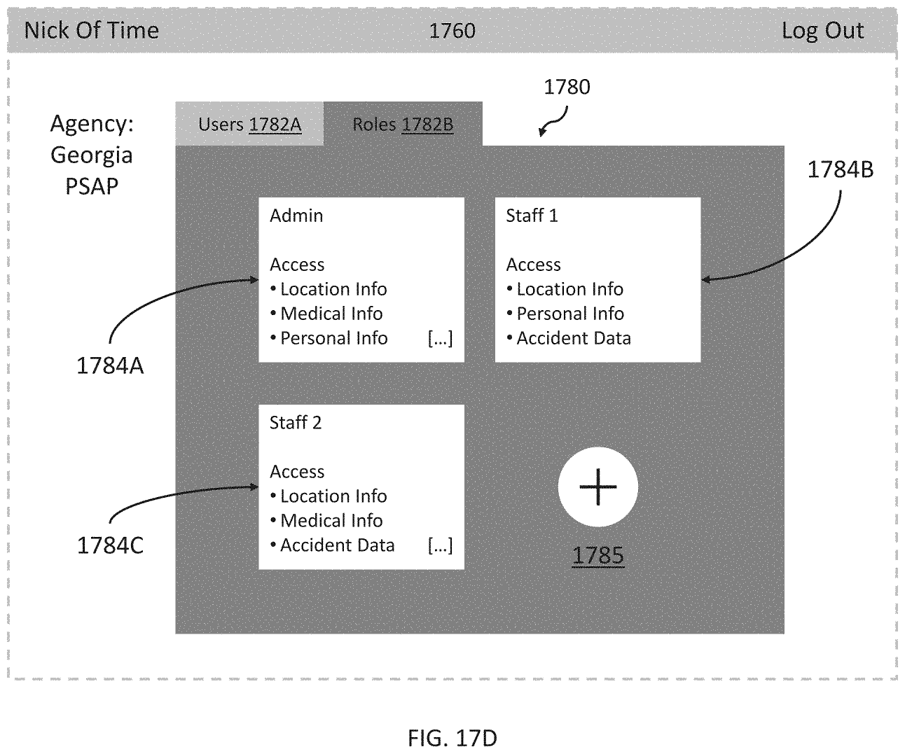

In some embodiments, the emergency data management system includes a frontend application (hereinafter, “management portal”) that can be accessed through a standalone website, web application (e.g., the emergency response application), or desktop application. FIGS. 17A-17D illustrate an embodiment of a management portal 1780 accessed through the emergency response application 1760. For example, in some embodiments, the jurisdiction view (as described above) and the management portal 1780 are accessed through different tabs or different pages within the emergency response application 1760. FIG. 17A illustrates a User tab 1782A of an embodiment of a management portal 1780 accessed through an emergency response application 1760. In some embodiments, a user of the management portal (e.g., an ESP administrator) can create accounts for employees or other members of the ESP within the Users tab 1782A. Selecting the Users tab 1782A prompts the web application 1760 to display a list of accounts associated with the particular ESP. For example, FIG. 17A depicts a non-limiting example of a list of accounts associated with the “Georgia PSAP” agency, which includes a PSAP administrator account 1783B, a PSAP staff 1 account 1783C, and a PSAP staff 2 account 1783D. In some embodiments, a user of the management portal can create a new account for an ESP by selecting the Add User button 1783A. In some embodiments, as depicted in FIG. 17A, every account associated with an ESP is assigned a role. As depicted, each of the accounts can be assigned a role, as described in further detail below. In this example, account 1783B has been assigned the “Admin” role, account 1783C has been assigned the “Staff 1” role, and account 1783D has been assigned the “Staff 2” role.

FIG. 17B illustrates a Roles tab 1782B of an embodiment of a management portal 1780 accessed through an emergency response application 1760. In some embodiments, a user of the management portal (e.g., an ESP administrator) can access the Roles tab 1782B to create new roles for a particular ESP, or edit existing roles, as illustrated by FIGS. 17B-17D. In some embodiments, the Roles tab 1782B is a graphical user interface (GUI) of a management portal 1780. As shown in FIG. 17B, two existing roles for the Georgia PSAP are displayed within the Roles tab 1782B, the Admin role 1784A and the Staff 1 role 1784B. In some embodiments, as depicted by FIG. 17B, roles for a particular ESP are displayed within the Roles tab 1782B as tiles that can be selected. In some embodiments, as depicted by FIG. 17B, the tiles representing roles display the emergency data fields, emergency data categories (e.g., groups of emergency data fields, as described above), data sources, or MAS schemas that the roles have been given access to. For example, as shown in FIG. 17B, the Admin role 1784 for the Georgia PSAP has been given access to at least the Location Information, Medical Information, and Personal Information data categories. In this example, the Admin role 1784 has additional access (also referred to as permissions) hidden until the tile is selected (denoted by the [ . . . ] symbol), for the purpose of saving screen space within the GUI. However, the Staff 1 role 1784B for the Georgia PSAP has only been given access to the Location Information and Personal Information data categories.

In some embodiments, as shown in FIG. 17C, when a tile representing a role is selected within the Roles tab 1782B, the tile expands to display all of the emergency data fields, emergency data categories, emergency data sources, or MAS schemas provided by the EMS to the ESP and allows a user of the management portal (e.g., an ESP administrator) to select or deselect emergency data fields, emergency data categories, emergency data sources, or MAS schemas (hereinafter, “options” 1786) to be made accessible for the role, to edit the title of the role in text box 1786A, or to save the edited role with save button 1786B. In some embodiments, one or more options 1786 may not be able to be deselected. For example, as shown in FIG. 17C, while the Medical Information data category is unselected (unchecked box) and the Personal Information data category is selected (checked box), the Location Information data category is permanently selected (filled in box) and cannot be deselected. In the example illustrated in FIG. 17C, a user of the management portal has selected Accident Data (the MAS schema created in FIG. 5) to now be made available for the Staff 1 role.

In some embodiments, a user of the management portal can create a new role for an ESP by selecting the create new role button 1785. For example, as shown in FIG. 17D, a user of the management portal has created a new role, the Staff 2 role 1784C, for the Georgia PSAP. The Staff 2 role has been given access to at least the Location Information and Medical Information data categories, as well as the Accident Data schema. Thus, now, if a user associated with either the Staff 1 or Staff 2 role at the Georgia PSAP access the emergency response application, when the EMS receives successfully validated data associated with the Accident Data schema, the EMS will transmit the data to the emergency response application, and the visualization engine will display the Accident Data card (as shown in FIG. 16D) within the emergency response application, as described above. In some embodiments, before transmitting data to an emergency response application, the EMS checks to verify that the user accessing the emergency response application is associated with a role that has been given access to the data. In some embodiments, the EMS does not check a user's role before transmitting data to the emergency response application, and the visualization engine checks the user's role to verify that the user accessing the emergency response application is associated with a role that has been given access to the emergency data before visualizing the data within the emergency response application. In some embodiments, accounts and their associated roles are stored in a user database, such as user database 1568 depicted in FIG. 15.

### Exemplary Schemas

As described above, in various embodiments, a modular API system (MAS) allows for a single API to access a plurality of schemas (e.g., MAS schemas). Thus, the MAS allows for a single API to receive data from a plurality of data sources, in which each data source might provide different types or different amounts of data. Furthermore, in some embodiments, the MAS includes a schema editor interface, through which MAS schemas can be created or edited with little to no software engineering expertise. The schema editor interface therefore allows a MAS API (e.g., an API managed by a MAS) to receive data from additional data sources without having to be reengineered. Furthermore, in some embodiments, the MAS includes a visualization engine, which can interpret visualization rules included in MAS schemas and visualize data received by the MAS within a graphical user interface according to the visualization rules included in the MAS schemas. Essentially, the MAS provides for dynamic and flexible data ingestion and visualization with minimal engineering time and effort.

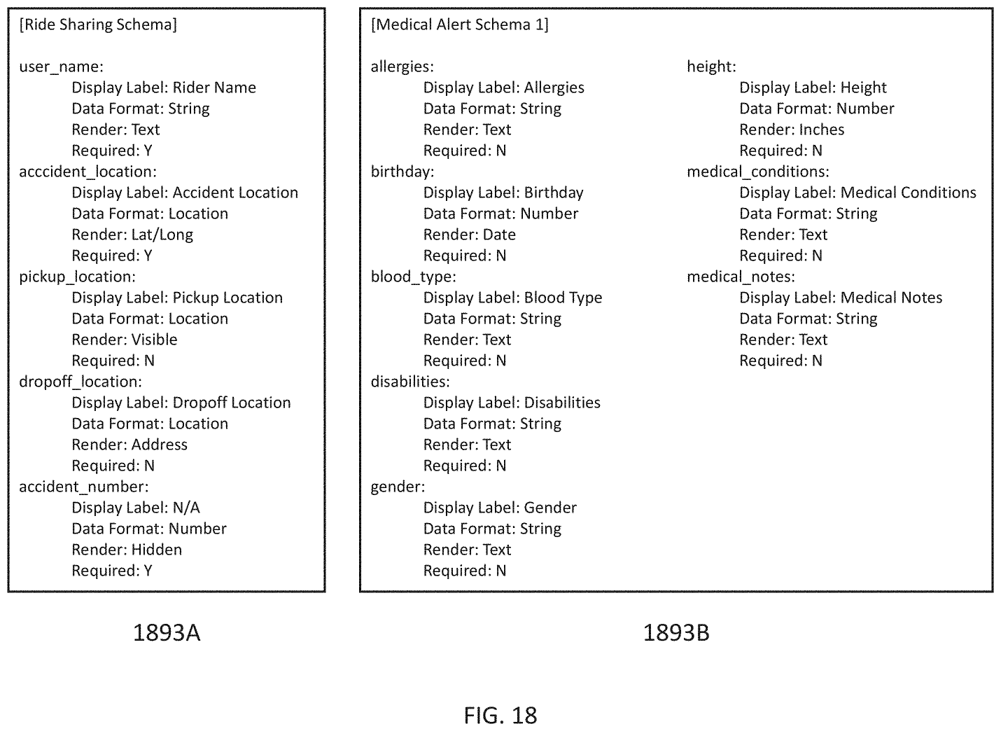

FIG. 18 depicts two exemplary MAS schemas, in accordance with some embodiments. MAS schema 1893A is a visual depiction of the MAS schema created with the schema editor interface in FIG. 5 for a ride sharing mobile application (e.g., Uber). As described above with regards to FIG. 5, a user has added five data fields to the ride sharing schema: accident_number, pickup_location, dropoff_location, accident_location, and user_name. The user has also selected or defined data formats, rendering options, display labels, and a display order for the five data fields. After saving and publishing the schema (as described above), an identifier of the schema (also referred to as a “schema identifier” or a “schema ID”) is produced and provided to the user, and the schema itself is stored within a schema database for later reference. MAS schema 1893A is a depiction of the ride sharing schema as stored in the schema database. As depicted in FIG. 18A, the MAS has saved and stored the data fields of the ride sharing schema along with the respective data formats, rendering options, and display labels chosen by the user, and in the display order selected by the user. As described above, data card 1618C (as illustrated in FIG. 16D) is a visualization of data received by a MAS according to the visualization rules defined by MAS schema 1893A (e.g., the user_name data field is displayed first, under the display label “Rider Name,” and rendered as text; the accident_location data field is displayed second, under the display label “Accident Location,” and rendered as a latitude/longitude pair; etc.). Similarly, MAS schema 1893B (Medical Alert Schema 1) is a visual depiction of the MAS schema used to generate data card 1618B (as illustrated in FIGS. 16C and 16D). As depicted in FIG. 18, MAS schema 1893B is saved and stored within a schema database with the same eight data fields displayed in data card 1618B (allergies, birthday, blood_type, disabilities, gender, height, medical_conditions, and medical_notes) in the same order that they are displayed in data card 1618B.

### Action Schemas

As disclosed herein, in some embodiments, a modular API system (MAS) includes a library of actions (e.g., library of actions 485, as depicted in FIG. 4) containing protocols that can be added to a MAS schema, in order to provide MAS schemas with additional functionality. As described above, in various embodiments, an API managed by a MAS receives data associated with a schema identifier, retrieves a MAS schema associated with the schema identifier from a schema database, and validates the data against the schema. Then, when the data is transmitted to a recipient, the MAS (or a visualization engine communicatively coupled to the MAS) visualizes the data according to visualization rules defined by the MAS schema. For example, in some embodiments, the visualization engine visualizes data within data cards, as described above. In such an embodiment, the MAS schema might be considered passive, meaning that the schema defines no actions to be performed. However, in some embodiments, a MAS schema may include instructions for a system communicatively coupled to the MAS (e.g., an EMS, or a component of the EMS, such as the emergency flow management system or the emergency response application, as described above) to perform various actions. For example, in some embodiments, a MAS schema can include instructions for an emergency flow management system to retrieve and execute an emergency flow (as described above). Or for example, in some embodiments, a MAS schema can include instructions for an emergency response application to display a clickable action (e.g., a button or a hyperlink) that prompts the emergency management system to query a third-party system (as described above) when selected. However, a MAS schema can include instructions for any system communicatively connected to a MAS to perform any action.

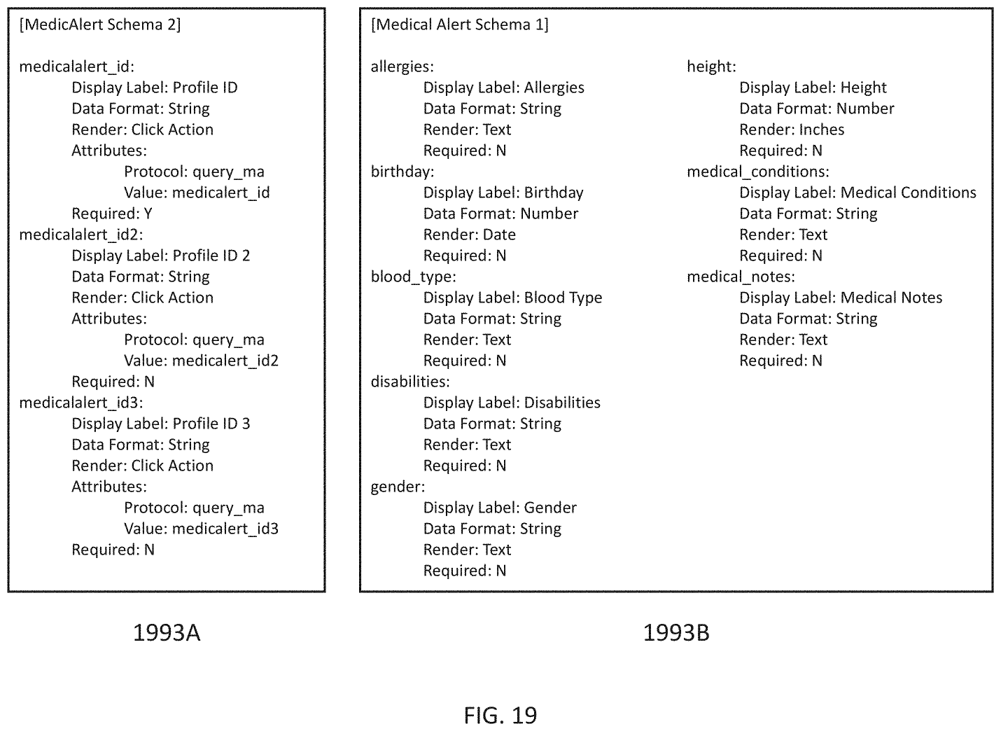

FIG. 19 depicts an exemplary MAS schema 1993A that includes instructions for an emergency response application to display a clickable action that prompts the emergency management system (EMS) to query a third-party system. In this example, the emergency management system is communicatively coupled to backend system managed by a medical organization that receives and stores medical information regarding users in a medical information database (e.g., Medical Alert). In some embodiments, as described above, when the EMS detects an emergency call, the EMS queries third-party systems using the phone number associated with the emergency call for emergency data associated with the emergency call and provides the emergency data to an emergency service provider (ESP) through the graphical user interface (GUI) of an emergency response application. For example, the EMS can query the medical organization (e.g., the backend system managed by the medical organization) for medical information associated with the phone number associated with the emergency call. In this example, an individual profile is created by the medical organization for each user for which medical information is received and stored within the medical information database. However, multiple profiles may be associated with a single user identifier, such as the phone number of a caretaker who provides medical care for multiple users registered with the medical organization. Thus, if/when the caretaker makes an emergency call from their phone, it is likely that they are not calling on behalf of themselves, and, if they provide medical care to multiple users registered with the medical organization, it would be difficult to determine exactly which user the caretaker might be calling on behalf of. To solve this problem, as opposed to returning medical information for each of the profiles associated with the phone number of the caretaker in response to a query from the EMS including the phone number of the caretaker (which would needlessly expose potentially sensitive data for the non-relevant profiles), the medical organization initially returns only the profile identifiers (also referred to as “profile IDs”) of the profiles associated with the phone number of the caretaker. The profile IDs are received by the EMS (employing a MAS) using a MAS schema (e.g., MAS schema 1993A) that includes instructions for the profile IDs to be rendered within the GUI of an emergency response application as clickable actions. When a clickable action rendered for a profile ID is selected from within the GUI of the emergency response application, the emergency response application prompts the EMS to query the medical organization for medical information regarding only the profile associated with the selected profile ID.

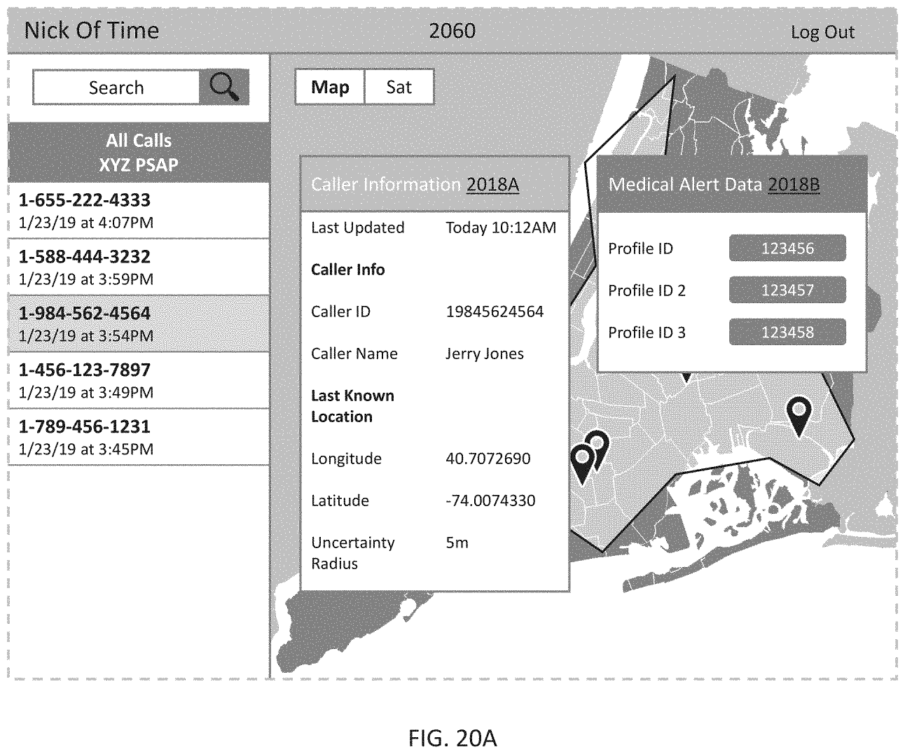

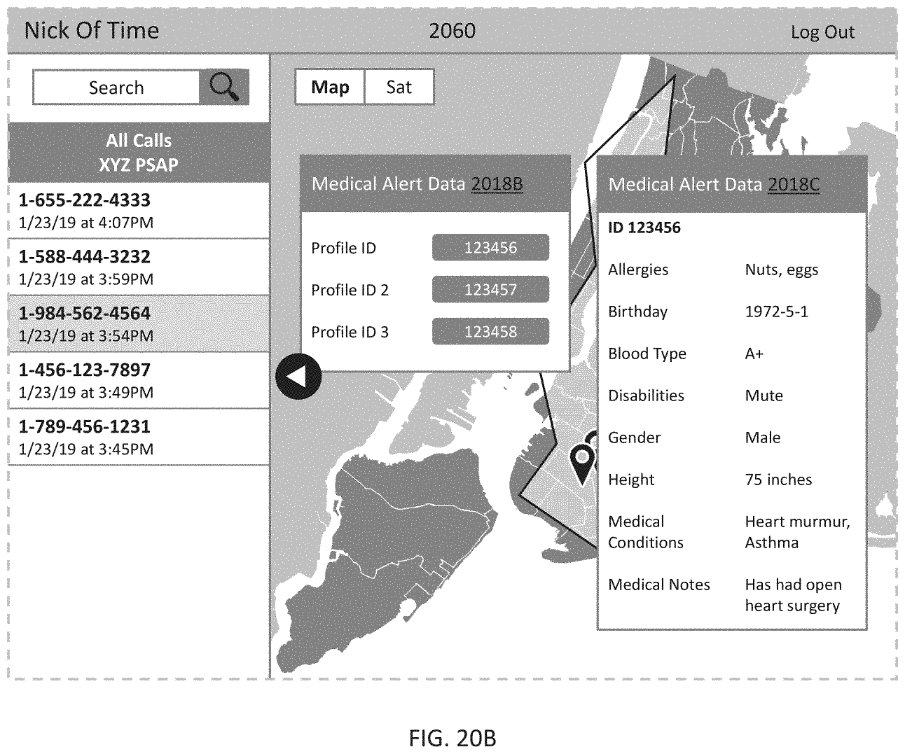

As depicted in FIG. 19, MAS schema 1993A (Medical Alert Schema 2) includes three virtually identical data fields (medicalalert_id, medicalalert_id2, and medicalalert_id3) each of which represent profile IDs (as described above). In this example, when the medical organization backend system receives a query including a phone number from the EMS, the medical organization backend system is programmed to return profile IDs to the EMS (as described above) in a data packet that also includes an identifier (e.g., a schema ID) associated with MedicalAlert Schema 2. When the MAS employed by the EMS receives the data packet including the profile IDs and the schema ID associated with MedicalAlert Schema 2, the MAS uses the schema ID to retrieve MedicalAlert Schema 2 from a schema database (as described above) and validates the data packet against MedicalAlert Schema 2. In this example, as depicted in FIG. 19, the data packet must include at least one profile ID in the form of a string (although it may also include two others). In this example, MedicalAlert Schema 2 indicates that the render option for the medicalalert_id data field is Click Action. The Click Action render option instructs the visualization engine to render the medicalalert_id data field (e.g., the profile ID) as a clickable action (e.g., a button or a hyperlink), which will prompt the emergency response application to perform the action listed for Protocol (in this example, “query ma”) under the Attributes of the medicalalert_id data field using the value listed for Value (in this example, the medicalalert_id data value itself, e.g., the profile ID). Such a visualization is illustrated in FIG. 20A. In the example illustrated by FIG. 20A, the EMS has detected an emergency call made by a Jerry Jones (as seen in the Caller Information data card 2018A) and queried the medical organization backend system with the phone number associated with the emergency call (e.g., Jerry Jones's phone number). In this example, Jerry Jones happens to be a caretaker providing medical care to three users of the medical organization, and medical organization backend system has returned a data packet containing three respective profile IDs (profile IDs 123456, 123457, and 123458) and a schema ID associated with MedicalAlert schema 2. The MAS has used the schema ID to retrieve MedicalAlert schema 2 and validated the data packet against MedicalAlert schema 2 (as described above). The EMS has subsequently transmitted the data included in the data packet (e.g., the three profile IDs) to XYZ PSAP (e.g., the PSAP responding Jerry Jones's emergency call), and the visualization engine has rendered the three profile IDs as clickable actions (in this example, buttons) within the “MedicalAlert Data” data card 2018B according to the visualization rules defined by MedicalAlert schema 2, as illustrated in FIG. 20A.

A user of the emergency response application (e.g., the PSAP call taker responding to Jerry Jones's emergency call) then learns from Jerry that Jerry is calling on behalf of a user of the medical organization represented by profile ID 123456, and selects the clickable action (e.g., the button) for profile ID 123456. In response, the emergency response application 2060 prompts the EMS to perform the action associated with the clickable action for profile ID 123456, which, in this example, is the query ma protocol using the medicalalert_id value, as depicted in FIG. 19. The EMS (or the MAS employed by the EMS) then retrieves and executes the query ma protocol from the library of actions, which, in this example, instructs the EMS to send a second query to the medical organization backend system, but this time including the medicalalert_id value (e.g., the profile ID), as opposed to the phone number that was used in the first query (e.g., Jerry Jones's phone number). The medical organization backend system has been programmed to return data in response to queries from the EMS including profile IDs along with a second schema ID associated with MedicalAlert schema 1 (MAS schema 1993B, as depicted in FIG. 19). The EMS (or the MAS employed by the EMS) has received a data packet including medical information associated with profile ID 123456, used the second schema ID to retrieve MedicalAlert Schema 1 from the schema database, and validated the data packet against MedicalAlert Schema 1. The EMS has transmitted the medical information associated with profile ID 123456 to XYZ PSAP, and the visualization engine has rendered the medical information associated with profile ID 123456 within the “MedicalAlert Data” data card 2018C according to the visualization rules defined by MedicalAlert Schema 1, as illustrated in FIG. 20B.

The foregoing example is only one example of a MAS schema including instructions for a system communicatively coupled to the MAS to perform various actions. For example, the library of actions may include any number of protocols that can be called by a MAS schema. For example, in some embodiments, the library of actions includes an execute_flow protocol that can be incorporated into a MAS schema and, when rendered by the visualization engine within the emergency response application as a clickable action, prompts the emergency management system (or an emergency flow management system employed by the emergency management system) to execute an emergency flow (as described above) associated with an emergency flow ID defined by the MAS schema when selected. Or for example, in some embodiments, the library of actions includes a call_phone protocol that can be incorporated into a MAS schema and, when rendered by the visualization engine within the emergency response application as a clickable action, prompts the emergency management system to execute a phone call (e.g., a VoIP call) between the emergency response application a phone number (e.g., the phone number of an emergency contact) defined by the MAS schema when selected. However, the library of actions may include protocols configured to prompt a system communicatively coupled to the MAS to perform virtually any other action, such as opening a website or transmitting a text message.

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device. In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random-access memory (FRAM). In some embodiments, the non-volatile memory comprises phase-change random access memory (PRAM). In some embodiments, the non-volatile memory comprises magneto resistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing-based storage. In further embodiments, the storage and/or memory device is a combination of devices such as those disclosed herein.

In some embodiments, the digital processing device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the digital processing device includes an input device to receive information from a subject. In some embodiments, the input device is a keyboard. In some embodiments, the input device is a pointing device including, by way of non-limiting examples, a mouse, trackball, trackpad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PUP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Certain Terminologies

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, a “device” is a digital processing device designed with one or more functionality. A “triggering device” refers to a communication device with a communication component, which will allow it to send and receive information over a wireless channel, a wired channel, or any combination thereof (e.g., sending/receiving information over the Internet). Non-limiting examples of triggering devices include a mobile phone (e.g., a smartphone), a laptop, a desktop, a tablet, a radio (e.g., a two-way radio), and a vehicular communication system. In some embodiments, a triggering device includes a car security system (e.g., OnStar®), a home security system, or a home control system (e.g., a networked control system for providing network controlled and/or smart temperature control such as a Wi-Fi smart thermostat, lighting, entertainment, and/or door control, such as Nest®). In some embodiments, a triggering device is an Internet of Things (IoT) device. In some embodiments, the triggering device is a sensor for sensing environmental or health indicators. In some embodiments, the sensor may include a sensing component and a communication component. In some embodiments, the triggering device is a sensor in a sensor network or a device that controls a sensor network.

In some embodiments, a triggering device is a wearable device (e.g., a communication device worn by a user). In some embodiments, a triggering device (e.g., a wearable device) comprises one or more sensors. As used herein, a “mobile wireless device” refers to a device that is portable and communicates wirelessly. In some embodiments, a user wears or carries the mobile wireless device on the user's person or in the user's vehicle. Non-limiting examples of mobile wireless devices include mobile or cellular phones, wearable devices (e.g., smart watch, fitness tracker, wearable sensor, smart glasses, etc.).

As used herein, an “associated device” refers to a communication device that is associated with the triggering device. For example, a user may be using several communication devices such as a mobile phone, a wearable, a home security system, a car computer. The user may have registered these devices with his or her account and linked these devices with a username, user number(s), email address(es), home or other physical address(es). In some embodiments, associated devices may include communication devices of a second user who is associated with user, e.g., a husband and wife, a father and son, a victim and doctor, friends, work colleagues, etc. In some cases, the user may have added the second user as an emergency contact, a member of a group, etc. In some cases, user may have agreed to share location and other data with the second user. In some embodiments, the second user may be someone who is frequently contacted by the user and the communication device identifies the second user from the “Recently called” or “Frequently called” list. In some embodiments, the associated devices may be devices that are proximal or near-by to the triggering device such as obtained through a WiFi scan. In some embodiments, an associated device is proximal to the triggering device when the location of the associated device is within 1, 5, 10, 15, 20, 25, 30, 35, 40, 45, 50, 60, 70, 80, 90, 100, 200, 300, 400, or 500 meters of the location of the triggering device.

As used herein, the “list of associated devices” refers to a list of communication devices that are associated with the user or the triggering device (e.g., a second resident in a smart home). The list of associated devices may be listed by username, phone number, email address, physical address, coordinates etc. The device entry in the list may include phone number, email address, physical address, coordinates, BSSID, SSID or MAC address. The list may be user defined or generated by the device or the EMS.

As used herein, a “emergency service request” refers to a request or message sent to an emergency service provider for emergency assistance. In some embodiments, a request for assistance is an emergency request for assistance (e.g., the request is associated with an emergency situation) such as, for example, an emergency alert. In some embodiments, an emergency alert comprises a request for assistance. In some embodiments, a request for assistance is associated with an emergency situation. In some embodiments, a request for assistance comprises an emergency indication. In further embodiments, an emergency indication is selected from one or more of the group consisting of traffic accident, police emergency, medical emergency, and fire emergency. In some embodiments, a request for assistance is associated with a non-emergency situation (e.g., request for a tow truck after car breaks down). In some embodiments, a request for assistance is associated with a device sending the request. In other embodiments, a request for assistance is associated with a device not sending the request (e.g., a proxy request on behalf of a second device and/or a member device in a group of devices). As used herein, a request is “associated” with a device or user when the request relates to an emergency or non-emergency situation involving the device or user. In some embodiments, a request comprises data associated with a device (or user thereof). In some embodiments, a request comprises a data set associated with a device. For example, in some embodiments, a request comprises a data set associated with a device, wherein the data set comprises current location data. In other embodiments, a request for assistance is sent and/or received separately from data associated with a device. For example, in some embodiments, a request is sent first, and the recipient subsequently queries the device that sent the request for data or a data set associated with the emergency and/or device or user involved in the emergency. Alternatively, in some embodiments, a request is sent first, and the recipient subsequently queries the device associated with the emergency for data or a data set associated with the emergency and/or device or user involved in the emergency.

As used herein, a “emergency responder” refers to any person or persons responsible for addressing an emergency situation. In some embodiments, a first responder refers to government personnel responsible for addressing an emergency situation. In some embodiments, a first responder is responsible for a particular jurisdiction (e.g., a municipality, a township, a county, etc.). In some embodiments, a first responder is assigned to an emergency by an emergency dispatch center. In some embodiments, a first responder responds to a request for emergency assistance placed by a user via a user communication device. In some embodiments, a first responder includes one or more fire fighters, police officers, emergency medical personnel, community volunteers, private security, security personnel at a university, or other persons employed to protect and serve the public and/or certain subsets of the population.

As used herein, an “emergency service provider” (ESP) is a public or private organization or institution responsible for providing emergency services. For example, in some embodiments, an ESP (e.g., a public safety answering point (PSAP)), a fire department, a police department, and a hospital may all be considered emergency service providers. In some embodiments, an emergency responder is a member of an ESP. In some embodiments, an ESP personnel is a person who works at an ESP. For example, an ESP personnel may be a call-taker at a PSAP or a first responder at a fire department.

As used herein, a “recipient” refers to one or more persons, services, or systems that receive a request for assistance (e.g., an emergency alert). The recipient varies depending on the type of request. In some embodiments, a recipient is an emergency service. In some embodiments, a recipient is an emergency service when he requests for assistance pertains to an emergency (e.g., a tier 2 emergency). In some embodiments, a recipient is an emergency management system. In some embodiments, a recipient is an emergency dispatch center. In some embodiments, a recipient is an emergency dispatch center, wherein the request is first routed through an emergency management system (e.g., request is sent to the EMS, but ultimately is sent to an ESP). In some embodiments, a recipient is a first responder (e.g., a communication device of a first responder). In some embodiments, a recipient is a non-emergency service or personnel, for example, a relative or friend. In such situations, a user of a communication device (or member device or second device) does not require emergency assistance, but does need help. As an example, a user of a member device in a group of devices is a child who is lost in a theme park. The parent of the child has a communication device in the same group of devices as the child's member device. The parent uses the communication device to send a request for assistance on behalf of the child's member device to theme park security guards who are closer to the child than the parent. Security is then able to pick up the child quickly using the data set associated with the member device, which they are given authorization to access by the parent's communication device.

As used herein, an “emergency data source” refers to any device, server, or system that can produce, generate, or communicate information or data pertinent to an emergency. In some embodiments, an emergency data source is a communication device, a wearable device, an internet of things (IoT) device, or any other type of device. In some embodiments, an emergency data source is a network server. As used herein, an “emergency data recipient” refers to any device, server, or system or user of any device, server, or system that can receive information or data pertinent to an emergency. In some embodiments, an emergency data recipient is an emergency service provider (ESP), ESP personnel, or an electronic device associated with an ESP. In some embodiments, an emergency data recipient is a person in an emergency or an electronic device associated with a person in an emergency.

As used herein, a “victim” refers to a person experiencing an emergency. As used herein, a “medical service provider” is a facility that provides people with medical services, such as a hospital, healthcare clinic, emergency room, urgent care center, etc. As used herein, a “preferred medical service provider” is a medical service provider covered under a victim's medical insurance or a medical service provider or has better (e.g., more optimal or less expensive) coverage under the victim's medical insurance than another medical service provider. In some embodiments, a preferred medical service provider may be referred to as an “in-network hospital” or “in-network medical service provider.” As used herein, a medical service provider is “proximal” to a location if the medical service provider is within the vicinity of the location (e.g., within 1 mile, 2 miles, 3 miles, 4 miles, or 5 miles of the location).

As used herein, a “user” refers to one or more person or persons associated with a device (e.g., communication device, member device, second device, device of a first responder, etc.). In some embodiments, a user utilizes a device to place a request for assistance. In some embodiments, user refers to one or more persons who are paid subscribers of a network access service, for example, cellular service subscribers. In some embodiments, a user refers to anyone who gains access to a network via a router, for example, a Wi-Fi router, and is not a paid subscriber of any access service. In some embodiments, a device associated with a user is a device carried or worn on the person of the user (e.g., a phone or wearable device). In some embodiments, a device associated with a user is not carried or worn on the person of the user (e.g., a home security sensor or camera installed in the home of the user, a vehicle tracking system installed in a vehicle of the user, etc.).

As used herein, “data” refers to a collection of information about one or more entities (e.g., user of a user communication device) and/or an environment that pertains to characteristics of the one or more entities. In some embodiments, an entity is a person. In some embodiments, an entity is a thing (e.g., a house). For example, in some embodiments, data comprises sensor data from home sensors associated with a house. In this example, the data is also associated with one or more persons (e.g., the homeowner(s) and/or inhabitant(s)). In some embodiments, data refers to meta-data. In some embodiments, data comprises health information about the user of a communication device. In some embodiments, data comprises information about the surrounding environment of the user of the user communication device (e.g., surrounding temperature, location, elevation, barometric pressure, ambient noise level, ambient light level, surrounding geography, etc.). In some embodiments, data comprises information about other users that is pre-stored in a device or in a database (e.g., a database within a group of devices who are related to the user of the user communication device as predefined by the user). In some embodiments, the data set comprises information from two or more users of user communication devices, wherein each user is affected by the current emergency situation. As an example, two unrelated users are involved in a vehicular collision, and each user sends a separate emergency request (for traffic accident) using his/her communication device. In this example, the separate emergency requests are associated (e.g., by an emergency management system and/or emergency dispatch center) with the same emergency based on the proximity of time, location, and emergency indication of the emergency requests. As a result, the data set for this accident comprises information from both user communication devices. In this example, the data set comprises location information from both devices (e.g., GPS coordinates), biosensor data for one or both devices (e.g., biosensor data such as heart rate and blood pressure can be important in case of injury), and information about the vehicle driven by each user (e.g., make, model, and year of manufacture information stored on the device). In some embodiments, data comprises current data. In further embodiments, current data comprises information that is equal to or less than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, or 60 minutes old. In further embodiments, current data comprises information that equal to or less than 1, 2, 3, 4, 5, 6, 7, 8, 9, 10, 11, 12, 13, 14, 15, 16, 17, 18, 19, 20, 21, 22, 23, or 24 hours old. In some embodiments, data comprises historical data. In further embodiments, historical data comprises information that is equal to or more than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, or 60 minutes old. In further embodiments, historical data comprises information that equal to or more than 1, 2, 3, 4, 5, 6, 7, 8, 9, 10, 11, 12, 13, 14, 15, 16, 17, 18, 19, 20, 21, 22, 23, or 24 hours old. In some embodiments, the age of information is calculated from the date the information is first collected (e.g., when a sensor first detects a sensed parameter such as, for example, heart rate).

As used herein, “health data” refers to medical information associated with a user of a device. In some embodiments, health data comprises medical history such as, for example, past illnesses, surgery, food and/or drug allergies, diseases, disorders, medical diagnostic information (e.g., genetic profile screen), or any combination thereof. In some embodiments, health data comprises family medical history (e.g., family history of breast cancer). In some embodiments, health data comprises current health information such as, for example, current symptoms, current medications, and/or current illnesses or diseases. In some embodiments, health data comprises user age, height, weight, blood type, and/or other biometrics. In some embodiments, medical history comprises medical information that is equal to or more than 1, 2, 3, 4, 5, 6, 7, 8, 9, 10, 11, 12, 13, 14, 15, 16, 17, 18, 19, 20, 21, 22, 23, or 24 hours old. In some embodiments, medical history comprises medical information that is equal to or more than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days old. In some embodiments, current health information comprises information that is equal to or less than 1, 2, 3, 4, 5, 6, 7, 8, 9, 10, 11, 12, 13, 14, 15, 16, 17, 18, 19, 20, 21, 22, 23, or 24 hours old. In some embodiments, current health information comprises medical information that is equal to or less than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days old.

As used herein, “user data” refers to general information associated with a user of a device. In some embodiments, user data comprises user identity, user name, height, weight, eye color, hair color, ethnicity, national origin, religion, language(s) spoken, vision (e.g., whether user needs corrective lenses), home address, work address, occupation, family information, user contact information, emergency contact information, social security number, alien registration number, driver's license number, vehicle VIN, organ donor (e.g., whether user is an organ donor), or any combination thereof. In some embodiments, user data is obtained via user input.

As used herein, “sensor data” refers to information obtained or provided by one or more sensors. In some instances, a sensor is associated with a device (e.g., user has a communication device with a data link via Bluetooth with a wearable sensor, such as, for example, a heart rate monitor or a pedometer). Accordingly, in some embodiments, the device obtains sensor data from the sensor (e.g., heart rate from the heart rate monitor or distance traveled from the pedometer). In some instances, the sensor data is relevant to an emergency situation (e.g., heart rate during a cardiac emergency event). In some embodiments, a sensor and/or sensor device comprises an acoustic sensor, a breathalyzer, a carbon dioxide sensor, a carbon monoxide sensor, an infrared sensor, an oxygen sensor, an ozone monitor, a pH sensor, a smoke detector, a current sensor (e.g., detects electric current in a wire), a magnetometer, a metal detector, a radio direction finder, a voltage detector, an air flow meter, an anemometer, a flow sensor, a gas meter, a water meter, a Geiger counter, an altimeter, an air speed indicator, a depth gauge, a gyroscope, a compass, an odometer, a shock detector (e.g., on a football helmet to measure impact), a barometer, a pressure gauge, a thermometer, a proximity sensor, a motion detector (e.g., in a home security system), an occupancy sensor, or any combination thereof, and in some embodiments, sensor data comprises information obtained from any of the preceding sensors. In some embodiments, one or more sensors are physically separate from a user device. In further embodiments, the one or more sensors authorize the user device to obtain sensor data. In further embodiments, the one or more sensors provide or send sensor data to the user device autonomously. In some embodiments, the user device and the one or more sensors belong to the same group of devices, wherein member devices are authorized to share data. In some embodiments, a user device comprises one or more sensors (e.g., user device is a wearable device having a sensor or sensing component).

As used herein, “communication link” refers to a communication pathway from a device (e.g., communication device) to another device or to an intermediate device (e.g., a router) on a network. In some embodiments, the communication device establishes a communication link with another device or an intermediate device to transfer information (e.g., a location of the device) or to obtain information from a recipient such as, for example, location of a first responder assigned to a request for assistance associated with the communication device (e.g., device of first responder). A communication link refers to the point-to-point communication channels, point-to-point and end-to-end data sessions, and the physical hardware facilitating the communication channel(s) (e.g., antennas used to communicate/transmit information). In some embodiments, a data session comprises session parameters and the network route taken from one device to another device.

As used herein, a “data channel” refers to a communication session between two devices wherein data packets are exchanged between the devices. In some embodiments, a data session is setup using exchange of certain data packets, also called as “handshake signals,” which are able to define the capabilities of the data session. For example, in some embodiments, the data session “handshake” provides for the ability to transfer multi-media data, voice data, and other data via the data session. In some embodiments, the data session is setup without the use of handshake signals, wherein the two devices involved share data packets according to a predefined protocol (e.g., a previously agreed upon protocol). In some embodiments, the data session is routed through an EMS, which stores the multi-media, voice, and/or other data from any of the devices that are part of the data session. In further embodiments, the EMS shares the data from the data session with the other device (e.g., device of a first responder). In some embodiments, the EMS manages the data session.

As used herein, a “Received Signal Strength Indicator (RSSI)” refers to a measurement of the power present in a received radio signal. In some embodiments, the RSSI refers to a number assigned to the signal levels (e.g., power level) of packets as detected by a device receiving the packets from a device sending the packets. For example, an RSSI value may be a number within an arbitrary range such as from 0 to 100. In some embodiments, the RSSI refers to the decibel level of the power of the received data packets. In other embodiments, the RSSI refers to the actual power, for example measured in mW, as detected by the receiver. In some embodiments, RSSI is replaced with received channel power indicator (RCPI), which is a measure of the received radio signal power in a selected channel over the preamble and the entire received frame.

As used herein, “voice or speech recognition software” refers to computer programs that can recognize a person's speech to identify trigger phrases (e.g., iListen, Voice Navigator, Google Now, LilySpeech, etc.). In some embodiments, the software may be able to recognize the identity of the speaker. As used herein, “voice command” refers to words or phrases that a user may use to give command to the triggering device. The trigger phrases may be user-defined or may be from a library of phrases on the trigger device or at a remote server.

As used herein, “sound detection software” refers to computer programs for detecting trigger sounds in and around the triggering device. The trigger sounds may be user-defined or may be from a library of phrases on the trigger device or at a remote server. The trigger sounds may be sounds (alarms, breakage, gunshots, explosion, fire, car crash, etc.) or absence of sound (e.g., no heartbeat, etc.). For example, a glass break detector software may use the microphone in the trigger device to monitor any noise or vibrations to detect burglaries in a smart home. If the vibrations exceed a baseline, they may be analyzed by the software. The software may analyze frequencies typical of glass shattering and trigger an emergency alert if the sound is above a trigger threshold. In some cases, the software may compare detected sounds with glass-break profiles analysis and trigger an alert if the amplitude threshold and/or statistically expressed similarity threshold are breached. In some embodiments, an emergency is detected or triggered when a trigger sound exceeds a threshold. In some embodiments, a trigger sound threshold is about 50, 55, 60, 65, 70, 75, 80, 85, 90, 95, 100, 110, 120, 130, 140, 150, 160, 170, 180, 190, or 200 decibels. In some embodiments, a trigger sound threshold is at least about 50, 55, 60, 65, 70, 75, 80, 85, 90, 95, 100, 110, 120, 130, 140, 150, 160, 170, 180, 190, or 200 decibels. In some embodiments, a trigger sound threshold is no more than about 50, 55, 60, 65, 70, 75, 80, 85, 90, 95, 100, 110, 120, 130, 140, 150, 160, 170, 180, 190, or 200 decibels.

Modern communication devices, for example, smart phones, tablet computers, wearable communication devices, smart sensor devices and/or systems are often equipped with a variety of features for determining location information of the communication device using, for example, GPS, or triangulation with cellular phone towers. Modern communication devices also often include functionality to store data regarding a user of the communication device, for example, health information about the user.

In some embodiments, the communication device (or communication module of the device) communicates with a recipient through one or more data channels. In some embodiments, the recipient is an emergency management system. In some embodiments, the EMS routes communications to an ESP. In further embodiments, the EMS establishes a first data channel with the communication device and a second data channel between the EMS and the ESP, wherein the EMS bridges the first and second data channels to enable the communication device and the ESP to communicate. In some embodiments, the EMS converts data (e.g., data set) from the communication device into a format suitable for the ESP (e.g., analog or digital, audio, SMS, data, etc.) before sending or routing the formatted data to the ESP. In some embodiments, the EMS routes communications to a device associated with a first responder. In some embodiments, the communication device relays additional communications, information, and/or data sent or shared between member devices in the group of devices to the EMS or ESP after a request for assistance has been sent. In further embodiments, the additional information is relayed to the EMS or ESP after the request for assistance has been sent in order to provide current information that is relevant to the request. For example, in some instances, communications between member devices contain information relevant to the emergency (e.g., information that the user of member device who is experiencing a medical emergency suffers from diabetes). Accordingly, in some embodiments, the information is sent autonomously, at request of a user of the communication device, or at request of the recipient (e.g., EMS, ESP, first responder, etc.).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### EXAMPLES

The following illustrative examples are representative of embodiments of the invention described herein and are not meant to be limiting in any way.

Just In Time, an emergency response company, aids emergency service providers (ESPs; e.g., public safety answering points, or “PSAPs”) by providing a central hub for connected devices and systems (e.g., mobile phones, IoT devices, etc.) to communicate with ESPs. Through this central hub, connected devices and systems may transmit data and electronic communications to ESPs and ESPs may transmit data and electronic communications to connected devices and systems. Traditionally, PSAPs and other ESPs are only technologically capable of receiving telephone calls (e.g., 9-1-1 emergency calls) with no additional data. Thus, typically, when a person is in an emergency, they must make an emergency call (e.g., by dialing 9-1-1 in the United States) and verbally communicate the details of their emergency to a call taker at an ESP. The central hub provided by Just In Time (also referred to as an “emergency clearinghouse”) provides ESPs with new and additional ways to respond to emergencies. In acting as a central hub between ESPs and connected devices and systems, the clearinghouse should be able to receive data from a large set of data sources, and that set of data sources should be able to grow dynamically. To this end, Just In Time has developed a modular application programming interface (API) system (MAS) that allows for a single API to employ a plurality of different MAS schemas associated with a plurality of different data sources. The MAS additionally provides a schema editor interface (e.g., a graphical user interface or GUI) for new MAS schemas to be created for the MAS with little or no programming knowledge or skills. MAS schemas created within the schema editor interface can be stored within a schema database, where they can be later retrieved by the MAS.

### Example 1

Company A, an online marketplace for peer-to-peer home sharing would like to be able to share information with the Just In Time clearinghouse during emergencies. For example, if a person calls 9-1-1 while they are purportedly renting another person's room or home, Company A might be the only entity aware of where the person is currently staying (e.g., a temporary home address), as well as who they may be staying with (e.g., potential emergency contacts). Company A could provide emergency service providers (ESPs) with this information through the Just In Time clearinghouse. To do so, Just In Time provides Company A with access to the schema editor interface, where an Company A employee creates a new MAS schema for the modular API system (MAS). The new Company A schema contains three mandatory data fields: user_name, user_number, temp_address, associated with the data formats string, number, and location, respectively, and have been given the render options text, phone number, and address, respectively. Each data field has been given a display label and a display order: Traveler Name, Traveler Number, and Temporary Address, respectively; and 1, 2, and 3, respectively. The schema includes a number of other, non-mandatory data fields, such as host_name, host_number, and additional_guests (which may be a nested field of contact names and phone numbers). Finally, the schema is also designated as supplemental data. The new Company A schema is saved and transmitted to a verification interface, where a Just In Time employee verifies the MAS schema for quality control and assurance purposes before committing the new Company A schema to the schema database.

Later, Caroline, a New York resident, is on vacationing by herself in Santa Fe, N. Mex. and renting an apartment through Company A. One morning, Caroline sets out on a bike ride. In attempting to dodge a tortoise on a downhill slalom, Caroline swerves on her bike and catches a rut in the path, jettisoning herself off the bike and breaking her leg when she hits the ground. Caroline pulls her mobile phone out of her pocket and calls 9-1-1. In response to Caroline calling 9-1-1, her mobile phone also transmits an emergency alert to the Just In Time clearinghouse, which forwards her location to the public safety answering point (PSAP) that receives Caroline's 9-1-1 call through an emergency response application provided by Just In Time, Nick Of time. An incident is created for Caroline's emergency alert within the Nick Of Time GUI. A call taker at the PSAP who is speaking to Caroline through her 9-1-1 call selects Caroline's incident within Nick Of Time, which prompts Nick Of Time to transmit a request for emergency data to the Just In Time clearinghouse, which then gathers any available additional data associated with Caroline's incident and returns the additional data to Nick Of Time.

In this example, the Just In Time clearinghouse transmits a query including Caroline's phone number to the Company A backend systems, which return a data packet associated with Caroline's phone number to an ingestion API managed by the MAS within the Just In Time clearinghouse. The data packet contains an identifier of the Company A schema stored within the schema database. Using the identifier of the Company A schema, the MAS retrieves the Company A schema from the schema database and validates the data packet received from Company A against the Company A schema retrieved from the schema database. In this example, the data packet includes the three data fields designated as mandatory in the Company A schema (user_name, user_number, temp_address) in the proper data formats, so the MAS successfully validates the data packet and passes the data packet (or the data included in the data packet) into the Just In Time clearinghouse. The clearinghouse automatically associates the data received from Company A with Caroline's incident using Caroline's phone number, and because Caroline's incident already exists within Nick Of Time, the clearinghouse automatically transmits the data received from Company A to Nick Of Time and visualizes the data within the GUI. In this example, because the Company A schema has been designated as supplemental data, the data received from Company A would not have been transmitted to Nick Of Time if Caroline's incident did not already exist within Nick Of Time.

After Nick Of Time receives the Company A data, a visualization engine included in Nick Of Time visualizes the Company A data within the Nick Of Time GUI according to the designations provided by the schema. In this example, the visualization engine generates a data card titled Company A Data that includes the at least the three data fields designated as mandatory by their designated display names and in the order that they were selected to be displayed in—Traveler Name, Traveler Number, and Temporary Address—with their respective values to the right of the display names. In this way, the 9-1-1 call taker speaking to Caroline instantly has access to not only Caroline's real-time location (generated by Caroline's mobile phone) but also Caroline's temporary address in Santa Fe (along with any other data potentially received from Company A, such as Caroline's host's name and phone number), which the call taker can use to provide additional or more effective emergency assistance to Caroline in her emergency.

### Example 2

Caroline (from Example 1 above), a marketing specialist, works for Company B, a private security company that installs and maintains smart building systems. The smart building systems include remotely controllable doors and remotely accessible surveillance cameras than can be activated during emergencies. For example, a smart building system may be installed at a high school, so that a school administrator may have remote access to one or more doors at the high school or one or more surveillance cameras at the high school. Company B also provides a mobile application that its users, such as a school principal or campus police, can use to remotely lock the doors to a school, for example, in the event of an emergency. After her experience in Santa Fe, Caroline proposes that Company B send emergency data to Just In Time whenever an emergency mode is activated by one of their smart building systems or the associated mobile application, so that Just In Time can notify local emergency service providers (ESPs) as quickly as possible. To this end, Caroline (who has little or no programming skills or knowledge) accesses the Just In Time modular API system (MAS) schema editor interface to create a new MAS schema for Company B's smart building systems. Caroline is able to quickly and easily define the Company B schema to contain four mandatory data fields: building_location (the activated smart building's location), event_time (the time at which the emergency mode was activated), user_name (the name of the user who activated the emergency mode), and phone_number (the phone number of the user), associated with the data formats location, number, string, and number, respectively, to be rendered as an address, a time, text, and a phone number, respectively. Caroline sets the display names to be Building Location, Event Time, QL Admin Name, and Phone Number, and she designates the schema as a primary request. However, in this example, Caroline does not designate a display order for the Company B schema. Finally, Caroline saves and publishes the Company B schema, and the Company B engineers then reprogram the smart building systems and the mobile application to transmit a data payload including the mandatory data fields to the Just In Time clearinghouse whenever an emergency mode is activated by one of the smart building systems or the mobile application. The Company B schema is transmitted to a verification interface, where a Just In Time employee verifies the MAS schema for quality control and assurance purposes and then commits the Company B schema to the schema database.

Later, the principal of a high school in Chicago where a Company B system has been installed hears gunshots fired in the vicinity. The principal does not know if the shots were fired inside or outside of the school, but uses access the Company B mobile application on his mobile phone to activate an emergency mode for the high school's smart building system. In response, the mobile phone is prompted to transmit a data payload including an identifier of the Company B schema to the Just In Time clearinghouse, which employs the modular API system (MAS). Upon receiving the data payload, the MAS uses the schema identifier to retrieve the Company B schema from the schema database (which now stores at least two schemas—the Company B schema and the Company A schema—and therefore, in this example, the MAS requires the schema identifier to select the proper schema, the Company B schema). The MAS then attempts to validate the data payload against the Company B schema. In this example, the data payload includes a value for each of the four data fields designated as mandatory by the Company B schema (building_location, event_time, user_name, and phone_number) in the proper data formats; therefore, the data payload is successfully validated against the schema.

With the data payload successfully validated against the MAS schema, the MAS passes the data payload (or the data included in the data payload) into the Just In Time clearinghouse. In this example, because the Company B schema has been designated as a primary request, the clearinghouse uses the location included in the data payload to identify an ESP having an authoritative jurisdiction encompassing the location (such as by using a geofence fence) and automatically pushes the data payload (or the data included in the data payload) to the appropriate ESP through the Nick Of Time emergency response application. An incident is created for the data payload within the Nick Of Time GUI. When the incident is selected by a user of Nick Of Time at the ESP, a visualization engine included in Nick Of Time visualizes the Company B data according to the designations provided by the MAS schema. In this example, the visualization engine generates a Company B data card that includes the four data fields designated as mandatory by the Company B schema by their designated display names and in the order that they were listed in the schema (because Caroline did not designate a display order)—Building Location, Event Time, QL Admin Name, and Phone Number—with their respective values to the right of the display names. In this way, an ESP (such as a 911 PSAP) is immediately notified of a potential emergency at the Chicago high school as soon as possible.

What is claimed is:

1. A method for validating and visualizing data using a modular API system, the method comprising:
providing a schema database comprising a plurality of schemas corresponding to a respective plurality of schema identifiers, each schema defining a validation requirement and a visualization rule for one or more data fields;
receiving a data packet associated with a schema identifier from the plurality of schema identifiers and comprising one or more data values for one or more respective data fields;
retrieving a schema associated with the schema identifier from the schema database;
validating the data packet against the schema to generate a validated data packet; and
transmitting the validated data packet to a recipient for display of the one or more data values within a graphical user interface according to the visualization rule defined by the schema.

2. The method of claim 1, wherein the validation requirement comprises a data format.

3. The method of claim 1, wherein the validation requirement comprises a mandatory designation.

4. The method of claim 1, wherein the visualization rule comprises a rendering option, a display label, or a display order.

5. The method of claim 1, wherein the one or more data values are visualized within the graphical user interface according to the visualization rule within a data card.

6. The method of claim 1, wherein the plurality of schemas corresponds to a respective plurality of data sources.

7. The method of claim 1, further comprising:
storing the validated data packet in a database;
receiving a data query for the validated data packet; and
visualizing the one or more data values within the graphical user interface in response to receiving the data query for the validated data packet.

8. The method of claim 7, wherein the data packet comprises or is otherwise associated with a user identifier and wherein the data query comprises the user identifier.

9. The method of claim 1, further comprising receiving a definition of the schema through a schema editor interface.

10. The method of claim 9, further comprising providing the schema editor interface for creating and defining new schemas.

11. The method of claim 9, wherein the schema editor interface is provided through a web application accessible through a standard web browser.

12. The method of claim 9, wherein the definition of the schema comprises at least one data field and at least one data format associated with the at least one data field.

13. The method of claim 9, wherein the visualization rule is selected within the schema editor interface.

14. The method of claim 1, wherein validating the data packet against the schema comprises confirming that a data value for a data field comprised by the data packet is in an appropriate data format as defined by the schema.

15. The method of claim 1, wherein the schema additionally defines a data field configured to be visualized as a clickable action.

16. The method of claim 1, wherein the data packet is an emergency alert and wherein the graphical user interface is provided by an emergency response application.

17. The method of claim 16, wherein the emergency alert comprises at least a location and a user identifier.

18. The method of claim 16, wherein the emergency response application is executed on a computing device at an emergency service provider (ESP).

19. The method of claim 16, wherein the graphic user interface displays a map showing at least a portion of the jurisdiction of the emergency service provider and a location of an emergency corresponding to the validated data packet.

20. An emergency management system comprising:
a schema database comprising a plurality of schemas corresponding to a respective plurality of schema identifiers, each schema defining a validation requirement and a visualization rule for one or more data fields; and
a processor and non-transitory computer readable storage medium including instructions that, when executed by the processor, causes the processor to:
receive a data packet associated with a schema identifier from the plurality of schema identifiers and comprising one or more data values for one or more respective data fields;
retrieve a schema associated with the schema identifier from the schema database;
validate the data packet against the schema to generate a validated data packet; and
transmit the validated data packet to a recipient for display of the one or more data values within a graphical user interface according to the visualization rule defined by the schema.
